(19) United States
(12) Patent Application Publication
(10) Pub. No.: US 2026/0094412 A1
(43) Pub. Date: Apr. 2, 2026

(54) DETECTION AND CLASSIFICATION USING A SINGLE MACHINE LEARNING MODEL

(71) Applicants: TECHNION RESEARCH & DEVELOPMENT FOUNDATION LIMITED, Haifa (IL); RAMBAM MED-TECH LTD., Haifa (IL)

(72) Inventors: Aaron CIECHANOVER, Haifa (IL); Alona GOLTS, Haifa (IL); Ido LIVNEH, Haifa (IL); Yaniv ZOHAR, Kiryat Tivon (IL); Michael ELAD, Haifa (IL)

(21) Appl. No.: 19/117,764

(22) PCT Filed: Sep. 29, 2023
(86) PCT No.: PCT/IL2023/051049

§ 371 Date: Apr. 2, 2025

Related U.S. Application Data
(60) Provisional application No. 63/378,286, filed on Oct. 4, 2022.

(51) Int. Cl. G06V 10/764; G06V 10/778

(52) U.S. Cl. CPC G06V 10/764; G06V 10/778

(57) ABSTRACT

The present disclosure is related to the field of machine learning (ML) based detection and classification. More specifically, the present disclosure provides computer implemented methods of detection and multi-class classification of objects of interest in an image, computer program product operable in a computer, and diagnostic methods thereof.

### TECHNOLOGICAL FIELD

The present disclosure is related to the field of machine learning (IL) based detection and classification.

### BACKGROUND ART

References considered to be relevant as background to the presently disclosed subject matter are listed below:
[1] Ren, S., He, K., Girshick, R., Sun, J.: Faster r-cnn: Towards real-time object detection with region proposal networks. Advances in neural information processing systems 28, 91-99 (2015)
[2] Jia, Y., Shelhamer, E., Donahue, J., Karayev, S., Long, J., Girshick, R., Guadarrama, S., Darrell, T.: Caffe: Convolutional architecture for fast feature embedding. In: Proceedings of the 22nd ACM international conference on Multimedia. pp. 675-678. ACM (2014)
[3] Long, J., Shelhamer, E., Darrell, T.: Fully convolutional networks for semantic segmentation. In: Proceedings of the IEEE conference on computer vision and pattern recognition. pp. 3431-3440 (2015)
[4] Zhang, K., Zuo, W., Chen, Y., Meng, D., Zhang, L.: Beyond a gaussian denoiser: Residual learning of deep cnn for image denoising. IEEE transactions on image processing 26(7), 3142-3155 (2017)
[5] Johnson, J., Alahi, A., Fei-Fei, L.: Perceptual losses for real-time style transfer and super-resolution. In: European Conference on Computer Vision. pp. 694-711.
Springer (2016)
[6] Han, Z., Wei, B., Zheng, Y., Yin, Y., Li, K., Li, S.: Breast cancer multi-classification from histopathological images with structured deep learning model. Scientific reports 7(1), 1-10 (2017)
[7] Litjens, G., S'anchez, C. I., Timofeeva, N., Hermsen, M., Nagtegaal, I., Kovacs, I., Hulsbergen-Van De Kaa, C., Bult, P., Van Ginneken, B., Van Der Laak, J.: Deep learning as a tool for increased accuracy and efficiency of histopathological diagnosis. Scientific reports 6(1), 1-11 (2016)
[8] Saha, M., Chakraborty, C.: Her2net: A deep framework for semantic segmentation and classification of cell membranes and nuclei in breast cancer evaluation. IEEE Transactions on Image Processing 27(5), 2189-2200 (2018)
[9] Gao, Z., Puttapirat, P., Shi, J., Li, C.: Renal cell carcinoma detection and subtyping with minimal point-based annotation in whole-slide images. In: International Conference on Medical Image Computing and Computer-Assisted Intervention. pp. 439-448. Springer (2020)
[10] Wei, J. W., Tafe, L. J., Linnik, Y. A., Vaickus, L. J., Tomita, N., Hassanpour, S.: Pathologist-level classification of histologic patterns on resected lung adenocarcinoma slides with deep neural networks. Scientific reports 9(1), 1-8 (2019)
[11] Coudray, N., Ocampo, P. S., Sakellaropoulos, T., Narula, N., Snuderl, M., Fenyo″, D., Moreira, A. L., Razavian, N., Tsirigos, A.: Classification and mutation prediction from non-small cell lung cancer histopathology images using deep learning. Nature medicine 24(10), 1559-1567 (2018)
[12] Kanavati, F., Toyokawa, G., Momosaki, S., Rambeau, M., Kozuma, Y., Shoji, F., Yamazaki, K., Takeo, S., Iizuka, O., Tsuneki, M.: Weakly-supervised learning for lung carcinoma classification using deep learning. Scientific reports 10(1), 1-11 (2020)
[13] Cire, san, D. C., Giusti, A., Gambardella, L. M., Schmidhuber, J.: Mitosis detection in breast cancer histology images with deep neural networks. In: International conference on medical image computing and computer-assisted intervention. pp. 411-418. Springer (2013)
[14] Sirinukunwattana, K., Raza, S. E. A., Tsang, Y. W., Snead, D. R., Cree, I. A., Rajpoot, N. M.: Locality sensitive deep learning for detection and classification of nuclei in routine colon cancer histology images. IEEE transactions on medical imaging 35(5), 1196-1206 (2016)
[15] Song, T. H., Sanchez, V., Daly, H. E., Rajpoot, N. M.: Simultaneous cell detection and classification in bone marrow histology images. IEEE journal of biomedical and health informatics 23(4), 1469-1476 (2018)
[16] Wu, Y. Y., Huang, T. C., Ye, R. H., Fang, W. H., Lai, S. W., Chang, P. Y., Liu, W. N., Kuo, T. Y., Lee, C. H., Tsai, W. C., et al.: A hematologist-level deep learning algorithm (bmsnet) for assessing the morphologies of single nuclear balls in bone marrow smears: algorithm development. JMIR medical informatics 8(4), e15963 (2020)
[17] Qu, H., Wu, P., Huang, Q., Yi, J., Yan, Z., Li, K., Riedlinger, G. M., De, S., Zhang, S., Metaxas, D. N.: Weakly supervised deep nuclei segmentation using partial points annotation in histopathology images. IEEE Transactions on Medical Imaging 39(11), 3655-3666 (2020)
[18] Mahmood, F., Borders, D., Chen, R. J., McKay, G. N., Salimian, K. J., Baras, A., Durr, N.J.: Deep adversarial training for multi-organ nuclei segmentation in histopathology images. IEEE transactions on medical imaging 39(11), 3257-3267 (2019)
[19] Qu, H., Wu, P., Huang, Q., Yi, J., Riedlinger, G. M., De, S., Metaxas, D. N.: Weakly supervised deep nuclei segmentation using points annotation in histopathology images. In: International Conference on Medical Imaging with Deep Learning. pp. 390-400. PMLR (2019)
[20] Chandradevan, R., Aljudi, A. A., Drumheller, B. R., Kunananthaseelan, N., Amgad, M., Gutman, D. A., Cooper, L. A., Jaye, D. L.: Machine-based detection and classification for bone marrow aspirate differential counts: initial development focusing on nonneoplastic cells. Laboratory Investigation 100(1), 98-109 (2020)
[21] Cire, san, D. C., Giusti, A., Gambardella, L. M., Schmidhuber, J.: Mitosis detection in breast cancer histology images with deep neural networks. In: International conference on medical image computing and computer-assisted intervention. pp. 411-418. Springer (2013)
[22] Wei, J. W., Tafe, L. J., Linnik, Y. A., Vaickus, L. J., Tomita, N., Hassanpour, S.: Pathologist-level classification of histologic patterns on resected lung adenocarcinoma slides with deep neural networks. Scientific reports 9(1), 1-8 (2019)
[23] Gao, Z., Puttapirat, P., Shi, J., Li, C.: Renal cell carcinoma detection and subtyping with minimal point-based annotation in whole-slide images. In: International Conference on Medical Image Computing and Computer-Assisted Intervention. pp. 439-448. Springer (2020)
[24] Malon, C. D., Cosatto, E.: Classification of mitotic figures with convolutional neural networks and seeded blob features. Journal of pathology informatics 4(1), 9 (2013)
[25] Xie, Y., Xing, F., Shi, X., Kong, X., Su, H., Yang, L.: Efficient and robust cell detection: A structured regression approach. Medical image analysis 44, 245-254 (2018)
[26] Li, C., Wang, X., Liu, W., Latecki, L. J., Wang, B., Huang, J.: Weakly supervised mitosis detection in breast histopathology images using concentric loss. Medical image analysis 53, 165-178 (2019)
[27] Kumar, N., Verma, R., Sharma, S., Bhargava, S., Vahadane, A., Sethi, A.: A dataset and a technique for generalized nuclear segmentation for computational pathology. IEEE transactions on medical imaging 36(7), 1550-1560 (2017)
[28] Naylor, P., La'e, M., Reyal, F., Walter, T.: Segmentation of nuclei in histopathology images by deep regression of the distance map. IEEE transactions on medical imaging 38(2), 448-459 (2018)
[29] Xing, F., Xie, Y., Yang, L.: An automatic learning-based framework for robust nucleus segmentation. IEEE transactions on medical imaging 35(2), 550-566 (2015)
[30] Qu, H., Wu, P., Huang, Q., Yi, J., Riedlinger, G. M., De, S., Metaxas, D. N.: Weakly supervised deep nuclei segmentation using points annotation in histopathology images. In: International Conference on Medical Imaging with Deep Learning. pp. 390-400. PMLR (2019)
[31] Nishimura, K., Ker, D. F. E., Bise, R.: Weakly supervised cell instance segmentation by propagating from detection response. In: International Conference on Medical Image Computing and Computer-Assisted Intervention. pp. 649-657. Springer (2019)
[32] Chamanzar, A., Nie, Y.: Weakly supervised multi-task learning for cell detection and segmentation. In: 2020 IEEE 17th International Symposium on Biomedical Imaging (ISBI). pp. 513-516. IEEE (2020)
[33] Gao, Z., Puttapirat, P., Shi, J., Li, C.: Renal cell carcinoma detection and subtyping with minimal point-based annotation in whole-slide images. In: International Conference on Medical Image Computing and Computer-Assisted Intervention. pp. 439-448. Springer (2020)
[34] Hou, L., Agarwal, A., Samaras, D., Kurc, T. M., Gupta, R. R., Saltz, J. H.: Robust histopathology image analysis: To label or to synthesize? In: Proceedings of the IEEE/CVF Conference on Computer Vision and Pattern Recognition. pp. 8533-8542 (2019)
[35] Li, J., Yang, S., Huang, X., Da, Q., Yang, X., Hu, Z., Duan, Q., Wang, C., Li, H.: Signet ring cell detection with a semi-supervised learning framework. In: International conference on information processing in medical imaging. pp. 842-854. Springer (2019)
[36] Liu, D., Zhang, D., Song, Y., Zhang, F., O'Donnell, L., Huang, H., Chen, M., Cai, W.: Unsupervised instance segmentation in microscopy images via panoptic domain adaptation and task re-weighting. In: Proceedings of the IEEE/CVF conference on computer vision and pattern recognition. pp. 4243-4252 (2020)
[37] Mahmood, F., Borders, D., Chen, R. J., McKay, G. N., Salimian, K. J., Baras, A., Durr, N.J.: Deep adversarial training for multi-organ nuclei segmentation in histopathology images. IEEE transactions on medical imaging 39(11), 3257-3267 (2019)
[38] Peikari, M., Salama, S., Nofech-Mozes, S., Martel, A. L.: A cluster-then-label semisupervised learning approach for pathology image classification. Scientific reports 8(1), 1-13 (2018)
[39] Xu, J., Xiang, L., Liu, Q., Gilmore, H., Wu, J., Tang, J., Madabhushi, A.: Stacked sparse autoencoder (ssae) for nuclei detection on breast cancer histopathology images. IEEE transactions on medical imaging 35(1), 119-130 (2015)
[40] Xie, Y., Xing, F., Kong, X., Su, H., Yang, L.: Beyond classification: structured regression for robust cell detection using convolutional neural network. In: International conference on medical image computing and computer-assisted intervention. pp. 358-365. Springer (2015)
[41] Sirinukunwattana, K., Raza, S. E. A., Tsang, Y. W., Snead, D. R., Cree, I. A., Rajpoot, N. M.: Locality sensitive deep learning for detection and classification of nuclei in routine colon cancer histology images. IEEE transactions on medical imaging 35(5), 1196-1206 (2016)
[42] Javed, S., Mahmood, A., Fraz, M. M., Koohbanani, N. A., Benes, K., Tsang, Y. W., Hewitt, K., Epstein, D., Snead, D., Rajpoot, N.: Cellular community detection for tissue phenotyping in colorectal cancer histology images. Medical image analysis 63, 101696 (2020)
[43] Javed, S., Mahmood, A., Werghi, N., Benes, K., Rajpoot, N.: Multiplex cellular communities in multi-gigapixel colorectal cancer histology images for tissue phenotyping. IEEE Transactions on Image Processing 29, 9204-9219 (2020)
[44] Qu, H., Riedlinger, G., Wu, P., Huang, Q., Yi, J., De, S., Metaxas, D.: Joint segmentation and fine-grained classification of nuclei in histopathology images. In: 2019 IEEE 16th international symposium on biomedical imaging (ISBI 2019). pp. 900-904. IEEE (2019)
[45] Redmon, J., Farhadi, A.: Yolov3: An incremental improvement. arXiv preprint arXiv:1804.02767 (2018)
[46] Zhou, Y., Dou, Q., Chen, H., Qin, J., Heng, P. A.: Sfcn-opi: Detection and finegrained classification of nuclei using sibling fcn with objectness prior interaction. In: Proceedings of the AAAI Conference on Artificial Intelligence. vol. 32 (2018)
[47] Song, T. H., Sanchez, V., Daly, H. E., Rajpoot, N. M.: Simultaneous cell detection and classification in bone marrow histology images. IEEE journal of biomedical and health informatics 23(4), 1469-1476 (2018)
[48] WO 2022/009212.

Acknowledgement of the above references herein is not to be inferred as meaning that these are in any way relevant to the patentability of the presently disclosed subject matter.

### BACKGROUND

The field of machine learning (and deep learning specifically) has taken the computer vision world by storm, showing an ever-increasing presence and impact on a wide variety of technological fields, both for research and commercial purposes. These include technological fields such as, agriculture, traffic monitoring, cosmetics, weather forecast, mineral processing, medicine, and many more. Machine learning techniques have shown state-of-the-art results in a wide range of applications, including for example: object detection [1], image classification [2], segmentation [3], restoration [4], synthesis [5] and more.

One non-limiting example of a field of technology which benefits from the possibilities provided by machine learning, is pathology. Immunohistochemistry (IHC) is a widely used method in Histopathology where cellular proteins are stained via the employment of specific antibodies and dyes. The stained proteins serve as markers for different cell types, differentiation levels and tumor classifications of the slide in question. Such staining is crucial for diagnosis, prognosis, treatment guidance, response monitoring, follow up and many other aspects in the clinical life. With the emergence of personalized medicine, IHC staining and screening allow for the identification of the unique features of each patient—and tumor, and subsequent tailoring of the optimal known treatment. A well-known example for such markers that are used to guide treatment, are the estrogen, progesterone and HER2 receptors in breast cancer. Such cellular markers can be stained in a specific biopsy or excised tumor, and their relative abundance—as interpreted by a pathologist—provides valuable information for the management of each patient [Slamon, D. J., New England journal of medicine 344(11), 783-792 (2001)]. Specifically, in an era when cancer treatment has rendered many tumors as curable, tumor recurrence, or relapse has become commonplace. In some cases, the recurring cancer cells were in fact present already in the primary tumor, yet in small numbers [Dagogo-Jack, I., et al., Nature reviews Clinical oncology 15(2), 81-94 (2018)]. It is therefore clear how the identification of unique subpopulations of cells in advance can potentially benefit with patients, as it can predict relapse, dictate the follow-up protocol under remission, and guide treatment may the tumor reoccur. While global slide examination is routine and commonly performed by pathologists, local analysis in the cell level is still out of reach, as such subpopulation of cells may be so rare that the human operator simply cannot spot it.

In the advent of computational pathology, some believe that manual inspection of tissue slides under the microscope will be gradually replaced with high resolution slide scanning and automatic analysis of Whole Slide Images (WSIs).

Based on the success of deep learning in natural images, many are currently attempting to harness machine learning for solving computational pathology tasks, such as detection, classification and grading of breast [6, 7, 8], kidney [9] and lung [10, 11, 12] cancers, mitosis detection [13], detection and classification of cell nuclei [14, 15], automatic count of histologic bone marrow samples [16] and many more.

The tasks of detection and classification of cells into multiple categories serve as crucial building blocks in the realization of cell-level analysis of WSIs, and their constituent smaller sized image patches, called ‘tiles’. Current cell-level approaches either concentrate on the detection and accurate segmentation of cells [17, 18, 19], leaving the task of classification to a later stage, or separate the two tasks to two consecutive networks [14, 20]. Both approaches do not fully utilize the common low and high-level features of the corresponding neural networks. Thus, simultaneous detection and classification of cells into multiple categories of interest, are most valuable. Several recent publications suggest joint detection and classification [15, 16], however, they all rely on fully-supervised annotated datasets.

Many works in computational pathology deal with a single task as WSI classification [21, 22, 23], cell detection [24, 25, 26] and segmentation [27, 28, 29, 30, 31, 32]. Classification-centered approaches [21, 22, 23] are usually global and provide a classification result for each patch or tile. These are then aggregated across the entire WSI using a sliding-window method to create a global classification heatmap. This global approach, however, is less suitable for creating accurate patient specific cell count histograms. Local approaches, attempting to detect or segment all cells in the image are abundant. Mitosis detection and classification is performed in [24] by morphologically finding cell blobs and classifying them using a Convolutional Neural Network (CNN). In [25, 26], a fully-convolutional CNN (FCN) is weakly-supervised with point labels for each cell. The point annotations are encoded either by Gaussians [25] or concentric rings [26] around each cell point. These methods, however, do not account for multiple cell classes and require annotation of all cells in the train set. In the task of cell instance segmentation, full pixelwise masks are incredibly hard to collect, thus weakly-supervised approaches are in favor. In [30, 32], Voronoi, cluster-based and repel-code pseudo labels are created to deal with weak cell point annotations.

Another series of works suggests different methods of coping with the relatively low amount of training data [33, 34, 35, 36, 37, 38, 39]. The work of [39] suggests pre-training an encoder-decoder network with unlabeled images to obtain richer representations. The authors of [35, 33]propose a semi-supervised approach of training on a smaller dataset and enriching the labels with resulting high scored predictions. Finally, the works of [37, 36] use a cycle-GAN architecture to synthesize corresponding pairs of H&E images and segmentation masks.

An increasing effort is applied at solving both tasks jointly. The authors of [40] introduced a Structured Regression CNN (SR-CNN) which produced a proximity map for each image patch, allowing cell instance detection, classification to cancer/non-cancer cells [41] and tissue phenotyping by grouping individual cells to cohesive neighborhoods [42, 43]. These works, however, treat both tasks separately, leading to error accumulation and slower inference times. The authors of [44]propose solving both cell segmentation and classification within the same network, with the help of an additional VGG-assisted perceptual loss but require the full pixelwise segmentation masks during training. Finally, few papers treat both tasks simultaneously. The work of [16] performs detection and classification of bone marrow smear cells, using a YoloV3 [40] architecture. In [46], a unified network, featuring separate detection and classification branches, allows fine-grained classification of H&E colorectal adenocarcinoma cells. In [47], a synchronized asymmetric hybrid deep autoencoder is used to detect and classify bone marrow stem cells. It should be noted that all of the above methods use cell annotations for the entire image, thus, utilizing a reduced portion of the analyzed cells, for example, only 5% of cells in each image as done in the present disclosure, may be advantageous.

A recent publication of the present inventors (WO 2022/009212 [48]) discloses the correlation between proteasome cellular localization and malignancy of cancer cells. This correlation provides a diagnostic tool that can be used for monitoring subjects, for example, multiple myeloma (MM) patients, assessing responsiveness for anti-cancer therapy, thereby supporting personalized treatment approach. The detection and classification of tissue cells into meaningful categories is a crucial stage in modern computational pathology pipelines. In the onset of personalized medicine, the ability to construct a patient-specific histogram, detailing the exact composition of cells in a given biopsy, may be a game-changer in the diagnosis, proposed treatment plan and follow-up of cancer. While in some cases, the majority category, the class that is most common in the biopsy, dictates the proposed treatment, it is actually the abundance of certain rare cells that can lead to future relapse and shorter remission periods of the disease. The detection of such rare cells is challenging for an artificial-intelligence (ai)-based system, and practically impossible for a human pathologist, as there exist millions of cells in a given biopsy. Thus, addressing the heterogeneity of cells within the same tumor, and more specifically, profiling and providing a deep analysis of the tumor inherent variability is clearly an unmet need.

### GENERAL DESCRIPTION

A first aspect of the present disclosure relates to a computer implemented method of detection and multi-class classification of objects of interest in an image, using a single machine learning model (e.g., single deep neural network). The method comprising the following steps:
applying a machine learning model on at least one input image;
   the machine learning model is a model, which has been trained using a partially and weakly labelled training dataset of images;
   for each input image (of the at least one input image), the machine learning model is configured to provide as output, C probability maps, where c is defined according to the number of classes in a group of classes which includes at least two object-related classes and a background class. Each map of the C probability maps corresponds to a respective class and comprises, with respect to each pixel in the input image, a respective probability value indicative of a probability that the pixel belongs to the respective class. Still further, the c probability maps provide collectively, for each pixel in the input image, a respective probability vector comprising C probability values each value indicating the probability that the pixel belongs to a respective class;
applying post-processing on the output, comprising detecting objects of interest in at least one input image, based on the probability vectors and classifying each detected object of interest to a respective class in the group of classes, based on the probability values in the probability maps, of pixels located in the detected object of interest.

A further aspect of the present disclosure relates to a computer program product stored on a non-transitory computer-readable medium, comprising instructions which, when the program is executed by a computer, cause the computer to carry out a method in accordance with the computer implemented method the present disclosure.

In yet a further aspect, the present disclosure provides a computer program product e.g., stored on a non-transitory computer-readable medium, operable in a computer and comprising instructions stored on a non-transitory computer-readable medium causing the computer to execute for a method of detection and multi-class classification of one or more objects in an image, using a single machine learning model for both detection and classification. More specifically, the product is produced by the processes of: Obtaining a training dataset comprising a collection of partially and weakly labelled (annotated) images, where in each image only part of the one or more objects are labeled, and only part of the pixels of each labeled object are labeled;

Using the training dataset for training the machine learning model comprising: generating for each partially and weakly labeled image C probability maps, wherein each map corresponds to a respective class and comprises, with respect to each labelled pixel a respective probability value indicative of a probability that the pixel belongs to the respective class; wherein the c probability maps provide collectively, for each labelled pixel, a respective probability vector comprising c probability values each value indicating the probability that the pixel belongs to a respective class; and iteratively applying a loss function on the training dataset.

A further aspect of the present disclosure relates to a computer implemented method of training machine learning model for detection and multi-class classification of one or more objects in one or more images using a single machine learning model for both detection and classification, the method comprising:
applying an encoding expansion process on the weakly and partially labeled dataset before training, comprising:
for each labeled object in the training dataset:
   automatically defining a first masked region surrounding at least one manually labeled pixel in the labeled object, wherein all pixels in the first region are classified to the same class as the at least one manually labeled pixel, and a second masked region surrounding the first mased region, wherein the area between the first masked region and the second masked region corresponds to background.

Using the training dataset for training the machine-learning model comprising generating for each partially and weakly labeled image c probability maps, each map corresponds to a respective class and comprises, with respect to each labelled pixel a respective probability value indicative of a probability that the pixel belongs to the respective class. The c probability maps provide collectively, for each labelled pixel, a respective probability vector comprising c probability values each value indicating the probability that the pixel belongs to a respective class; and
Iteratively applying a loss function on the training dataset.

A further aspect disclosed herein relates to a computer system comprising at least one processing circuitry configured to execute a method of detection and multi-class classification of objects in an image, using a single machine learning model for both detection and classification according to the present disclosure.

Still further aspect relates to a computer system comprising at least one computer circuitry configured to execute a method of training machine learning model for detection and multi-class classification of objects in an image using a single machine learning model for both detection and classification, according to the present disclosure.

A further aspect of the present disclosure relates to a diagnostic method for detecting and multi-class classifying the sub-cellular localization of at least one biomarker in at least one object of at least one biological sample. More specifically, the method comprising:
Applying a machine learning model on at least one input image of the sample, wherein the machine learning model is a model, which has been trained using a partially and weakly labelled training dataset of images;
More specifically, for each input image, the machine learning model is configured to provide as output, C probability maps, where c is defined according to the number of classes in a group of classes which includes at least two object-related classes and a background class. It should be noted that each map of the C probability maps corresponds to a respective class. It should be noted that each object-related class in the group of classes reflects a respective distribution of at least one biomarker within the object. Still further, the C probability maps provide collectively, for each pixel in the input image, a respective probability vector comprising C probability values indicating the probability that the pixel belongs to a certain class in the group of classes;
Applying post-processing on the output, comprising:
Detecting one or more objects of interest in at least one input image, based on the probability vectors and classifying each detected object of interest to a respective class in the group of classes, based on the probability values in the probability maps, of pixels located in the detected object of interest, thereby identifying one or more classified objects in the at least one input image.

A further aspect provided by the present disclosure relates to a computer system comprising at least one processing circuitry configured to execute a diagnostic method for determining and classifying the sub-cellular localization of at least one biomarker in at least one biological sample, as defined by the present disclosure.

Another aspect of the present disclosure relates to a prognostic method for determining the prognosis of a subject suffering from a pathologic disorder and/or for predicting and assessing responsiveness of the subject to a treatment regimen (e.g., a treatment regimen comprising at least one therapeutic agent). Optionally, the disclosed methods may be further applicable for monitoring disease progression. More specifically, the method comprising the steps of:
Step (a) of the disclosed method involves detecting and classifying the sub-cellular localization of the proteasome in at least one pathological cell of at least one biological sample of the subject to generate a pathological cell-profile that reflects the relative amount and/or ratio of pathological cell/s in at least two pathological cell-related classes.
Step (b) of the disclosed methods involves determining for the subject a negative or positive prognosis; and/or the responsiveness to the treatment regime, based on the pathological cell-profile generated in step (a).

More specifically, in some embodiments, detecting and classifying the sub-cellular localization of the proteasome according to step (a), is performed by a method comprising:

One step involves applying a machine learning (ML) model on at least one input image of the sample, the machine learning model is a model, which has been trained using a partially and weakly labelled training dataset of images.

It should be noted that for each input image, the machine learning model is configured to provide as output, C probability maps, where c is defined according to the number of classes in a group of classes which includes at least two cell-related classes and a background class. Each map of the c probability maps corresponds to a respective class, and each cell-related class in the group of classes reflects a respective distribution of the proteasome within the cell. Still further, the C probability maps provide collectively, for each pixel in the input image, a respective probability vector comprising C probability values, each value indicating the probability that the pixel belongs to a certain class in a group of classes.

Another step involves applying post-processing on the output, comprising:
detecting one or more pathological cell in the at least one input image, based on the probability vectors, and classifying each detected pathological cell to a respective class in the group of classes, based on the probability values in the probability maps of pixels located in the detected object of interest, thereby identifying one or more classified pathological cells in the at least one input image.

A further aspect of the present disclosure relates to a method for determining a personalized treatment regimen for a subject suffering from a pathologic disorder, the method comprising the steps of:
In step (a), detecting and classifying the sub-cellular localization of the proteasome in at least one biological sample of the subject to generate a pathological cell-profile reflecting the relative amount and/or ratio of pathological cell/s in the at least two pathological cell-related classes.
Step (b), involves determining the responsiveness of the subject to at least one treatment regime, based on the pathological cell-profile generated in step (a).
Step (c), involves selecting a treatment regimen based on the responsiveness determined in (b).

In some embodiments, detecting and classifying the sub-cellular localization of the proteasome according to step (a), is performed by a method comprising: One step involves applying a single machine learning (ML) model on at least one input image of the sample. Wherein the machine learning model is a model, which has been trained using a partially and weakly labelled training dataset of images.

It should be noted that for each input image, the machine learning model is configured to provide as output, C probability maps, where c is defined according to the number of classes in a group of classes which includes at least two cell-related classes and a background class. Each map of the c probability maps corresponds to a respective class, and each cell-related class in the group of classes reflects a respective distribution of the proteasome within the cell. Still further, the C probability maps provide collectively, for each pixel in the input image, a respective probability vector comprising C probability values, each value indicating the probability that the pixel belongs to a certain class.

Another step involves applying post-processing on the output, comprising:
detecting one or more pathological cell in the at least one input image, based on the probability vectors, and classifying each detected pathological cell to a respective class in the group of classes, based on the probability values in the probability maps of pixels located in the detected object of interest, thereby identifying one or more classified pathological cells in the at least one input image.

A further aspect of the present disclosure relates to a method for treating, preventing, inhibiting, reducing, eliminating, protecting or delaying the onset of at least one of: at least one neoplastic disorder and/or at least one protein misfolding disorder in a subject in need thereof. More specifically, the method comprising the steps of:
In step (a), detecting and classifying the sub-cellular localization of the proteasome in at least one biological sample of said subject to generate a pathological cell-profile reflecting the relative amount and/or ratio of pathological cell/s in at least two pathological cell-related classes.
Step (b) involves determining the responsiveness of the subject to at least one treatment regime, based on the pathological cell-profile generated in step (a).
Step (c) involves subjecting a subject (e.g., administering to the subject) that was determined as a responder, to the treatment regimen, thereby treating the subject with the selected treatment regimen.

In some embodiments, detecting and classifying the sub-cellular localization of the proteasome according to step (a), is performed by a method comprising: One step involves applying a single machine learning (ML) model on at least one input image of the sample. Wherein the machine learning model is a model, which has been trained using a partially and weakly labelled training dataset of images.

It should be noted that for each input image, the machine learning model is configured to provide as output, C probability maps, where c is defined according to the number of classes in a group of classes which includes at least two cell-related classes and a background class. Each map of the c probability maps corresponds to a respective class, and each cell-related class in the group of classes reflects a respective distribution of the proteasome within the cell. Still further, the C probability maps provide collectively, for each pixel in the input image, a respective probability vector comprising C probability values, each value indicating the probability that the pixel belongs to a certain class.

Another step involves applying post-processing on the output, comprising:
detecting one or more pathological cell in the at least one input image, based on the probability vectors, and classifying each detected pathological cell to a respective class in the group of classes, based on the probability values in the probability maps of pixels located in the detected object of interest, thereby identifying one or more classified pathological cells in the at least one input image.

A further aspect of the present disclosure relates to a diagnostic system comprising at least one computer circuitry configured to execute a method of training machine learning model for detection and multi-class classification of pathological cells in an image using a single machine learning model for both detection and classification, in accordance with the present disclosure.

These and further aspects of the present disclosure will become apparent by the hand of the following disclosure.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1. Architecture

A UNet-based network with the number of features maps and spatial dimensions listed at the top and bottom of each block, respectively.

FIG. 2. Proteasome cellular localization classes

Examples from each of the disclosed classes. Each row contains examples of each individual class, which index is shown on the left bar.

FIG. 3. Qualitative detection results on ‘det-test’.

Each tile is overlayed with its predicted cells. Blue, red and yellow dots represent tp (true positives), fp (false positives), fn (false negatives), correspondingly.

FIG. 4A-4C. Qualitative classification results on ‘class-test’

FIG. 4A. ‘baseline’ method

FIG. 4B. ‘ours-ring’ method

FIG. 4C. ‘ours-vor’ method

The annotated ground truths are marked as bounding boxes. Cooler tones represent nuclear cells, whereas warmer tones represent cytosolic cells. The exact colormap is: −4: red, −3: pink, −2: orange, −1: yellow, 0: white, 1: green, 2: cyan, 3: blue, 4: purple, 5: grey.

FIG. 5. Classification confusion matrix of the output of the ‘ours-vor’ approach

FIG. 6A-6C. Patient histograms

FIG. 6A(i)-(iii). Bone marrow sample from three patient' slides, tagged globally by a pathologist, as ‘nuclear’ (FIG. 6A(i)), ‘evenly distributed’ (FIG. 6A(ii)) and ‘cytosolic’ (FIG. 6A(iii)).

FIG. 6B(i)-(iii). Example tile from the Whole Slide Image (WSI) per each corresponding sample.

FIG. 6C(i)-(iii). Accumulated histogram per each corresponding sample.

FIG. 7A-7B. The computer system

FIG. 7A. The figure discloses a block diagram schematically illustrating a computer system according to some examples of the presently disclosed subject matter.

FIG. 7B. is a schematic block diagram showing modules comprised as part of computer 10, according to some examples of the presently disclosed subject matter.

FIG. 8. A flowchart of operations carried out as part of object detection and classification process, according to examples of the presently disclosed subject matter.

FIG. 9. A flowchart of operations carried out as part of the preprocessing, according to examples of the presently disclosed subject matter.

FIG. 10. A flowchart of operations carried out as part of the training process, according to examples of the presently disclosed subject matter.

FIG. 11. A flowchart of operations carried out as part of an object detection procedure, according to examples of the presently disclosed subject matter.

FIG. 12 A flowchart of operations carried out as part of an object classification procedure, according to examples of the presently disclosed subject matter.

### DETAILED DESCRIPTION OF EMBODIMENTS

Detection and classification of cells in immunohistochemistry (IHC) images play a vital role in modern computational pathology pipelines. Biopsy scoring and grading at the slide level is routinely performed by pathologists, but analysis at the cell level, often desired in personalized cancer treatment, is both impractical and non-comprehensive. With its remarkable success in natural images, deep learning is already the gold standard in computational pathology. Currently, some learning-based methods of biopsy analysis are performed at the tile level, thereby disregarding intra-tile cell variability; while others do focus on accurate cell segmentation, but do not address possible downstream tasks. Due to the shared low and high-level features in the tasks of cell detection and classification, these can be treated jointly using a single deep neural network, minimizing cumulative errors and improving the efficiency of both training and inference.

The present inventors constructed a novel dataset of Proteasome-stained Multiple Myeloma (MM) bone marrow slides, containing nine categories with unique morphological traits. With the relative difficulty of acquiring high-quality annotations in the medical-imaging domain, the proposed dataset is intentionally annotated with only part (for example 5%) of the cells in each tile. To tackle both cell detection and classification within a single network, the inventors modeled these as a multi-class segmentation task and trained the network with a loss function that combines a partial cross-entropy loss component and energy-driven (smoothness) loss component. However, as full segmentation masks are unavailable during both training and validation, evaluation is performed on the combined detection and classification performance. The strategy disclosed herein, uniting both tasks within the same network, achieves a better combined Fscore, at faster training and inference times, as compared to similar disjoint approaches.

More specifically, as indicated above, envisioning the application of Whole Slide Images (WSI) cell-level profiling, the present inventors propose simultaneous detection and classification of cells into multiple categories of interest. Apart from minimizing the propagation of errors from one network to the other, improving overall robustness of the solution, this reduces training and inference times, both crucial for WSIs. As compared to other works which suggest joint detection and classification [15, 16], the methods and systems of the present disclosure do not rely on fully-supervised annotated datasets but use a relatively small and compact set of weak partial annotations.

Still further, as a proof of concept, the present disclosure proposes a novel dataset of Proteasome-stained IHC images of bone marrow biopsies diagnostic for Multiple Myeloma (MM). MM is a malignancy of plasma cells—immune cells which specialize in the production of antibodies, accounting for about 20% of hematological malignancies, and as much as 2-3% of all human cancers [Siegel, R. L., et al., A Cancer Journal for Clinicians 72(1), 7-33 (January 2022)]. As part of avast drug re-purposing project, it has been discovered that proteasome inhibitors, such as Bortezomib [Richardson, P. G., et al.: New England journal of medicine 352(24), 2487-2498 (2005)], are highly efficient for the treatment of MM. The proteasome is the catalytic arm of the ubiquitin proteasome system, largely responsible for selective cellular protein degradation [Livneh, I., et al., Cell research 26(8), 869-885 (2016)]. Unfortunately, despite the dramatic improvement in survival of many MM patients, the disease is still considered incurable, and virtually all of them experience a relapse of the disease [Botta, C., et al., Blood advances 1(7), 455-466 (2017)]. Notably, it is yet to be unraveled why some patients experience relapse within 2-3 years, while others enjoy a remission as long as 8-9 years. Such a difference may stem from a molecular variability between such patients, which may be determined using IHC staining and analysis at the cell-level. Since MM serves as a suitable prototype and desirable subject for such testing of intra- and inter-patient variability, and since the proteasome is highly abundant in the malignant MM cells, the inventors chose to stain MM biopsies for the proteasome to establish the proposed network disclosed herein.

The dataset of used in the example disclosed herein contains point or bounding box annotations with corresponding class information of approximately 5% of the cells in each image. The cells are graded from −4 (most cytosolic) to 4 (most nuclear), amounting to nine distinct classes, with unique morphological signatures. To account for the high level of detail the task of MM biopsy profiling requires, the inventors propose detecting and classifying each and every cell in the WSI for the purpose of aggregating it into a unique histogram representation. This is done by a simultaneous detection and classification neural network, trained end-to-end on the input partial annotations. The above tasks were modeled as multi-class semantic segmentation, such that the network outputs C (number of classes) segmentation maps. Since both training and validation sets as used herein do not include full segmentation masks, the performance of the network was evaluated using a combined Fscore of both detection and classification.

To further improve the method disclosed by Qu et al [17], the partial point labels were encoded as concentric multiclass circles and surrounding background rings, disregarding all other pixels. The inventors optimized a UNet network [Ronneberger, O., et al. In: International Conference on Medical image computing and computer-assisted intervention. pp. 234-241. Springer (2015)], with its encoder pre-trained on ImageNet [Russakovsky, O., et al. International Journal of Computer Vision 115(3), 211-252 (2015)]. The loss function consists of a partial cross-entropy term [Tang, M., et al. In: Proceedings of the European Conference on Computer Vision (ECCV). pp. 507-522 (2018) 53], ensuring fidelity to the extended concentric multi-class labels, and an energy-based smoothness promoting term [Golts, A., Freedman, D., et al. IEEE Journal of Selected Topics in Signal Processing 15(2), 324-338 (2021)] which enforces the output probability maps to correlate with the edges of the input image. Once training is finished, the network disclosed herein can infer the position and class of each cell in an input tile using a single forward-pass operation. The experiments presented herein show that the disclosed method can achieve a higher combined Fscore, at faster training and inference speeds, as compared to the approach of training each task disjointly.

The presently disclosed subject matter includes a computer implemented method of object detection and multi-class classification using a single machine learning model (e.g., implemented as a single deep neural network). As opposed to using an additional classifier following object detection this approach is more efficient and may also reduce errors which are normally accumulated from one model to another, thereby improving accuracy and robustness of the solution. As further explained herein the approach disclosed herein is particularly useful when the training dataset is weakly and partially annotated and enables to obtain high quality detection and classification output even under such conditions. Partial labelling refers to the labeling of only part of the objects in the images of the training dataset and weakly labeling refers to labeling of only part of the pixels of a labeled object.

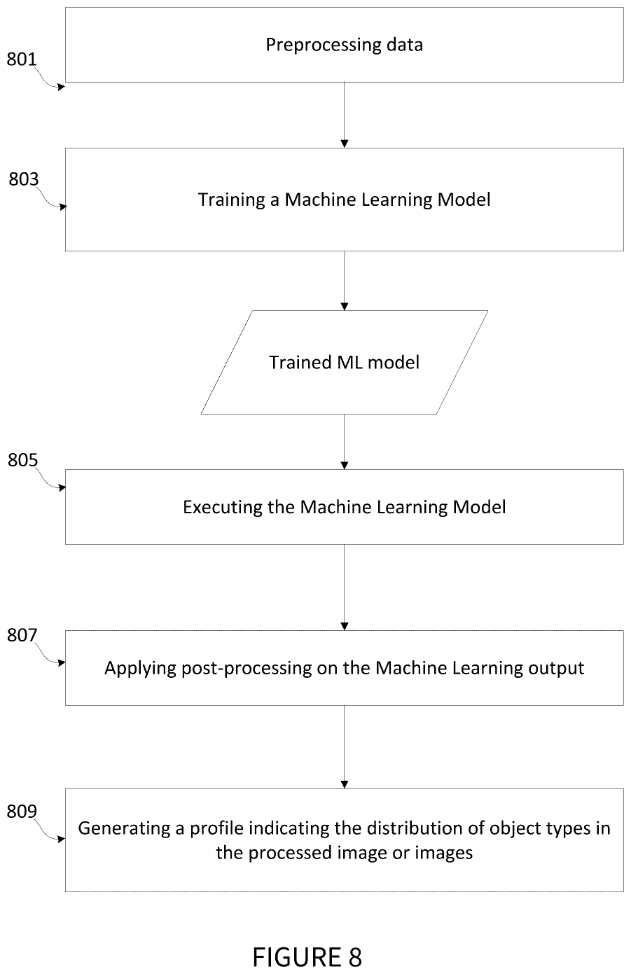

In some examples, the computer implemented method can be divided into different stages, where each stage is dedicated for completing a distinct part of the complete process. In some examples, the different stages may be each executed by a different computer device, where each device may optionally be located at a different geographical location, while in other examples different stages may be executed by the same computer device. As illustrated in FIG. 8, in some examples the method can be divided into four main stages, including:
stage 1—preprocessing, including training dataset preparation;
stage 2—machine learning training;
stage 3—machine learning execution; and
stage 4—machine learning output postprocessing.

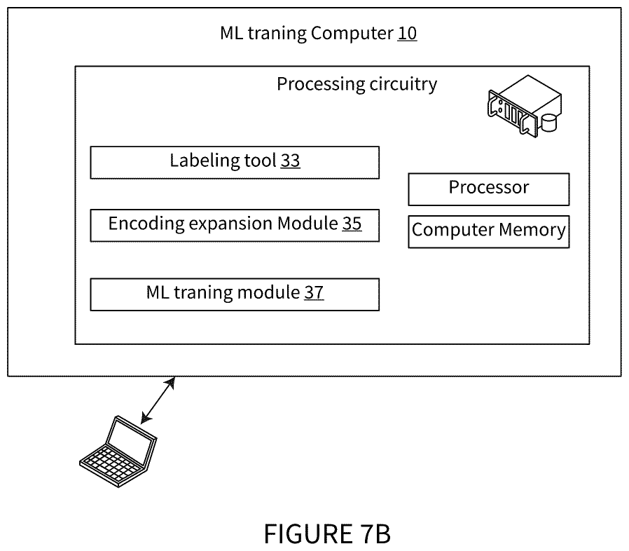

FIGS. 7a and 7b are block diagrams schematically illustrating, by way of non-limiting example, a computer system configured to carry out operations of the computer implemented method of detection and multi-class classification of objects of interest in an image, as disclosed herein.

FIGS. 7a and 7b show general schematic illustrations of the system architecture in accordance with a non-limiting example of the presently disclosed subject matter. Elements in FIGS. 7a and 7b can be made up of any combination of software and hardware and/or firmware that performs the functions as defined and explained herein. Elements in FIGS. 7a and 7b may be centralized in one location or dispersed over more than one location. In other embodiments of the presently disclosed subject matter, the system may comprise fewer, more, and/or different elements than those shown in FIGS. 7a and 7b. Likewise, the specific division of the functionality of the disclosed system to specific parts as described below, is provided by way of example, and other various alternatives are also construed within the scope of the presently disclosed subject matter. For example, FIGS. 7a and 7b shows machine learning training computer 10 and machine learning execution computer 12, which can be both implemented on the same computer device or otherwise can be each implemented on a sperate computer device located remotely one from the other. Furthermore, the subject matter disclosed herein includes a preprocessing stage (that includes the generation of the training dataset) and a postprocessing stage (that includes the post-processing of the machine learning output). It is noted that operations related to the pre-processing stage and/or postprocessing stage can be executed by any one of learning training computer 10 and machine learning execution computer 12, or by one or more other computer devices that may be designated for performing the relevant operations.

Some operations are described herein with reference to components shown in FIGS. 7a and 7b, however this is done for the sake of completions and clarity of the description only and should not be construed to limit the scope of the disclosed subject to the specific design and/or components illustrated in FIGS. 7a and 7b. As described below, a processing circuitry can be configured to execute several functional modules in accordance with computer-readable instructions implemented on a non-transitory computer-readable storage medium. Such functional modules are referred to hereinafter as comprised in the processing circuitry.

Given an image that includes objects (or elements) of interests (e.g., images of MM cells as discussed above) and background areas, a machine learning model is trained for detecting the objects of interests in the image and classifying the detected objects to one of a plurality of classes. The number of classes (denoted by ‘C’) can be any number greater than 1 in addition to a background class (e.g., 3, 4, 5, 6, etc.). According to the example disclosed above of MM cells, C=11, including 9 cell classes (i.e., object-related classes), 1 background class and 1 non-relevant (e.g., non-malignant cells) class.

Referring to the preprocessing stage (block 801), it can be executed for example with the help of machine learning training computer 10 or by some other designated computer device. FIG. 7b is a schematic block diagram showing modules comprised as part of computer 10, according to some examples of the presently disclosed subject matter.

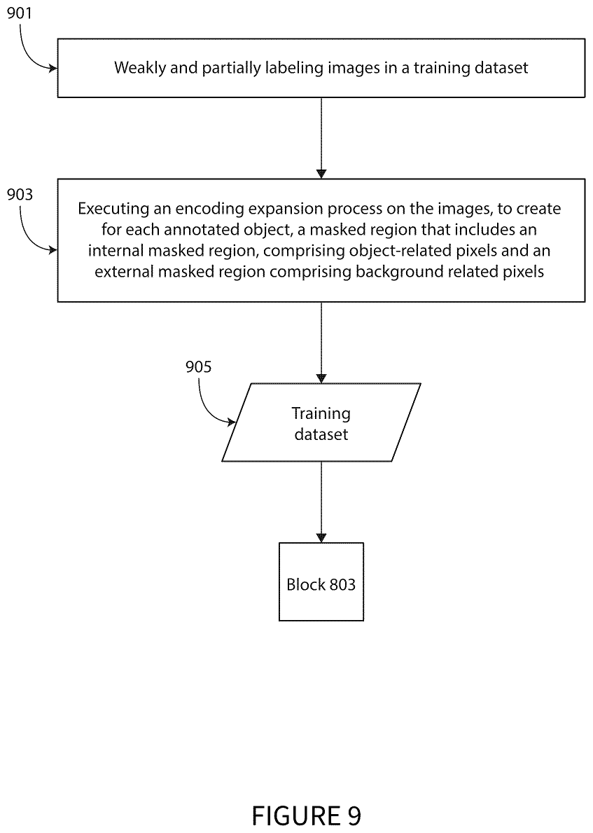

Operations carried out as part of the preprocessing stage are shown in FIG. 9.

A training dataset comprising a plurality of images for training the machine learning model is generated. As described above, in one possible use case, images are Whole Slide Images (WSIs), where in some examples the results of the WSI analysis includes a plurality of tiles generated from each scanned tissue slide.

The applied machine learning model is a partially and weakly supervised model. Accordingly, during the training dataset preparation only part of the objects of interest in each image are labeled. Furthermore, labeling of an object includes the labeling of only part of the pixels of the labeled object. According to one non-limiting example only 5% of the objects (e.g., cells) are labeled. According to some examples, for a given object which is being labeled, a subset of pixels of the object located substantially at its center (or substantially at the center of a bounding box placed around the object's boundaries) are labeled. In the example described above, of MM cells, labeling includes the ranking of the cells from −4 (most cytosolic) to 4 (most nuclear), amounting to nine distinct classes, with unique morphological signatures.

According to one example, initially a manual annotation process takes place (block 901). To this end, computer 10 can execute for example a software tool (33) that enables a user (human annotator) to interact with images displayed by computer 10, receive the annotation input provided by the user and generate the partially and weakly dataset accordingly.

According to some examples, the weak labeling is such that only a few pixels are labeled by the human annotator. According to yet a further example, only a single pixel is labeled. The annotated pixel (or pixels) can be located substantially at the center of the object, but this is not always necessary. Weak labeling of only a few pixels (e.g., between 1 to 5 pixels at the center of the object) considerably simplifies the annotation work, which is generally very labor intensive.

Following the manual labeling, a computer implemented process (referred to herein also as “encoding expansion process”) is executed (block 903; e.g., by encoding expansion module 35). The purpose of the encoding expansion process is to expand the annotation of the one or more human annotated pixels by automatically identifying and annotating a subset of pixels surrounding the annotated pixel to thereby create a masked region (otherwise referred to as “annotated region”) that corresponds to the objects. All pixels in the same masked region are classified to the same class of the manually annotated pixel located substantially at its center. According to some examples, the size of the masked region is defined by a predefined radii of pixels around the manually annotated pixel (or pixels) at the center (e.g., an annotated circle of pixels having a radius of 5 pixels).

According to some examples the masked region is further expanded to include a second region of pixels which represents the background. To this end another ring can be added that encircles the masked region (e.g., having a radius of 7 pixels), thus generating an internal masked region and external masked region (i.e., area residing between the two rings), where the former is defined as the object and the latter is defined as the background. Notably, unless mentioned otherwise the term “masked region” as used herein refers to both the internal and external masked regions. See an example of the mathematical representation of the multi-class mask as presented by equation (2) shown below. The annotated dataset includes sampled images with labeled pixels that are used during the training stage.

It should be noted that the size of the radius defining the internal masked region and the size of the radius defining the external masked region (background), as well as the selection of a circle for indicating the masked regions, are each determined according to an expected size and shape of the relevant objects, where in case the size an/or the shape of the objects of interest are different a different size of radii and/or a different shape can be used.

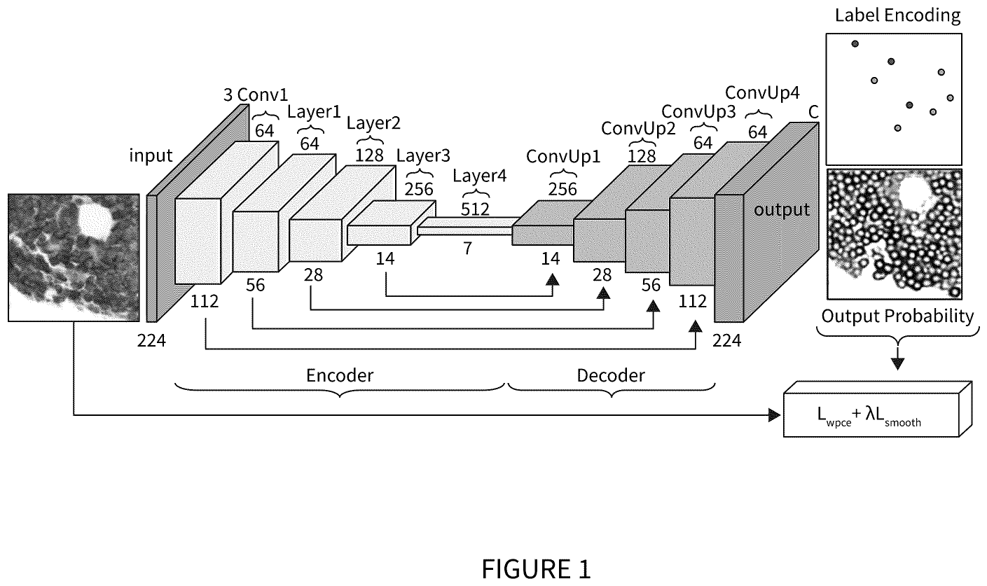

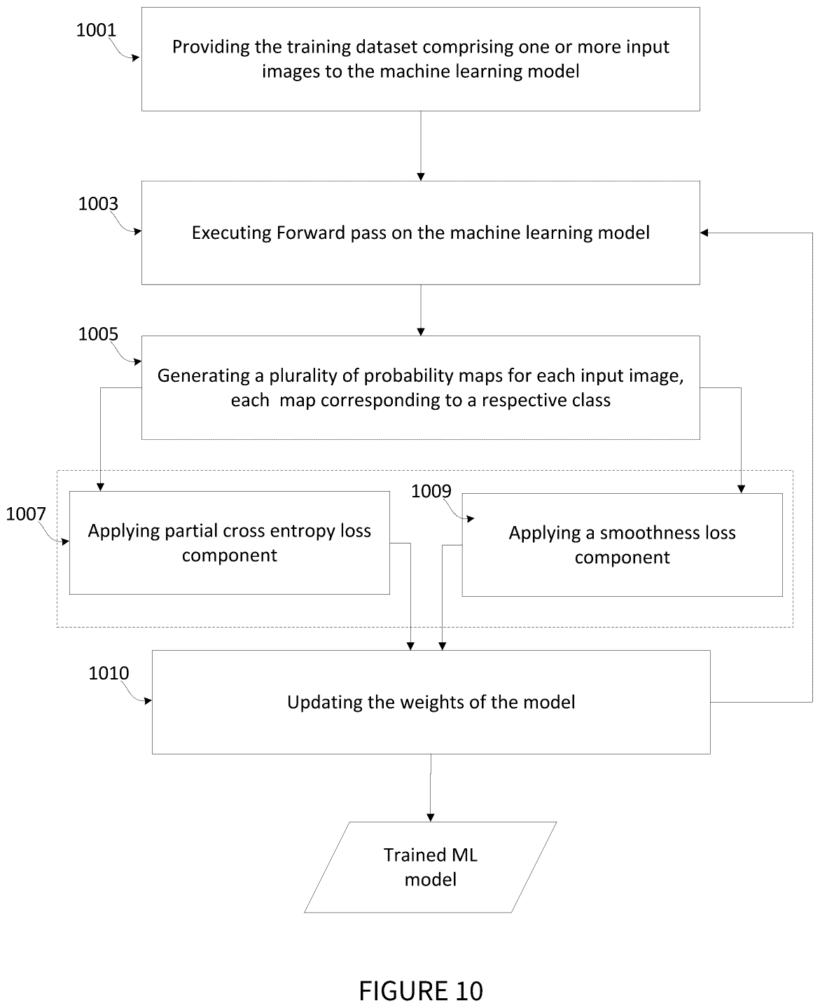

Once the training dataset is available training can be executed (block 803). FIG. 10 is a flowchart of operations carried out as part of the ML training, according to some examples of the presently disclosed subject matter. The training dataset that comprises partially and weakly annotated images that were expanded to include the full masked region is provided as input to the ML model (block 1001). During training the machine learning (ML) model is applied on the training dataset (e.g., by executing a forward pass on the model) to obtain the trained ML model which can be later applied on new unseen images to obtain the desired output (block 1003). The machine learning model can be for example, a deep learning Neural Network such as a UNet convolutional network as illustrated schematically with respect to FIG. 1 and discussed below. Training of the ML model can be carried out for example by ML training module 37 in computer 10, e.g., by a GPU such as GTX Titan-X Nvidia GPU or similar. The training dataset can be stored for example, in a computer storage device (14) accessible to machine learning training computer 10.

The ML model is trained to correlate between the image data (e.g., red-green-blue (RGB) values) and a certain class from a group of possible classes. In some examples, during training a plurality of probability maps are generated for each input image (e.g., tile), where each probability map corresponds to one of the classes (block 1005). Each probability map indicates for each pixel in the input image, the probability that the pixel belongs to the corresponding class.

Referring to the example of MM cells mentioned above, in case of 9 cell classes (ranging from −4 to 4), 11 probability maps are generated during the ML training process, 9 of the 11 correspond to the 9 classes respectively, one probability map corresponds to background and one probability map corresponds to “non-relevant” (e.g., non-malignant cells appearing in the biopsy).

In some examples, the collection of probability maps can be perceived as a three-dimensional probability map (or “cube”) generated by superimposing the maps one on top of the other, having the size of the original image (L_{ength}*W_{idth}) and a depth (the z axis, assuming the image plane is defined by the x and y axes) according to the number of classes (C). The three-dimensional probability map provides along its Z axis, for each pixel in the image, a probability vector indicating the probabilities that the pixel belongs to each one of the classes (where the sum of the probabilities in each probability vector equals 1). Notably, the training dataset as disclosed herein above combines information pertaining both to the localization and to the class of each annotated object (e.g., MM cell) and accordingly assists in using a single ML model for both detection (e.g., localization) and classification of the objects.

As mentioned above, a loss function is used for training the model. In some examples the loss function includes a partial cross-entropy loss component and a smoothness component (blocks 1007 and 1009). A partial cross-entropy loss component enables to evaluate the output, relative to the ground truth, of a partially (and weakly) supervised ML model as opposed to a regular cross-entropy loss function which is applied on a fully supervised dataset. Furthermore, since the partial cross-entropy loss component is applied on masked regions, which represent the object of interest, its application contributes to both detection and classification of objects, as the ML output allows completion of both tasks as further discussed below.

According to examples of the presently disclosed subject matter the partial cross-entropy loss component is configured to enforce an output probability according to the ground truth only on pixels in the masked regions. More specifically, the model enforces a probability on pixels in the internal masked region to one of the object related classes and a probability of the pixels in the external masked region as background. Probability errors in pixels located outside the masked region do not induce the same loss function penalty and in some examples such errors are ignored by the model during training. Thus, while a probability is assigned to all pixels in image, the cross-entropy loss component gives greater weight to the masked areas.

In some examples, an additional weighting coefficient f (referred to herein as “energy-based smoothness component” or “smoothness component”) added to the loss function, which enables to preserve smoothness of the output probabilities notwithstanding the partial annotation (see equations 4 and 5 in the examples section).

More specifically, given the probabilities provided as output by the ML model, the smoothness component applies a higher penalty on neighboring pixels with similar values (e.g., RGB values), which are assigned by the ML model with different output probabilities (i.e., indicating different classes), as compared to neighboring pixels with different values that reside on opposite sides of transitional areas, such as an edge or boundary in the image, which are assigned by the ML model with different output probabilities. This approach enables to preserve prominent edges in the image, while ensuring that smooth areas (e.g., internal area of a cell) will have similar output probability with little variance.

In the example of MM cells, neighboring pixels with similar image values located in a cell area (i.e., in the internal masked region), which are assigned by the ML model with different probabilities are more highly penalized as compared to neighboring pixels, where one is in a cell area and the other in a background area, with different image values which are assigned by the ML model with different probabilities.

Notably, according to one example, similarity between pixel color is measured as the Euclidean distance between the RGB values of one pixel over the other. A weight function can be applied that translates the distance between pixels in terms of color, to a weight scalar. For example, pixels which have color RGB (0,100,0) and (0,101,0) will have smaller weights, pixels that have colors (0,250,0), (250,0,0) will have much higher weight.

The partial entropy loss function measures the error of the prediction of the ML models, and, along with the influence of the smoothness component, the gradients of this loss are used to update the weights of the model using an optimization algorithm (block 1010). The training process then returns to block 1003 for another forward pass until the training is terminated and the trained model is obtained.

During the execution stage (block 805) the trained (single) ML model is applied on one or more input images to enable detection and classification of the corresponding objects (e.g., MM cells) in the images. For each image that is provided as input to the ML model, the output, which is provided by the model includes C images, each representing a probability map corresponding to one of the classes, where C equals to the number of classes. Inference of a new image can be performed for example, by a forward-pass over the trained network (ML model), resulting in C SoftMax probability maps. According to the example above, C=11. According to some examples, in each probability map a uint8 value (ranging between 0-255) is assigned to each pixel in the input image, indicating the probability that the pixel belongs to the class represented by the respective probability map.

As explained above with respect to training, the collection of C maps therefore provides for each pixel in an input image, a vector with C probability values, each value indicating the probability that the pixel belongs to a specific class of the C classes. In some examples, ML execution can be performed by ML execution computer 12, e.g., comprising GPU such as GTX Titan-X Nvidia GPU or other, as mentioned above.

According to some examples, pixel classification in the processed image can be done based on the maximal probability value in the respective vector of each pixel.

According to other examples, additional post-processing is performed for object detection and classification (block 807). Operation executed during this stage can be performed by way of example by processing circuitry 20 which can be implemented as part of computer 12 or on a different computer, e.g., a dedicated and separate computer device.

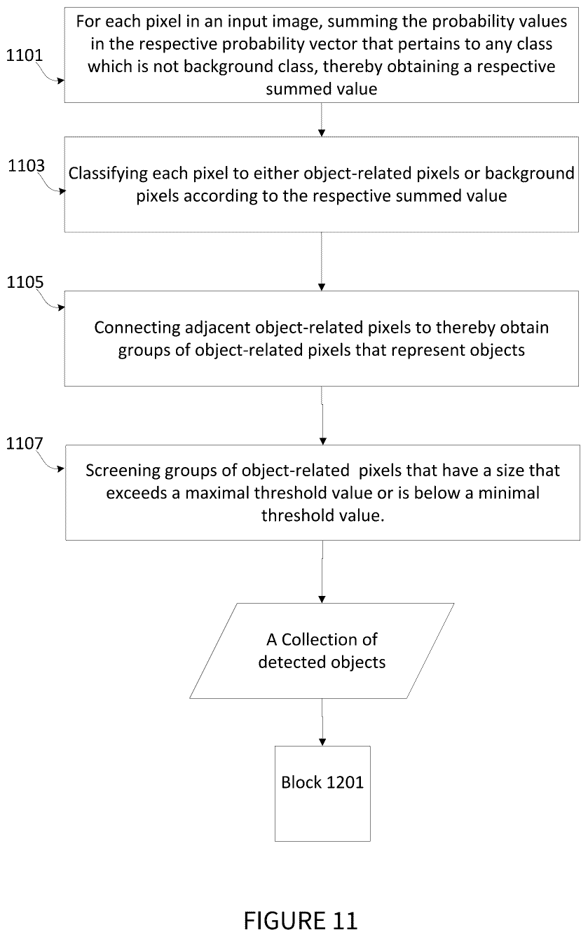

Object detection procedure is executed as part of the post-processing. FIG. 11 is a flowchart of operations carried out as part of an object detection procedure, according to examples of the presently disclosed subject matter. For each pixel in the input image summing the probability value of all C values in the respective vector which pertain to an object (block 1101). In other words, all values in the respective probability vector, except the one representing the background are summed (C-1). This summation results in a map of summed values (a summed value for each pixel in the input image; also referred to herein as “summed object-related probability values”) that shows strong signals (indicated by greater values) where objects of interest (e.g., cells) are located and weaker signals (indicated by lower values) where background areas are located. According to an alternative approach the background value in each probability vector is compared to a threshold and used to determine whether the pixel belongs to an object or background.

The pixels are classified as being part of an object or part of the background based on their respective summed value (block 1103). In some examples, to transform the data from pixel level data to object level data, a predefined threshold (e.g., 0.5) is applied on the summed probability values, where any pixel having a respective summed value above the threshold is identified as a part of an object of interest (referred to herein as “object-related pixel”) and any pixel having a respective summed value below threshold is identified as part of the background.

Neighboring object-related pixels identified as part of an object of interest are connected to thereby create groups of object-related pixels which represent objects (block 1105). To this end algorithms for connecting neighboring pixels can be used, which are well known in the art (e.g., connected components algorithm). Notably, continuity between pixels is enhanced by the smoothness component.

According to some examples, a screening step is applied, where objects which have a size that exceeds a certain maximal threshold value or a size that is below a certain minimal threshold value, are removed from the collection of objects (block 1107). The maximal and minimal thresholds are defined according to the type of objects in the processed images.

At this point groups of object-related pixels (aka “blobs”) that represent objects (e.g., MM cells) have been obtained. Operations described above as part of the object detection procedure can be executed for example by object detection module 21.

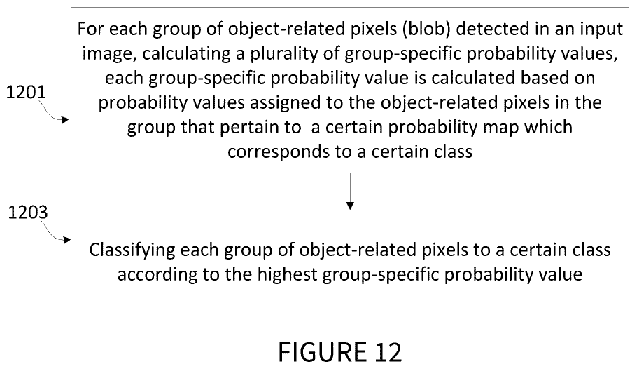

Object classification procedure is executed as part of the post-processing. FIG. 12 is a flowchart of operations carried out as part of an object classification procedure, according to examples of the presently disclosed subject matter. Reverting to the multi-class probability maps created by the ML model, for each group of object-related pixels (blob), which is identified as an object the following is performed:
Calculating a collective value (also referred to as “group-specific probability value”) for each class (represented by a respective probability map) based on the collection of values of the pixels in the respective probability map that are part of the blob, obtaining altogether C-1 collective values for each blob, one per each non-background class (block 1201). In some examples, the collective value is calculated as an average of the pixel values. Reverting to the example mentioned above of MM cells, 10 average values are obtained for each blob, representing a cell, that is identified in the image.
Classifying the blob to a respective class (“selected class”) according to the highest collective value of the C-1 collective values (block 1203). Operations described above as part of the classification procedure be executed for example by Object classification module 23 in FIG. 7.

As apparent from the above description, special post-processing is applied on the ML output obtained from the execution of a single ML model, which includes the C probability maps for each image, that enables both detection of objects and multi-class classification of the detected objects.

The ML model can be applied on multiple images. In some examples, the ML output undergoes further processing (e.g., by profiling module 25, FIG. 7) that includes aggregating object classifications in one or more input images or sub-images, into subsets (block 811, FIG. 8). According to one non-limiting example this can be done by aggerating the objects in a histogram according to their respective classification, where column in the histogram represents a certain class. As explained above with respect to the example of MM cells, this approach enables to obtain a patient's profile indicative of the MM cell classes distribution in a sampled tissue extracted from the patient. The profile can be used for example for patient's diagnosis, prognosis and assignment of patient-specific treatment. Once the histogram profile is available it can be used to correlate a prognosis or diagnosis to the relevant subject (e.g., MM patient) as well as an appropriate treatment regimen (e.g., by module 27, FIG. 7). In other examples, e.g., analysis of leaves for detection and classification of leaves spots or blights, the histogram profiling can be used to identify disease types. In a further example, of satellite imagery of roads for detection and classification of vehicles travelling on the roads.

Thus, in a first aspect, the resent disclosure provides a computer implemented method of detection and multi-class classification of objects of interest in an image, using a machine learning model (e.g., a deep neural network). The method comprising the following steps: Applying the machine learning model on at least one input image, wherein the machine learning model is a model, which has been trained using a partially and weakly labelled training dataset of images.

For each input image, the machine learning model is configured to provide as output, c probability maps, where C is defined according to the number of classes in a group of classes. Each map of the c probability maps corresponds to a respective class and comprises, with respect to each pixel in the input image, a respective probability value indicative of a probability that the pixel belongs to the respective class. Still further, the c probability maps provide collectively, for each pixel in the input image, a respective probability vector comprising c probability values each value indicating the probability that the pixel belongs to a respective class.

Applying post-processing on the output, comprising:
Detecting objects of interest in at least one input image, based on the probability vectors and classifying each detected object of interest to a respective class in the group of classes, based on the probability values in the probability maps, of pixels located in the detected object of interest.
Wherein the machine learning model is a single machine learning model (e.g., a single deep neural network) which is used for both detection and classification of the objects of interest.

In some embodiments, for multi-class classification of one or more objects of interest, the computer implemented method of the present disclosure further comprises:
for each pixel in the input image:
Summing all probability values in the respective probability vector that correspond to the object and not the background to thereby obtain a respective summed object-related probability value of the pixel;
Identifying each pixel as an object-related pixel which is part of an object, based on a comparison of the respective object-related probability value to a threshold value;
Connecting nearby object-related pixels to thereby identify groups of object-related pixels, where each group of object-related pixels represents a respective object in the input image;
for each map of a subset of the c probability maps (e.g., the subset includes c-1 maps): for each group of object-related pixels in the map calculating a respective group-specific probability value, thereby obtaining a plurality of (e.g., c-1) group-specific probability values;
classifying each group of object-related pixels to a selected class based on the plurality of group-specific probability values.

In some embodiments, each group-specific probability value of the computer implemented method of the present disclosure is an average of probability values of object-related pixels in the respective group of object-related pixels.

In yet some further embodiments, the selected class of the computer implemented method the present disclosure, is a class corresponding to a probability map associated with the highest group-specific probability value of the plurality of group-specific probability values.

In some embodiments, the computer implemented method of the present disclosure further comprises a screening step. Such step comprises removing groups of object-related pixels having a size greater than a certain maximal threshold or a side smaller than a certain minimal threshold.

In some embodiments, the group of classes of the computer implemented method the present disclosure, includes at least three object-related classes and a background class.

In some further embodiments, each probability value is a uint8value and wherein the sum of probability values in each probability vector equals to 1.

Still further, in some embodiments, of the computer implemented method the present disclosure further comprises assigning each classified object of the one or more classified objects to a respective subgroup according to the respective class of the classified object.

It should be understood that the distribution of the one or more classified objects to different subgroups provides an object related profile.

In some specific embodiments, this step comprises generating graphical presentation for the different subgroups, e.g., a histogram where each column in the histogram represents a respective class and indicates a number of objects in the at least one input image that were classified to the respective class.

In some embodiments, the input images are images of a biological sample, and the objects are cells in the biological sample, or any organelles and/or cell compartments thereof.

Still further, in some embodiments of the computer implemented method the present disclosure, the biological sample is a sample of a subject. In yet some further embodiments, the objects are cells. In some particular embodiments, the object of interest may be pathological cells. In some embodiments, each class in the group of classes is indicative of a respective distribution or spread of at least one biomarker within the cell.

It should be noted that in some embodiments, each annotated cell is ranked for the spread of the biomarker within the cell.

In some embodiments, the respective spread of the at least one biomarker used by of the computer implemented method the present disclosure, indicates the sub-cellular localization of the at least one biomarker and/or the relative amount and/or the relative ratio of the biomarker in the specific cell compartment and/or organelle. In some embodiments, the specific cell compartment or organelle may be any cellular organelle, e.g., nucleus, lysosome, mitochondria, endoplasmic reticulum (ER), and/or any cellular compartments, for example, cytoplasm, or any membrane or cellular lumen.

In some specific embodiments of the computer implemented method the present disclosure, the subcellular localization comprises at least one of: a nuclear localization and a cytosolic localization of the at least one biomarker.

In more specific embodiments, the biomarker used by the computer implemented method the present disclosure is the proteasome, or any subunit thereof.

Still further, in some embodiments of the computer implemented method the present disclosure, the pathological cell is a neoplastic cell or a cell of a subject suffering from a protein misfolding disorder or a deposition disorder.

In more specific embodiments, such neoplastic cell is a cancer cell. In more specific embodiments, the cancer cell ma be at least one hematological malignancy.

In yet some further particular embodiments, the cancer cell is a Multiple Myeloma (MM) cell. In some embodiments, the biological sample is a bone marrow sample of a subject suffering from MM, or a subject suspected to be a MM patient.

In some embodiments, in at least part of images in the partially and weakly labelled training dataset of images, only a single pixel is labeled in a labeled object.

In some embodiments of the computer implemented method disclosed herein, the method further comprising applying an encoding expansion process on the weakly and partially labeled dataset before training, comprising:
for each labeled object in the training dataset:
automatically defining a first masked region surrounding at least one manually labeled pixel in the labeled object, wherein all pixels in the first region are classified to the same class as the at least one manually labeled pixel, and a second masked region surrounding the first mased region, wherein an area between the first masked region and the second masked region corresponds to background.

Still further, in some embodiments, the computer implemented method the present disclosure further comprises a training the machine learning model. More specifically, in some embodiments, the method comprising:
obtaining a training dataset comprising a collection of partially and weakly labelled images, where in each image only part of the objects are labeled, and only part of the pixels of each labeled object are labeled;
using the training dataset for training the machine learning model comprising: generating for each partially and weakly labeled image C probability maps, wherein each map corresponds to a respective class and comprises, with respect to each labelled pixel a respective probability value indicative of a probability that the pixel belongs to the respective class. Still further, wherein the C probability maps provide collectively, for each labelled pixel, a respective probability vector comprising c probability values each value indicating the probability that the pixel belongs to a respective class; and
iteratively applying a loss function on the training dataset.

In yet some further embodiments, the loss function includes a partial entropy loss component and a smoothness component wherein the smoothness component is configured to increase loss function penalty on neighboring pixels with similar values (e.g., colors), which are assigned by the ML model with different probabilities as compared to neighboring pixels with different values which are assigned with different probabilities and reside across transitional areas in an image.

A further aspect of the present disclosure relates to a computer program product, e.g. stored on a non-transitory computer-readable medium, comprising instructions which, when the program is executed by a computer, cause the computer to carry out a method in accordance with the computer implemented method the present disclosure.

In yet a further aspect, the present disclosure provides a computer program product operable in a computer and comprising instructions stored on a non-transitory computer-readable medium for causing the computer to execute a method of detection and multi-class classification of objects in an image, using a single machine learning model for both detection and classification. More specifically, the product is produced by the processes of:
Obtaining a training dataset comprising a collection of partially and weakly labelled images, where in each image only part of the one or more objects are labeled, and only part of the pixels of each labeled one or more objects are labeled.

Using the training dataset for training the machine learning model comprising: generating for each partially and weakly labeled image c probability maps, wherein each map corresponds to a respective class and comprises, with respect to each labelled pixel a respective probability value indicative of a probability that the pixel belongs to the respective class; wherein the c probability maps provide collectively, for each labelled pixel, a respective probability vector comprising c probability values each value indicating the probability that the pixel belongs to a respective class; and iteratively applying a loss function on the training dataset.

In some embodiments of the computer program product of the present disclosure, in at least part of images in the training dataset only a single pixel is manually labeled in each labeled object.

In some embodiments, the disclosed computer program product further comprising applying an encoding expansion process on the weakly and partially labeled dataset before training, comprising:
for each labeled object in the training dataset:
automatically defining a first masked region surrounding at least one manually labeled pixel in the labeled object, wherein all pixels in the first region are classified to the same class as the at least one manually labeled pixel, and a second masked region surrounding the first mased region, wherein an area between the first masked region and the second masked region corresponds to background.

In some embodiments, the loss function includes a partial entropy loss component and a smoothness component that is configured to increase loss function penalty on neighboring pixels with similar values, which are assigned by the machine learning model with different probabilities as compared to neighboring pixels with different values which are assigned with different probabilities and reside across transitional areas in an image.

A further aspect of the present disclosure relates to a computer implemented method of training machine learning model for detection and multi-class classification of objects in one or more images using a single machine learning model for both detection and classification. In some embodiments, the method comprising:
applying an encoding expansion process on the weakly and partially labeled dataset before training, comprising:
for each labeled object in the training dataset:
   automatically defining a first masked region surrounding at least one manually labeled pixel in the labeled object, wherein all pixels in the first region are classified to the same class as the at least one manually labeled pixel, and a second masked region surrounding the first mased region, wherein the area between the first masked region and the second masked region corresponds to background.

Using the training dataset for training the machine-learning model comprising generating for each partially and weakly labeled image c probability maps, each map corresponds to a respective class and comprises, with respect to each labelled pixel a respective probability value indicative of a probability that the pixel belongs to the respective class.

The c probability maps provide collectively, for each labelled pixel, a respective probability vector comprising c probability values each value indicating the probability that the pixel belongs to a respective class; and
Iteratively applying a loss function on the training dataset.

In some embodiments of the disclosed methods, the loss function is a partial cross-entropy loss function.

In some embodiments, in at least part of images in the training dataset only a single pixel is manually labeled in each labeled object.

In certain embodiments of the computer implemented method disclosed herein, the loss function includes a partial entropy loss component and a smoothness component, wherein the smoothness component is configured to increase loss function penalty on neighboring pixels with similar values, which are assigned by the machine learning model with different probabilities as compared to neighboring pixels with different values which are assigned with different probabilities and reside across transitional areas in an image.

A further aspect disclosed herein relates to a computer system comprising at least one processing circuitry configured to execute a method of detection and multi-class classification of objects in an image, using a single machine learning model for both detection and classification according to the present disclosure.

Still further aspect relates to a computer system comprising at least one processing circuitry configured to execute a method of training machine learning model for detection and multi-class classification of objects in an image using a single machine learning model for both detection and classification, according to the present disclosure.

A further aspect of the present disclosure relates to a diagnostic method for determining and multi-class classifying the sub-cellular localization of at least one biomarker in at least one biological sample. More specifically, the method comprising: Applying a machine learning model on at least one input image of the sample, wherein the machine learning model is a model, which has been trained using a partially and weakly labelled training dataset of images.

More specifically, for each input image, the machine learning model is configured to provide as output, c probability maps, where C is defined according to the number of classes in a group of classes which includes at least two object-related classes and a background class. It should be noted that each map of the c probability maps corresponds to a respective class and comprises, with respect to each pixel in the input image, a respective probability value indicative of a probability that the pixel belongs to the respective class. Still further, the c probability maps provide collectively, for each pixel in the input image, a respective probability vector comprising C probability values each value indicating the probability that the pixel belongs to a respective class in the group of classes.

Applying post-processing on the output, comprising:
Detecting objects of interest in at least one input image, based on the probability vectors and classifying each detected object of interest to a respective class in the group of classes, based on the probability values in the probability maps of pixels located in the detected object of interest, thereby identifying one or more classified objects in the at least one input image.

In some embodiments, the object/s in the disclosed diagnostic methods are cell/s in the biological sample or any organelles and/or compartments thereof. Thus, in some embodiments, the object-related classes are cell-related classes.

More specifically, as indicated above, the objects detected and classified by the disclosed methods may be cells that are classified according to distribution and/or cellular localization of a biomarker within the cells. A “cell” as used by the preset disclosure encompasses eukaryotic cells, as well as prokaryotic cells. In some specific embodiments, cells encompass any cell of the diagnosed subject, specifically a mammalian subject. Cells of eukaryotic organisms are elaborately subdivided into functionally-distinct membrane-bound compartments. Some major constituents of eukaryotic cells may include in some embodiments, plasma membrane, cytoplasm, specific organelles such as the nucleus, mitochondria, Golgi apparatus, endoplasmic reticulum (ER), peroxisome, vacuoles, cytoskeleton, nucleoplasm, nucleolus, nuclear matrix, as well as cell wall, outer membrane and periplasmic space (e.g., in prokaryotes). “Cellular compartments” or “compartment”, as used herein, comprise all of the closed parts within the cytosol of a eukaryotic cell, usually surrounded by a single or double lipid layer membrane. These compartments are often, but not always, defined as membrane-bound organelles. The formation of cellular compartments is called compartmentalization. Both organelles, the mitochondria and chloroplasts (in photosynthetic organisms), are compartments that are believed to be of endosymbiotic origin. Other compartments such as peroxisomes, lysosomes, the endoplasmic reticulum, the cell nucleus or the Golgi apparatus are not of endosymbiotic origin. Smaller elements like vesicles, and sometimes even microtubules can also be counted as compartments, and are also encompassed by the present disclosure. Still further, an “organelle” is a specialized subunit, usually within a cell, that display a specific function. Organelles are either separately enclosed within their own lipid bilayers (also called membrane-bound organelles) or are spatially distinct functional units without a surrounding lipid bilayer (non-membrane bound organelles). They include structures that make up the endomembrane system (such as the nuclear envelope, endoplasmic reticulum, and Golgi apparatus), and other structures such as mitochondria and plastids. Thus, it should be understood that by referring in the present disclosure to the subcellular localization of a biomarker, any of the disclosed cell compartments are encompassed.

Still further, it should be noted that “Cell-related” refers to any part or fragment of a cell, including any part or fragment of a cellular component or an organelle. Still further, a “biomarker”, or “biological marker”, as referred to in the present disclosure, is a measurable indicator of some biological state or condition. A biomarker can be any traceable substance, for example, a protein, or any complex thereof, that may be either introduced into an organism as a means to examine a specific condition or alternatively, can also be any substance naturally produced by specific organs, tissues or cells of the examined subject, or by any exogeneous or endogenous source (bacterial cells or any other microorganism, and may be correlated with a specific physiological state (e.g., pathology). In some non-limiting embodiments, a biomarker can be produced by bacteria (e.g., tumor-residing bacteria) or other microorganism (either exogenous or from the subject's own microbiome) or any other infectious agent.

In yet some further embodiments of the disclosed diagnostic methods, the cell/s are pathological cell/s. “Pathological cell/s” refers to abnormal cell/s caused by, causing or involving, and/or constituting a disease (e.g., a neoplasm) a disease. Accordingly, the method further comprises:
for each pixel in the input image:
Summing all probability values in the respective probability vector that correspond to the object and not the background to thereby obtain a respective summed object-related probability value of the pixel.
Identifying each pixel as an object-related pixel which is part of an object, based on a comparison of the respective object-related probability value to a threshold value.
Connecting nearby object-related pixels to thereby identify groups of object-related pixels, where each group of object-related pixels represents a respective object in the input image;
for each map of a subset of the c probability maps (e.g., the subset includes c-1 maps):
for each group of object-related pixels in the map calculating a respective group-specific probability value, thereby obtaining a plurality of (e.g., c-1) group-specific probability values;
Classifying each group of object-related pixels to a selected class based on the plurality group-specific probability values.

In yet some further embodiments, the diagnostic methods of the present disclosure further comprise assigning each classified object (e.g., a cell) of the one or more classified objects (cells) to a respective subgroup according to the respective class of the classified object (cell). In some embodiments, a distribution of the one or more classified objects to different subgroups provides a pathological cell-profile of the biological sample.

In some embodiments, this additional step may involves generating at least one representation means, for example, any graphical presentation for the different subgroups, e.g., at least one histogram, where each column in the histogram represents a respective class and indicates the number of pathological cells in the at least one input image that were classified to the respective class. The histogram therefore provides a pathological cell-profile of the sample. More specifically, in some embodiments, a “pathological cell/s profile” refers to the representation of assigning each classified pathological cell to a respective subgroup according to the respective class of the classified pathological cell. Non-limiting examples of such representation may be a histogram, a graph, a table, a plot.

Still further, in some embodiments, the biological sample/s used by the diagnostic methods of the present disclosure may be sample/s of a subject, specifically, the diagnosed subject. Still further, the cells comprise pathological cells of the diagnosed subject. Thus, the pathological cell-profile provided by the disclosed methods is a subject-specific pathological cell-profile. As used herein, “subject-specific pathological cell-profile” refers to the pathological cell-profile of a specific examined a specific examined sample (such as biopsy/tissue/blood/etc.) of a specific subject or tumor.

It should be further understood that multiple samples can be obtained from one subject (e.g., at various time points, from various tissues, e.g., blood smear, bone marrow biopsy, and blood cells enriched and analyzed by flow cytometry).

In yet some further embodiments, each class in the group of classes is indicative of a respective spread of at least one biomarker within the cell, thereby reflecting the sub-cellular localization and/or the relative amount and/or relative ratio of the at least one biomarker in a specific cell compartment/s and/or organelles of the pathologic cells of the examined sample. The terms “spread”, as used in the present disclosure, refers to the distribution of the biomarker within the object. More specifically, the term “spread” refers to the distribution of the biomarker between the cytosol and the nucleus of a pathological cell. Thus, each of the classes reflects a specific spread or distribution of the biomarker within the cell (e.g., between cell compartments). Still further, “relative amount” or “relative ratio” refers to the amount of a substance being measured or stated (e.g. a biomarker within the nucleus) relative to other substance or measurement (e.g. a biomarker in the cytosol). In some embodiments, the relative amount or relative ratio refer to the amount of the biomarker in various cell compartments.

As indicated herein, the methods of the present disclosure involve the step of determining and classifying proteasome localization in at least one cell in a sample. Biological sample is any sample obtained from the subject that comprise at least one cell or any organelles thereof. In some specific embodiments, sample applicable in the methods of the present disclosure may include bone marrow, lymph fluid, blood cells, blood, serum, plasma, semen, spinal fluid or CSF, the external secretions of the skin, respiratory, intestinal, and genitourinary tracts, any sample obtained from any organ or tissue, any sample obtained by lavage, optionally of the breast ductal system, or of the uterus, plural effusion, samples of in vitro or ex vivo cell culture and cell culture constituents. In some specific embodiments, the biological sample may result from a biopsy. A biopsy is a medical test commonly performed by a surgeon. The process involves extraction of sample cells or tissues from the patient. The tissue obtained is generally examined under a microscope by a pathologist for initial assessment and may also be analyzed for proteasome localization as discussed by the present disclosure. When an entire lump or suspicious area is removed, the procedure is called an excisional biopsy. An incisional biopsy or core biopsy samples a portion of the abnormal tissue without attempting to remove the entire lesion or tumor. When a sample of tissue or fluid is removed with a needle in such a way that cells are removed without preserving the histological architecture of the tissue cells, the procedure is called a needle aspiration biopsy. Still further, the sample/s may be obtained from the described tissues ectomized from a patient (e.g., in case of therapeutic ectomy).

In some specific embodiments, particularly where MM patients are prognosed and monitored, the sample examined by the methods of the present disclosure may be a bone marrow sample.

In more specific embodiments of the disclosed diagnostic methods, the subcellular localization of the biomarker, may be to any cellular compartment and/or organelle of the cell. Non-limiting examples for relevant organelles include nucleus, lysosomes, mitochondria, endoplasmic reticulum, and the like. Applicable compartments may include the cytoplasm, or any intracellular membrane or lumen or any other defined cellular compartment.

In some specific embodiments, the applicable cellular compartments and/or organelles may be the nucleus and the cytoplasm. Accordingly, each class in the group of classes of the disclosed diagnostic methods is indicative of a respective spread of at least one biomarker within the cell, specifically, reflecting the nuclear or cytoplasmic localization and/or the relative amount and/or relative ratio of the at least one biomarker in the pathologic cells of the examined sample.

More specifically, “Nuclear” refers to the localization to and/or within the nucleus of the cell. The cell “nucleus” is a membrane-bound organelle found in eukaryotic cells. The main structures making up the nucleus are the nuclear envelope, a double membrane that encloses the entire organelle and isolates its contents from the cellular cytoplasm; and the nuclear matrix, a network within the nucleus that adds mechanical support. It should be understood that the nuclear localization as used herein, encompasses localization of the biomarker in any of the specific parts or compartments of the nucleus, as discussed herein.

A “Cytosolic” as used herein in connection with cytosolic localization, refers to the localization to and/or within the cell cytoplasm. The “cytosol”, also known as “cytoplasmic matrix” or “groundplasm”, is a liquid substance inside cells (intracellular fluid (ICF)). It is separated into compartments by membranes. For example, in eukaryotic cell, the cytosol is surrounded by the cell membrane and is part of the cytoplasm, which also comprises the mitochondria, plastids, and other organelles (but not their internal fluids and structures); the cell nucleus however is separate. The cytosol is thus a liquid matrix around the organelles. It should be understood that the cytosolic localization as used herein, encompasses localization of the biomarker in any of the specific parts or compartments of the cytoplasm, as discussed herein. Specifically, cytosolic localization encompasses in some embodiments any localization within the volume enclosed by the cell membrane externally, and the nuclear membrane internally. More specifically, any localization within the volume enclosed by the cell membrane, excluding the nucleus. In yet some further embodiments, cytosolic localization encompasses any localization of the biomarker (e.g., the proteasome) within the intracellular fluid, that may be also referred to herein as any “non-organellar material”. In yet some further embodiments, cytosolic localization encompasses any localization of the biomarker (e.g., the proteasome) within the intracellular fluid without the mitochondria and the nucleus.

It should be understood that any biomarker may be applicable in the diagnostic methods of the present disclosure. Such biomarker may be any proteineous or nucleic acid entity, or any complex thereof, and/or any direct or indirect enzymatic activity. In some embodiments, the biomarker may be at least one protein or protein complex. In some particular embodiments of the diagnostic method of the present disclosure, the biomarker is the proteasome, or any subunit thereof Proteasomes, as used herein, are protein complexes which degrade unneeded or damaged proteins by proteolysis, a chemical reaction that breaks peptide bonds, mediated by proteases. Proteasomes are part of a major mechanism by which cells regulate the concentration of particular proteins and degrade misfolded proteins. Proteins are tagged for degradation with a small protein called ubiquitin. The tagging reaction is catalyzed by enzymes called ubiquitin ligases. The degradation process yields peptides of about seven to eight amino acids long, which can then be further degraded into shorter amino acid sequences and used in synthesizing new proteins. Proteasomes are found inside all eukaryotes and archaea, and in some bacteria. In structure, the proteasome is a cylindrical complex containing a “core” of four stacked rings forming a central pore. Each ring is composed of seven individual proteins. The inner two rings are made of seven p subunits that contain three to seven protease active sites. These sites are located on the interior surface of the rings, so that the target protein must enter the central pore before it is degraded. The outer two rings each contain seven a subunits whose function is to maintain a “gate” through which proteins enter the barrel. These a subunits are controlled by binding to “cap” structures or regulatory particles that recognize polyubiquitin tags attached to protein substrates and initiate the degradation process. The overall system of ubiquitination and proteasomal degradation is known as the ubiquitin-proteasome system (UPS). The proteasome subcomponents are often referred to by their Svedberg sedimentation coefficient (denoted S). The proteasome most exclusively used in mammals is the cytosolic 26S proteasome, which is about 2000 kilodaltons (kDa) containing one 20S protein subunit (also referred to herein as the core proteasome, or CP) and two 19S regulatory cap subunits (also referred to herein as the regulatory proteasome or RP). The core is hollow and provides an enclosed cavity in which proteins are degraded. Openings at the two ends of the core allow the target protein to enter. Each end of the core particle associates with a 19S regulatory subunit that contains multiple ATPase active sites and ubiquitin binding sites. This structure recognizes polyubiquitinated proteins and transfers them to the catalytic core. An alternative form of regulatory subunit called the 11S particle may play a role in degradation of foreign peptides and can associate with the core in essentially the same manner as the 19S particle. The proteasomal degradation pathway is essential for many cellular processes, including the cell cycle, the regulation of gene expression, and responses to oxidative stress.

Still further, in some embodiments, the cell-related class/s used in the diagnostic method of the present disclosure, comprise at least two pathological cell-related classes. In more specific embodiments, at least one class of the at least two pathological-cell-related classes reflects a ratio of nuclear to cytosolic proteasomal localization that is greater than 1, and at least one class reflects a ratio of nuclear to cytosolic proteasomal localization that is smaller than or is equal to 1. Various additional classes may further reflect the intensity of the nuclear to cytosolic proteasomal localization. For example, a ratio that is 1 (e.g., equal distribution of the proteasome between the nucleus and the cytosol), or smaller than 1 (e.g., 0.99, 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, 0.01, or smaller), reflects cytosolic localization. In some embodiments, various classes that display cytosolic localization may be characterized by a nuclear to cytosolic ratio of between about 1 to about 10⁻¹⁰ or less. In yet some further embodiments, various classes that display nuclear localization may be characterized by a nuclear to cytosolic ratio of between about 1.0000001 to about 10¹⁰ or more.

In some embodiments of the diagnostic method of the present disclosure, an applicable sample may be any tissue sample or any cell sample, for example, a cell culture sample, or a primary cell sample, e.g., obtained from a biological fluid. More specifically, a biological sample is any sample obtained from the subject that comprise at least one cell or any fraction thereof. In some specific embodiments, sample applicable in the methods of the invention may include bone marrow, lymph fluid, blood cells, blood, serum, plasma, semen, spinal fluid or CSF, the external secretions of the skin, respiratory, intestinal, and genitourinary tracts, any sample obtained from any organ or tissue, any sample obtained by lavage, optionally of the breast ductal system, or of the uterus, plural effusion, samples of in vitro or ex vivo cell culture and cell culture constituents. In some specific embodiments, the biological sample may result from a biopsy. A biopsy is a medical test commonly performed by a surgeon. The process involves extraction of sample cells or tissues from the patient. The tissue obtained is generally examined under a microscope by a pathologist for initial assessment and may also be analyzed for proteasome localization as discussed by the present disclosure. When an entire lump or suspicious area is removed, the procedure is called an excisional biopsy. An incisional biopsy or core biopsy samples a portion of the abnormal tissue without attempting to remove the entire lesion or tumor. When a sample of tissue or fluid is removed with a needle in such a way that cells are removed without preserving the histological architecture of the tissue cells, the procedure is called a needle aspiration biopsy. Still further, the sample/s may be obtained from the described tissues ectomized from a patient (e.g., in case of therapeutic ectomy). Specifically, a “tissue” sample, as used herein is any sample derived from a group of cells that have similar structure and that function together as a unit. A tissue as used herein, may further contain in addition to cells, also the intercellular matrix (containing fibers that are unique to a specific tissue). It should be understood that any type of tissue may be applicable in the present disclosure, for example, bone marrow, epithelial, connective, muscle, and nervous tissues.

In some specific embodiments, particularly where MM patients are prognosed and monitored, the sample examined by the methods of the invention may be a bone marrow sample.

In yet some further embodiments, detection of the subcellular localization of the biomarker, e.g., the proteasome or any subunits thereof in the cell sample, may be performed by any appropriate means. Non-limiting examples may include subjecting the sample to any immunological and/or any other affinity assay and/or any enzymatic and/or activity assays, to detect the biomarker (e.g., the proteasome). Accordingly, the input image processed by the disclosed methods, is an image of the at least one immunological and/or affinity and/or enzymatic, and/or activity assay. An “immunological assay” or “immunoassay” or “IA” is a biochemical test that measures the presence or concentration of a macromolecule or a small molecule in a solution usually through the use of an antibody or sometimes by the use of an antigen. The molecule detected by the immunoassay is often referred to as an “analyte” and is in many cases a protein, although it may be other kinds of molecules, of different sizes and types, as long as the proper antibodies that have the required properties for the assay are developed. Analytes in biological liquids such as serum or urine are frequently measured using immunoassays for medical and research purposes. An “affinity assay” or “ligand binding assay (LBA)” is an assay, or an analytic procedure, which relies on the binding of ligand molecules to receptors, antibodies or other macromolecules. A detection method is used to determine the presence and extent of the ligand-receptor complexes formed, and this is usually determined electrochemically or through a fluorescence detection method. This type of analytic test can be used to test for the presence of target molecules in a sample that are known to bind to the receptor. Still further, affinity assay, as used herein may be based on using any molecule that display affinity to the specific biomarker used. Such molecule may be in some embodiments, a substrate, a ligand, a receptor, an immunological entity (e.g., an antibody or any fragments thereof), an aptamer, or any molecule, either a biological entity or any chemical compound that reflects directly or indirectly the presence of the biomarker in the specific cell compartment or organelle. The presence of the biomarker is indicated in the image either directly or indirectly by at least one detectable label that may be any color label, fluorescent label, quencher, electrical label, radioactive label, metal label and the like.

To name but few, detection assays applicable in the disclosed methods may include immunofluorescence, FACS/Flow cytometry, activity-based probes, and any other appropriate methods, for both tissue and cells. “Enzymatic assays” that are also encompassed by the present disclosure, are methods for measuring enzymatic activity, which is a measure of the quantity of active enzyme present in a sample. Enzyme assays measure either the consumption of substrate or production of product over time. A large number of different methods of measuring the concentrations of substrates and products exist and are all encompassed by the present disclosure.

As indicated above, affinity-based methods may be employed by the prognostic methods of the present disclosure. In some embodiments, such methods may employ and compound displaying affinity and specificity to the determined biomarker, e.g., the proteasome and any subunits thereof. Thus, in some embodiments, Proteasome activity-based probes (ABPs) may also be employed for detecting proteasome localization and activity. ABPs are small molecules consisting of a proteasome inhibitor linked to a small fluorophore. Fluorescence labeling of proteasomes occurs via a nucleophilic attack of the catalytic N-terminal threonine toward the ABP, leading to a covalent, irreversible bond between the warhead of the ABP and the proteasome active site. Importantly, unlike fluorescently tagged proteasome subunits, the ABPs only label fully assembled, active proteasome complexes. ABPs react with proteasomes in a way that corresponds to their catalytic activity and because of their fluorescent properties, they can be imaged specifically and sensitively in cell lysates after gel-electrophoresis followed by fluorescent scanning or in living cells by fluorescence microscopy.

It should be understood that when referring to detection of the proteasome, the present disclosure encompasses the detection of the 26S, or of any subunit thereof, specifically, at least one of the 20S and 19S subunits, as specified above.

In some particular embodiments, an immunological assay is used to detect and localize the biomarker (e.g., proteasome) in the examined pathological cells of the diagnosed sample. In yet some specific embodiments, such immunological affinity assay may be any staining, for example an immunohistochemical staining. Accordingly, the input image processed by the disclosed methods is an image of immunohistochemical staining of the tissue and/or cell sample. “Immunohistochemical staining” or “Immunohistochemistry” or “IHC” involves the process of selectively identifying antigens (e.g., biomarker, specifically the proteasome) in cells of a tissue section by exploiting the principle of antibodies binding specifically to antigens in biological tissues. Visualizing an antibody-antigen interaction can be accomplished in a number of ways, for example, Chromogenic immunohistochemistry (CIH), wherein an antibody is conjugated to an enzyme, such as peroxidase (the combination being termed immunoperoxidase), that can catalyze a color-producing reaction. Another non-limiting embodiment relates to Immunofluorescence, where the antibody is tagged to a fluorophore, such as fluorescein or rhodamine.

In some specific embodiments, the at least one input image is generated in the disclosed diagnostic methods, by scanning whole slide images (WSI).

“Whole slide imaging (WSI)”, also known as virtual microscopy, refers to scanning a complete microscope slide and creating a single high-resolution digital file. This is commonly achieved by capturing many small high-resolution image tiles or strips and then montaging them to create a full image of a histological section.

WSI includes four sequential processes: image acquisition, storage, processing, and visualization. The hardware components of the device required for image acquisition comprise of two systems: image capture and image display. Image capture is performed by a digital scanner, which is basically a trinocular microscope with robotic control of illumination intensity, mechanical stage, objectives, and coarse and fine focusing facilities and is equipped with a high-resolution camera. Unlike the still microscopic images, WSI scanners capture sequential images either in a tiled or line-scanning manner which are subsequently assembled or stitched into a virtual slide (VS), an exact replica of the glass slide.

In some embodiments, the pathological cell/s analyzed by the disclosed diagnostic methods may be any neoplastic cell or a cell of a subject suffering from a protein misfolding disorder or a deposition disorder. “Neoplastic cells” are cells of a neoplasm that reflects abnormal and excessive growth of tissue, termed as “neoplasia” (growth uncoordinated with that of the normal surrounding tissue). A “Protein misfolding disorder” or “protein conformational disorder” or “proteinopathy” is a class of diseases in which certain proteins become structurally abnormal, and thereby disrupt the function of cells, tissues and organs of the body. Often the proteins fail to fold into their normal configuration. In this misfolded state, the proteins can become toxic or they can lose their normal function. A “Deposition disorders” comprise a diverse group of conditions or diseases in which there is accumulation, deposition, or production of substances. Typically, these substances are products of abnormal metabolism or degenerative phenomena occurring locally or systemically. The major cutaneous deposits may be subdivided into the hyalinoses, mucinoses, and mineral salts. Amyloidosis is an example of a deposition disorder, that ill be described in more detail herein after.

In yet some further embodiments, the neoplastic cell analyzed by the disclosed diagnostic methods may be a cancer cell. In more specific embodiments, the cell may be a cancer cell of a subject suffering from a hematological malignancy. “Hematological malignancy” or “blood cancer” or “hematological cancer”, involve any abnormal growth of hematopoietic cells, e.g., leukemia, lymphoma, and Multiple Myeloma, which affects the plasma cells in bone marrow, or in any other tissue or organ. It should be appreciated that this term encompasses any other hematological malignancy or pathological state defined, classified and/or recognized by the world health organization (WHO), by International Statistical Classification of Diseases and Related Health Problems (ICD), e.g., ICD-9. In yet some further specific any non-limiting optional embodiments, the cell may be a Multiple Myeloma (MM) cell.

In yet some alternative embodiments, the pathological cell analyzed by the disclosed diagnostic methods may be cell of a subject suffering from a protein misfolding disorder or disorder is a cell of a subject suffering from amyloidosis or any related conditions.

In some embodiments, the diagnostic method of the present disclosure further comprising:
applying an encoding expansion process on the weakly and partially labeled dataset before training, comprising:
   for each labeled object in the training dataset:
   automatically defining a first masked region surrounding at least one manually labeled pixel in the labeled object. It should be noted that all pixels in the first region are classified to the same class as the at least one manually labeled pixel, and a second masked region surrounding the first mased region. The area between the first masked region and the second masked region corresponds to background.

Still further, in some embodiments of the diagnostic method of the present disclosure, a loss function applied the partially and weakly labelled training dataset of images during training of the ML model includes a partial entropy loss component and a smoothness component. The smoothness component is configured to increase loss function penalty on neighboring pixels with similar values, which are assigned by the machine learning model with different probabilities as compared to neighboring pixels with different values which are assigned with different probabilities and reside across transitional areas in an image.

A further aspect of the present disclosure relates to a computer system comprising at least one processing circuitry configured to execute a diagnostic method for determining and classifying the sub-cellular localization of at least one biomarker in at least one biological sample, as defined by the present disclosure.

Another aspect of the present disclosure relates to a prognostic method for determining the prognosis of a subject suffering from a pathologic disorder and/or for predicting and assessing responsiveness of a subject suffering from a pathologic disorder to a treatment regimen (e.g., comprising at least one therapeutic agent). In yet some further optional embodiments, the method further provides means for monitoring disease progression. More specifically, the disclosed methods comprise the following steps. Step (a) of the disclosed methods involve detecting and classifying the sub-cellular localization of at least one biomarker, specifically, the proteasome or any subunit/s thereof, in at least one pathological cell (that is the object of interest), of at least one biological sample of the subject to generate a pathological cell-profile that reflects the relative amount and/or the ratio of pathological cell/s of the samples in each of the at least two pathological cell-related classes.

Step (b) of the disclosed methods involves determining for the prognosed subject a negative or positive prognosis based on the pathological cell-profile generated in step (a). In case of determination of responsiveness, based on the pathological cell-profile generated in step (a), the responsiveness to the treatment regime is determined. More specifically, in some embodiments, the subject may be classified as any one of a responder or a non-responder (drug-resistant disease). In yet some further embodiments the subject may be further sub classified with respect to the expected degree, depth or extent and/or duration of responsiveness, for example as a poor responder, a responder displaying mild response, a responder displaying a good response or even a responder displaying excellent response, and the like.

It should be understood that detecting and classifying the sub-cellular localization of at least one biomarker such as the proteasome or any subunits thereof according to step (a) above, is performed by a method comprising the step of applying a single machine learning (ML) model on at least one input image of the sample (e.g., staining for proteasome cellular localization). It should be understood that the machine learning model is a model, which has been trained using a partially and weakly labelled training dataset of images.

For each input image, the machine learning model is configured to provide as output, c probability maps, where C is defined according to the number of classes in a group of classes, which includes at least two cell-related classes and a background class. It should be noted that each map of the C probability maps corresponds to a respective class, each cell-related class in the group of classes reflects a respective distribution of the proteasome within the cell. The C probability maps provide collectively, for each pixel in the input image, a respective probability vector comprising C probability values, each value indicating the probability that the pixel belongs to a respective class in the group of classes. In some embodiments, the at least two cell-related classes, may be classes related to the cells of interest, for example, to pathological cells. In yet some further additional or alternative embodiments, a background class, may refer to pixels belonging to extracellular material, or alternatively, biological tissue that do not comprise cells, or to cells that are not pathological cells, such as non-malignant immune cells.

The method detecting and classifying the sub-cellular localization of the proteasome further involves applying post-processing on the output, comprising:
detecting one or more pathological cell in the at least one input image, based on the probability vectors, and classifying each detected pathological cell to a respective class in the group of classes, based on the probability values in the probability maps of pixels located in the detected object of interest thereby identifying one or more classified pathological cells in the at least one input image.

It should be understood that the various classes reflect a different subcellular distribution of the biomarker, specifically, of the proteasome in the cell. More specifically, the distribution of the proteasome in the nucleus and/or the cytoplasm, in each of the examined cells in the sample. Each of the classes represents a particular and different ratio of nuclear to cytosolic localization of the proteasome.

As indicated above, the disclosed methods provide a powerful means for determining the prognosis of a subject suffering from a pathologic disorder and/or for predicting and assessing responsiveness of a subject suffering from a pathologic disorder to a treatment regimen comprising at least one therapeutic agent, and also for monitoring the patient. “Predicting”, as used herein, refers to the process of foretell based on monitoring and/or analyzing. “Assessing”, as used herein, refers to the process of judging or deciding the amount, value, quality, or importance of a measurement and/or analysis. “Monitoring” refers to the process of observing, measuring, and recording the performance or behavior of a system, process, or activity over time. It involves collecting and analyzing data to identify patterns, trends, and anomalies, and to detect any deviations from expected outcomes. A “treatment regimen”, as used herein, also encompasses the sequence of decisions to determine the course of treatment type, drug dosage, and the election of a specific drug or drug combination (either a chemical or biological therapeutic compound). In some embodiments, detecting and classifying the sub-cellular localization of the proteasome in accordance with the prognostic methods disclosed herein, is performed as defined for the diagnostic methods disclosed herein before, in connection with other aspects of the present disclosure.

In yet some further embodiments, at least one class of the at least two pathological-cell-related classes reflects a ratio of nuclear to cytosolic proteasomal localization that is greater than 1 (e.g., that more than 50% of the proteasomes in the cell are localized in the nucleus), and at least one class reflects a ratio of nuclear to cytosolic proteasomal localization that is smaller than or equals to 1 (e.g., that 50% or more of the proteasomes in the examined cell are located in the cytoplasm).

In yet some further embodiments of the disclosed prognostic methods, at least one of:
(I) a pathological cell-profile predominantly composed of classes that reflect a ratio of nuclear to cytosolic proteasomal localization that is greater than 1, is a profile where: (i) in some embodiments, more than 50% of the cells (e.g., the examined cells) in the sample are classified in at least one class reflecting a ratio of nuclear to cytosolic proteasomal localization that is greater than 1; and/or in some embodiments (ii), where less than 1% of the examined cells are classified in at least one class reflecting a ratio of nuclear to cytosolic proteasomal localization that is smaller than or equals to 0.5.
(II) a pathological cell-profile predominantly composed of classes that reflect a ratio of nuclear to cytosolic proteasomal localization that is smaller than or equals to 1, is a profile where: (i) in some embodiments, 50% or more of the cells (e.g., the examined cells) in the sample are classified in at least one class reflecting a ratio of nuclear to cytosolic proteasomal localization that is smaller than or equals to 1; and/or in some embodiments (ii), where 1% or more of the examined cells, are classified in at least one class reflecting a ratio of nuclear to cytosolic proteasomal localization that is smaller than or equals to 0.5.

It should be understood that as indicated herein, “1% or less”, of the examined cells, is meant any cell number (1, 10, 100, 1000, 10,000, or more) reflecting a portion of about 1% or less, specifically, 1, 0.9, 0.8, 0.7, 0.6, 0.5, 0.4, 0.3, 0.2, 0.1% or less), of the examined cells in the sample.

In yet some further embodiments, as indicated herein, “1% or more” of the examined cells, is meant any cell number (1, 10, 100, 1000, 10,000, or more), reflecting a portion of about 1% or more, specifically, 1%, 2%, 3%, 4%, 5%, 6%, 7%, 8%, 9%, 10%, 15%, 20%, 25%, 30%, 35%, 40%, 45%, 46%, 47%, 48%, 49%, 50% or more of the examined cells in the sample. Still further, in some embodiments, a ratio of nuclear to cytosolic proteasomal localization that is smaller than or equals to 0.5, may range in some embodiments between about 0.5 to about 10¹⁰ or less. It should be understood that a pathological cell-profile predominantly composed of classes that reflect a ratio of nuclear to cytosolic proteasomal localization that is greater than 1, as determined herein above and in (I), and/or a pathological cell-profile predominantly composed of classes that reflect a ratio of nuclear to cytosolic proteasomal localization that is smaller than or equals to 1, as determined herein above and in (II), is applicable for determining prognosis, responsiveness, relapse and any other condition or state of the prognosed subject as defined in any of the aspects of the present disclosure.

Still further, in some embodiments of the disclosed prognostic methods, the step of determining the responsiveness of the subject to the treatment regime according to step (b) of the disclosed prognostic methods, comprises classifying the subject. More specifically, in some embodiments, the subject may be classified as (i), a responder subject to the treatment regimen, if the generated pathological cell-profile is predominantly composed of classes that reflect a ratio of nuclear to cytosolic proteasomal localization that is greater than 1; or classified as (ii), a non-responder or poor-responder subject, if the generated pathological cell-profile is predominantly composed of classes that reflect a ratio of nuclear to cytosolic proteasomal localization that is smaller than or equals to 1; thereby predicting, assessing and monitoring responsiveness of a mammalian subject to the treatment regimen.

It should be understood that the prognosis, and classification of responsiveness and/or prediction of relapse, depends not only on the dominating class (by means of its % of the total cells), but also at the “grade” of this class (any ratio of either above 1 e.g., 1 vs 10 (even though they both equal to, or above 1), or alternatively, below 1, e.g., 0.9, vs. 0.3 ratio, even though they are both below 1).

According to some embodiments, in responsive subjects, which are also indicated herein as responders, the term predominantly as used herein means that most of the cells, e.g., more than 50% (e.g., 51%, 52%, 53%, 54%, 55%, 60%, 65%, 70%, 75%, 80%, 85%, 90%, 95%, 100%), in the at least one sample are classified as belonging to at least one class reflecting a ratio of nuclear to cytosolic proteasomal localization that is greater than 1. More specifically, a subject displaying a profile where most of the classes in the profile are classes reflecting a ratio that is between 1.0000001 to about 101 or more, may be considered in accordance with some embodiments as a responder subject. In yet some further embodiments, a subject classified as a responder may have a profile with less classes, or even with no classes, which reflect a ratio that is significantly smaller than or equal to 1. According to such embodiments, if less than 1% of the cells in the sample are classified in the low-ratio classes, such subject may be considered as a responder. It should be further understood that the term responder as used herein, encompasses any depth of response, including a complete response, good response, partial response, mild or moderate response, low response, as well as non-resistance to the treatment. Thus, according to some embodiments, the degree or depth of the responsiveness may be negatively correlated with profiles comprising one or more classes reflecting a ratio of nuclear to cytosolic proteasomal localization that is smaller than or equals 0.5. More specifically, in some embodiments, the degree or depth of the responsiveness may be affected by the existence of cells, even when forming a minor fraction of the cells in the sample (e.g., about 1% or more), that display a ratio of nuclear to cytosolic proteasomal localization that is smaller than or equals 0.5. Simply put, even if the majority of the cells are classified in classes displaying a ratio of nuclear to cytosolic proteasomal localization that is greater than 1, the existence of even a minor fraction of cells (e.g., 1% or more) displaying a ratio of nuclear to cytosolic proteasomal localization that smaller than or equals 0.5, may significantly affect (e.g., reduce) the degree and/or depth of responsiveness. It should be appreciated that as used in the entire disclosure, responsiveness encompasses the responsiveness during the course of disease and/or remission. It should be thus further emphasized that the methods and computer implemented programs of the present disclosure provide a powerful means for monitoring, prognosing and predicting the likelihood of relapse, time to relapse and/or response to treatment at the time of relapse.

In yet some further embodiments, in subjects that display a low or poor response, and even no response, that are also referred to herein as non-responders, low or poor-responders, or drug-resistant subjects, the term predominantly as used herein means that most of the cells, e.g., at least 50%, in the at least one sample are classified as belonging to at least one class reflecting a ratio of nuclear to cytosolic proteasomal localization that is either equal to 1 or smaller than 1. In yet some alternative or additional embodiments, the degree of the non-responsiveness may be positively correlated with profiles comprising one or more classes reflecting a ratio of nuclear to cytosolic proteasomal localization that is smaller than or equals 0.5. In yet some further embodiments, profiles where 1% or more of the cells (e.g., the examined cells in the sample) belong to one or more classes reflecting a ratio of nuclear to cytosolic proteasomal localization that is smaller than or equals 0.5, are positively correlated with non-responsiveness, low responsiveness and/or poor responsiveness to a treatment regimen. In yet some further embodiments, a non-responder subject may display a profile where most of the classes in the profile are classes reflecting a ratio that is between 1 to about 10⁻¹⁰ or less. Alternatively, a non-responder or poor-responder subject may be a subject displaying a profile with more classes, or at least with one class that reflect a ratio that is significantly smaller than 1 (e.g., 0.5 or less, specifically, 0.45, 0.4, 0.3.5, 0.3, 0.25, 0.2, 0.15, 0.1, 0.01, or less, e.g., any ratio between 10⁻² to 10⁻¹⁰ or less).

It should be appreciated that subject specific pathological cell profile generated by the diagnostic and prognostic methods of the present disclosure, allows considering the heterogeneity of the cells within a single sample of the diagnosed subject, thereby providing an accurate and sensitive predictive tool that is not only limited to the determination of responders and non-responders, but also reflects the depth of the response. As such, the disclosed methods provide a powerful means for an accurate prediction allowing a more informative determination of the patient's prognosis, specifically with respect to the course of the disease. For example, responsiveness, relapse, length of disease-free period, survival, extent and/or severity and/or intensity of disease symptoms, side effects, disease related conditions and the like.

Still further, as indicated above, the disclosed methods are based on the use of at least two pathological cell classes. However, it should be understood that classification of the sample to more than two pathological cell-related classes, for example, three classes or more, four classes, five classes, six classes, seven classes, eight classes, nine classes, ten classes, eleven classes, twelve classes, thirteen classes, fourteen classes, fifteen classes or even more (e.g., 20, 25, 30, 35, 40, 45, 50 or even more), increases the accuracy and sensitivity of the diagnostic and prognostic tool provided herein. For example, in case of two patients displaying a similar pathological cell profile that on average, is predominantly composed of classes reflecting a ratio of nuclear to cytosolic proteasomal localization that is greater than 1, the existence of at least one class that reflects an extremely low ratio of nuclear to cytosolic proteasomal localization in one patient, indicates a worse prognosis of this patient. Thus, in some specific and non-limiting embodiments, the use of more than two classes in the disclosed methods, provides not only the general determination (based on the average percentage of the cells) that may be either positive (greater than 1, mostly nuclear), or negative (smaller than 1, mostly cytosolic), but also “how negative or positive” they are, thereby reflecting the complex state of the patient.

It should be appreciated that in some embodiments, determining and classifying the sub-cellular localization of the proteasome in at least one biological sample by the disclosed prognostic methods, is performed by a method as defined by the present disclosure in connection with previous aspects.

In yet some further embodiments of the disclosed prognostic methods, determining the prognosis of the subject according to step (b), comprises: (i) determining a positive prognosis of the subject if the subject displays a pathological cell-profile predominantly composed of classes that reflect a ratio of nuclear to cytosolic proteasomal localization that is greater than 1. Specifically, where either more than 50% of the cells in the sample are classified in classes reflecting a ratio of nuclear to cytosolic proteasomal localization that is greater than 1, and/or where less than 1% of the examined cells are classified in at least one class reflecting a ratio of nuclear to cytosolic proteasomal localization that is smaller than or equals to 0.5. As indicated above, such profile is indicative of a positive prognosis of the subject. Alternatively, or additionally, (ii) determining a negative or poor prognosis if the subject displays a pathological cell-profile predominantly composed of classes that reflect a ratio of nuclear to cytosolic proteasomal localization that is smaller than or equals to 1. Specifically, where 50% or more of the cells in the sample are classified in classes reflecting a ratio of nuclear to cytosolic proteasomal localization that is smaller than, or equal to 1 and/or where 1% or more of the examined cells, are classified in at least one class reflecting a ratio of nuclear to cytosolic proteasomal localization that is smaller than or equals to 0.5. As indicated above, such resulting profile is indicative of a negative prognosis of the subject.

It should be understood that even in cases where the majority of the examined cells in the samples display a ratio of nuclear to cytosolic proteasomal localization that is greater than 1, that may reflect a favorable prognosis, the existence of classes in the profile where 1% or more of the cells (e.g., the examined cells in the sample) belong to one or more classes reflecting a ratio of nuclear to cytosolic proteasomal localization that is smaller than or equals 0.5, may be indicative of negative prognosis.

In yet some further embodiments of the disclosed prognostic methods, a profile comprising at least one class with the smallest ratio of nuclear to cytosolic proteasomal localization that is below 1, is positively correlated with a negative prognosis of the subject. “positively correlated” or a “positive correlation” exists when one variable tends to decrease as the other variable decreases, or one variable tends to increase when the other increases.

In some particular and non-limiting embodiments, a profile where about 1% or more of the cells in the sample are classified as the most negative [or the smallest ratio of nuclear to cytosolic proteasome localization (classes with ratios=<1)], is positively correlated with a negative prognosis for the subject. In some embodiments, for the subject, even if >50% of the cells were classified as having a ratio of nuclear to cytosolic proteasomal localization that is greater than 1.

It should be understood that as used herein, the term “positive prognosis”, may be also referred to as “excellent, good, fair prognosis”, and indicates a positive forecast of the course of a disease that may be reflected by reduced chances for relapse, increased disease-free survival (DFS), reduced disease symptoms, increased responsiveness to treatment, and even cure. A “negative prognosis” as used herein, also referred to herein as “poor prognosis” or “bad prognosis”, refers to patients who have low likelihood of response to treatment, increased chances for relapse, reduced disease-free survival, reduced or no chance of cure, increased disease symptoms, reduced survival and even death. It should be understood that any amount or number of cells demonstrating a very low ratio of nuclear to cytosolic proteasomal localization (even few cells), may be suggestive of a future relapse, and may be taken into consideration while choosing the type and rate of follow-ups, and perhaps also maintenance treatment that will be used after induction of remission.

As indicated herein, the disclosed prognostic methods provide a powerful tool for early detection and/or prediction of relapse. For example, in cases where even where a subject displaying a profile predominantly composed of cells reflecting a ratio of nuclear to cytoplasmic proteasome localization that is greater than one, the existence of at least one class displaying the smallest ratio of nuclear to cytosolic proteasome localization (classes with ratios=<1, or even less than 0.5), is indicative of increased chances for relapse, and in some embodiments, also of reduced disease-free survival, reduced or no chance of cure, increased disease symptoms, non-responsiveness at the time of relapse, reduced survival and even death.

The disclosed methods may in addition, or alternatively, provide a tool for monitoring the subject (e.g. during the course of disease, the course of treatment, and even during the remission of the disease. Remission is either the reduction or disappearance of the signs and symptoms of a disease. The term may also be used to refer to the period during which this reduction occurs. Specifically, the term relates to the reduction or disappearance of the signs and symptoms of a disease being treated with proteasome inhibitor/s or to the period during which this reduction occurs. It should be understood that remission as used herein is as defined by the world health organization (WHO), e.g., ICD.

Thus, in some embodiments, the disclosed prognostic approach may be further extended for monitoring a subject during the disease, and alternatively, or additionally, during the period of treatment or remission. Thus, in some further embodiments of the prognostic methods of the present disclosure, monitoring disease progression comprises at least one of predicting and determining disease relapse and assessing a remission interval. In some embodiments, the method further comprises the steps of in step (c), repeating the step (a) of the disclosed prognostic methods, specifically, determining and classifying the sub-cellular localization of the proteasome in at least one biological sample of the subject, to determine and classify proteasome subcellular localization, generating a pathological cell-profile for at least one more temporally-separated sample of the prognosed and monitored subject. In step (d), predicting and/or determining disease relapse in the subject, if the generated pathological cell-profile of said at least one temporally separated sample, comprises increased number or fraction and/or extremity of pathological cell-classes that reflect reduced ratio of nuclear to cytosolic proteasome localization.

In some embodiments, at least one more temporally separated sample is obtained after the initiation of at least one treatment regimen. In some specific embodiments, such treatment regimen may comprise at least one therapeutic agent.

As indicated above, in accordance with some embodiments of the present disclosure, in order to assess the patient condition, or monitor the disease progression, as well as responsiveness to a certain treatment (e.g., comprising at least one proteasome modulator), at least two “temporally-separated” test samples must be collected from the examined patient and compared thereafter, in order to determine if there is any change or difference in the proteasome localization profile between the samples. Such change may reflect a change in the responsiveness and/or prognosis of the subject. In practice, to detect a change having more accurate predictive value, at least two “temporally-separated” test samples and optionally more, must be collected from the patient.

The proteasome cellular localization profile is determined using the method disclosed herein, applied for each sample. As detailed above, in some embodiments, the change in the profile is evaluated and compared between at least two samples obtained from the same patient in different time-points or time intervals. This period of time, also referred to as “time interval”, or the difference between time points (wherein each time point is the time when a specific sample was collected) may be any period deemed appropriate by medical staff and modified as needed according to the specific requirements of the patient and the clinical state he or she may be in. For example, this interval may be at least one day, at least three days, at least one week, at least two weeks, at least three weeks, at least one month, at least two months, at least three months, at least four months, at least five months, at least six months, at least one year, or even more.

The number of samples collected and used for evaluation and classification of the subject either as a responder or alternatively, as a drug resistant or as a subject that may experience relapse of the disease, may change according to the frequency with which they are collected. For example, the samples may be collected at least every day, every two days, every four days, every week, every two weeks, every three weeks, every month, every two months, every three months every four months, every 5 months, every 6 months, every 7 months, every 8 months, every 9 months, every 10 months, every 11 months, every year or even more. Furthermore, to assess the disease progression according to the present disclosure, it is understood that the change in nuclear or cytosolic proteasome localization value, may be calculated as an average change over at least three samples taken in different time points, or the change may be calculated for every two samples collected at adjacent time points. It should be appreciated that the sample may be obtained from the monitored patient in the indicated time intervals for a period of several months or several years. More specifically, for a period of 1 year, for a period of 2 years, for a period of 3 years, for a period of 4 years, for a period of 5 years, for a period of 6 years, for a period of 7 years, for a period of 8 years, for a period of 9 years, for a period of 10 years, for a period of 11 years, for a period of 12 years, for a period of 13 years, for a period of 14 years, for a period of 15 years or more.

In some embodiments, the therapeutic agent is a compound that modulates proteasome dynamics, specifically, proteasome localization, assembly and/or function.

Proteasome dynamics as used herein is meant the transport and shuttling of the proteasome between the cytoplasm and nucleus. In some embodiments, such translocation involves dissociation into proteolytic core and regulatory complexes, and re-assembly to form the assembled proteasome.

The present disclosure provides in some aspects thereof, methods for determining and assessing the responsiveness of a subject to a given therapeutic agent, for example, agents that modulate proteasome dynamics. In some embodiments, such agents may be proteasome inhibitors that are widely used in MM therapy. Proteasome inhibitors as used herein, are drugs that block the action of proteasomes, by affecting the activity, localization/distribution and/or stability of the proteasome, which may be employed in the treatment of cancer. Still further, a proteasome inhibitor reduces, inhibits, decreases the activity and function of the proteasome, specifically degradation of cellular and/or nuclear proteins, specifically in about 1% to about 5%, about 5% to 10%, about 10% to 15%, about 15% to 20%, about 20% to 25%, about 25% to 30%, about 30% to 35%, about 35% to 40%, about 40% to 45%, about 45% to 50%, 55%-60%, 60%-65%, 65%-70%, 70%-75%, 75%-80%, 80%-85%, 85%-90%, 90%-95%, 95%-100%. as compared to the non-inhibited activity. To date, three of them are approved for use in treating multiple myeloma, i.e., Bortezomib, Carfilzomib and Ixazomib.

Additional examples of proteasome inhibitors include but are not limited to: Marizomib (salinosporamide A), Oprozomib (ONX-0912), delanzomib (CEP-18770), Disulfiram, Epigallocatechin-3-gallate, Lactacystin, Epoxomicin, MG132, Selinexor and Beta-hydroxy beta-methylbutyrate.

In yet some further embodiments, the prognostic methods of the present disclosure provide a therapeutic tool for determining responsiveness to a treatment comprising at least one PROTAC and related molecules. More specifically, a proteolysis targeting chimera (PROTAC) is a heterobifunctional small molecule composed of two active domains and a linker capable of inducing targeted protein degradation by the ubiquitin-proteasome system. Mechanistically, this can be achieved via chemical ligands that induce molecular proximity between an E3 ubiquitin ligase and a protein of interest, leading to ubiquitination and degradation of the protein of interest. More specifically, PROTACs consist of two covalently linked protein-binding molecules: one capable of engaging an E3 ubiquitin ligase, and another that binds to a target protein meant for degradation. Recruitment of the E3 ligase to the target protein results in ubiquitination and subsequent degradation of the target protein by the proteasome. PROTACs, for example, PROTACs developed by ARVINAS LTD., applicable in the present disclosure include ARV-110 that is a potent, selective, orally available androgen receptor (AR) degrader, ARV-766 and AR-7, (that are AR Backups), ARV-471 (an oral estrogen receptor (ER)-targeting PROTAC® protein degrader for the potential treatment of patients with locally advanced or metastatic ER positive/HER2 negative breast cancer) and the like.

In yet some further embodiments, the prognostic methods of the present disclosure provide a therapeutic tool for determining responsiveness to a treatment comprising at least one IMiD. Imunomodulatory drugs (IMiDs) are a group of compounds that are analogues of thalidomide with anti-angiogenic properties and potent anti-inflammatory effects owing to its anti-tumor necrosis factor (TNF) a activity. More specifically, Thalidomide, which is a synthetic derivative of glutamic acid, and its analogs, lenalidomide and pomalidomide are IMiDs effective in the treatment of multiple myeloma and other hematological malignancies. Recent studies showed that IMiDs bind to CRBN, a substrate receptor of CRL4 E3 ligase, to induce the ubiquitination and degradation of IKZF1 and IKZF3 in multiple myeloma cells, contributing to their anti-myeloma activity. Similarly, lenalidomide exerts therapeutic efficacy via inducing ubiquitination and degradation of CK1α in MDS with deletion of chromosome 5q. Recently, novel thalidomide analogs have been designed for better clinical efficacy, including CC-122 (avadomide), CC-220 (iberdomide) and CC-885. It should be therefore appreciated, that any of the ImiDs discussed herein may be applicable for the methods and systems of the present disclosure.

Still further, in some embodiments, the prognostic methods of the present disclosure provide a therapeutic tool for determining responsiveness to a treatment regimen comprising at least one Calcineurin pathway modulator. More specifically, the Calcineurin pathway is a key component of the immune system and is relying on proteasomal activity for some of its key cellular and physiological effects. Calcineurin inhibitors such as Cyclosporine and Tacrolimus are widely used as immunosuppressive agents following organ transplantation, and for the treatment of several autoimmune diseases. Thus, in some embodiments, the prognostic methods of the present disclosure provide a therapeutic tool for determining responsiveness to a treatment regimen comprising any Calcineurin pathway inhibitor.

In some embodiments, the subject is suffering from at least one of: at least one neoplastic disorder, and/or at least one protein misfolding disorder or deposition disorder.

Still further, the neoplastic disorder is at least one hematological malignancy. In yet some further embodiments, the protein misfolding disorder or deposition disorder is amyloidosis and any related conditions.

In yet some further embodiments of the disclosed methods, hematological cancer is a multiple myeloma (MM) and/or any related condition.

In some specific embodiments, the disclosed prognostic method is for determining the prognosis of a subject and/or predicting and assessing responsiveness of a subject suffering from MM to a treatment regimen comprising at least one therapeutic agent. The disclosed method maybe optionally applicable also for monitoring MM disease progression in the subject. In some particular and non-limiting embodiments, the therapeutic agent may comprise any compound that modulates the proteasome dynamics and/or function (e.g., localization, activity and/or assembly) in a cell of the treated subject.

As demonstrated in this aspect, the present disclosure provides prognostic methods for assessing responsiveness of a subject for a specific treatment regimen, for monitoring a disease progression and for predicting relapse of the disease in a subject. It should be noted that “Prognosis”, is defined as a forecast of the future course of a disease or disorder, based on medical knowledge. This highlights the major advantage of the present disclosure, namely, the ability to assess responsiveness or drug-resistance and thereby predict progression of the disease, based on the proteasome dynamics evaluated in a cell of the prognosed subject. The term “relapse”, as used herein, relates to the re-occurrence of a condition, disease or disorder that affected a person in the past. Specifically, the term relates to the re-occurrence of a disease being treated with proteasome inhibitor/s.

The term “response” or “responsiveness” to a certain treatment, for example, treatment regimen that comprise at least one proteasome dynamics modulating agent, for example, at least one proteasome inhibitor, (e.g., PROTAC, or any other proteasome dynamics or function modulating agents), refers to an improvement in at least one relevant clinical parameter as compared to an untreated subject diagnosed with the same pathology (e.g., the same type, stage, degree and/or classification of the pathology), or as compared to the clinical parameters of the same subject prior to treatment with the indicated medicament.

The term “non responder” or “drug resistance” to treatment with a specific medicament, specifically, treatment regimen that comprise at least one therapeutic agent as discussed herein, refers to a patient not experiencing an improvement in at least one of the clinical parameter and is diagnosed with the same condition as an untreated subject diagnosed with the same pathology (e.g., the same type, stage, degree and/or classification of the pathology), or experiencing the clinical parameters of the same subject prior to treatment with the specific medicament.

A further aspect of the present disclosure relates to a method for determining a personalized treatment regimen for a subject suffering from a pathologic disorder. A “Personal treatment”, as used herein, refers to treatment which is tailored to the individual patient based on their predicted response or risk of disease. This term further encompasses any future monitoring, prediction and management of relapse and chances for response during relapse. In some embodiments, the method comprising the steps of: In step (a), detecting and classifying the sub-cellular localization of the proteasome in at least one biological sample of the subject to generate a pathological cell-profile reflecting the relative amount and/or ratio of pathological cell/s in the at least two pathological cell-related classes.

Step (b), involves determining the responsiveness of the subject to at least one treatment regime, based on the pathological cell-profile generated in step (a) of the disclosed personalized methods.

Step (c) of the disclosed methods involves selecting a treatment regimen based on the responsiveness determined in (b). More specifically, this step involves the selection of an appropriate treatment regimen (e.g., treatment regimen that comprises at least one therapeutic agent), if according to the generated pathological cell profile, the subject is classified as a responder, and is thus expected to display responsiveness to such treatment regimen. In some embodiments, the personalized method may further involve administration of an effective amount of at least one therapeutic agent, or subjecting the subject to the treatment regiment, or alternatively, administering to a subject classified as a non-responder, an alternative therapeutic agent or treatment regimen.

It should be understood that detecting and classifying the sub-cellular localization of the proteasome according to step (a), is performed by a method comprising the step of applying a single machine learning (ML) model on at least one input image of the sample. The machine learning model is a model, which has been trained using a partially and weakly labelled training dataset of images. For each input image, the machine learning model is configured to provide as output, C probability maps, where C is defined according to the number of classes in a group of classes which includes at least two cell-related classes and a background class. It should be noted that each map of the C probability maps corresponds to a respective class, wherein each cell-related class in the group of classes reflects a respective distribution of the proteasome within the cell. The c probability maps provide collectively, for each pixel in the input image, a respective probability vector comprising c probability values, each value indicating the probability that the pixel belongs to a respective class.

The method detecting and classifying the sub-cellular localization of the proteasome further involves applying post-processing on the output, comprising detecting one or more pathological cell in the at least one input image, based on the probability vectors, and classifying each detected pathological cell to a respective class in the group of classes, based on the probability values in the probability maps, thereby identifying one or more classified pathological cells in the at least one input image.

In some embodiments, determining and classifying the sub-cellular localization of the proteasome in at least one biological sample is performed by a method as defined in the present disclosure.

In yet some further embodiments of the disclosed prognostic methods, at least one of:
(I) a pathological cell-profile predominantly composed of classes that reflect a ratio of nuclear to cytosolic proteasomal localization that is greater than 1, is a profile where: (i) in some embodiments, more than 50% of the cells (e.g., the examined cells) in the sample are classified in at least one class reflecting a ratio of nuclear to cytosolic proteasomal localization that is greater than 1; and/or in some embodiments (ii), where less than 1% of the examined cells are classified in at least one class reflecting a ratio of nuclear to cytosolic proteasomal localization that is smaller than or equals to 0.5.
(II) a pathological cell-profile predominantly composed of classes that reflect a ratio of nuclear to cytosolic proteasomal localization that is smaller than or equals to 1, is a profile where: (i) in some embodiments, 50% or more of the cells (e.g., the examined cells) in the sample are classified in at least one class reflecting a ratio of nuclear to cytosolic proteasomal localization that is smaller than or equals to 1; and/or in some embodiments (ii), where 1% or more of the examined cells, are classified in at least one class reflecting a ratio of nuclear to cytosolic proteasomal localization that is smaller than or equals to 0.5.

It should be understood that in some embodiments of the disclosed personalized methods, at least one class of the at least two pathological-cell-related classes reflects a ratio of nuclear to cytosolic proteasomal localization that is greater than 1, and at least one class reflects a ratio of nuclear to cytosolic proteasomal localization that is smaller than or equal to 1. Still further, in some embodiments of the disclosed personalized methods, determining the responsiveness of the subject to at least one treatment regime comprises classifying the subject as: (i) a responder subject to a treatment regimen comprising at least one therapeutic agent, if the generated pathological cell-profile is predominantly composed of classes that reflect a ratio of nuclear to cytosolic proteasomal localization that is greater than 1; or as (ii), a non-responder or poor-responder subject, if the generated pathological cell-profile is predominantly composed of classes that reflect a ratio of nuclear to cytosolic proteasomal localization that is smaller than or equals to 1.

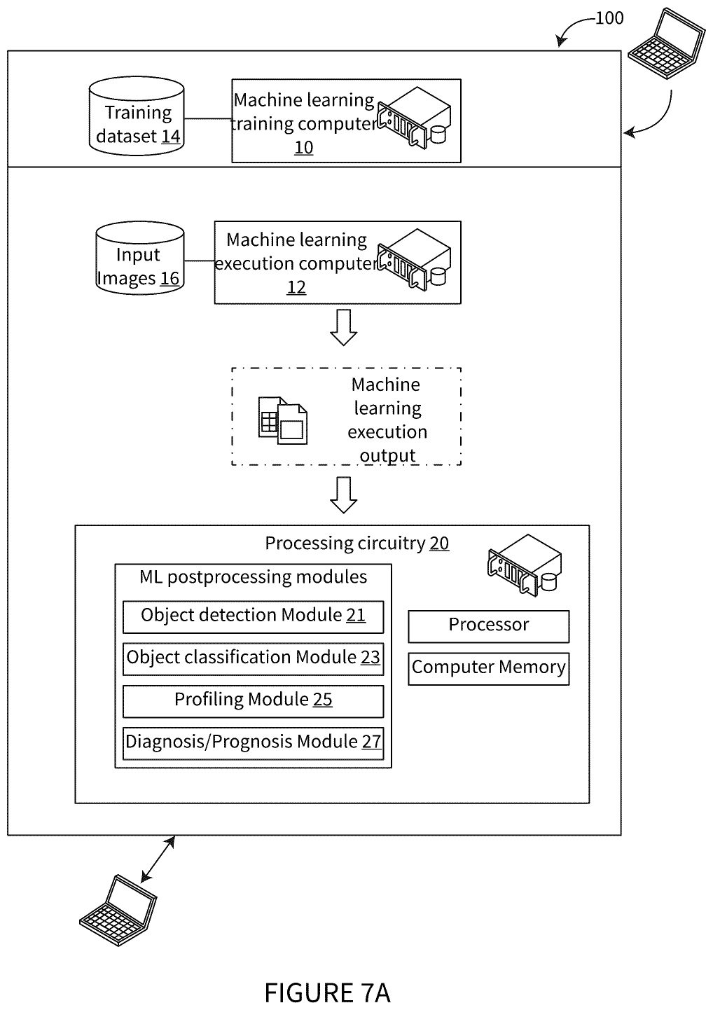

In some embodiments, the subject is and/or was subjected to a treatment regimen and is monitored for disease progression. In some embodiments, the treatment regimen may comprise the at least one therapeutic agent. Still further, the disclosed method comprising the steps of:
In step (a), determining and classifying the sub-cellular localization of the proteasome in at least one biological sample of the subject to generate a pathological cell-profile reflecting the relative amount and/or ratio of pathological cell/s in the at least two pathological cell-related classes. More specifically, each of the pathologic cells in the sample (or at least a portion of such cells), is classified into the various classes. The profile generated reflects the number/portion or ratio of the pathological cells in each class. Non-limiting example for such profile is provided in FIG. 6. It should be noted that in some embodiments, the profile may be presented in any appropriate graphical output, as a graph, histogram and the like. Still further, in some embodiments, at least one class of the at least two pathological-cell-related classes reflects a ratio of nuclear to cytosolic proteasomal localization that is greater than 1, and at least one class reflects a ratio of nuclear to cytosolic proteasomal localization that is smaller than or equals to 1. In yet some embodiments, at least one of the samples may be obtained after the initiation of the treatment regimen.
In step (b), determining at least one of: (i) a disease relapse and/or loss of responsiveness, and/or non-responsiveness, and/or poor-responsiveness and/or drug-resistance of the subject, if the generated pathological cell-profile is predominantly composed of classes that reflect a ratio of nuclear to cytosolic proteasomal localization that is smaller than or equals to 1; or (ii), responsiveness or maintained responsiveness of the subject, if the generated pathological cell-profile is predominantly composed of classes that reflect a ratio of nuclear to cytosolic proteasomal localization that is greater than 1.
In step (c), ceasing the treatment regimen (e.g., comprising the at least one therapeutic agent) for a subject displaying disease relapse and/or loss of responsiveness, and/or non-responsiveness, and/or poor-responsiveness and/or drug-resistance. alternatively, or maintaining the treatment regimen for a subject displaying responsiveness or maintained responsiveness. In some embodiments, the treatment regimen comprises at least one therapeutic agent.

Still further, in some embodiments, the subject is suffering from at least one of: at least one neoplastic disorder, and/or at least one protein misfolding disorder or deposition disorder.

In some embodiments, a proliferative disorder and/or neoplastic disorder as used herein, may be at least one benign or malignant solid and non-solid tumor. In yet some further embodiments, the protein misfolding disorder is amyloidosis and any related conditions. Still further, the methods disclosed by the present disclosure may be applicable for any proliferative disorder that may be in some embodiments, any neoplastic disease, more specifically, any abnormal mass of tissue, also referred to herein as a tumor, formed due to uncontrolled or abnormal cell growth that results increased cell number. The methods of the present disclosure may be applicable in some embodiments for any neoplasms, either benign neoplasms, in situ neoplasms, or malignant neoplasms.

As used herein to describe the present disclosure, “proliferative disorder”, “cancer”, “tumor” and “malignancy” all relate equivalently to a hyperplasia of a tissue or organ. If the tissue is a part of the lymphatic or immune systems, malignant cells may include non-solid tumors of circulating cells. Malignancies of other tissues or organs may produce solid tumors. In general, methods, systems and products of the present disclosure may be applicable for a patient suffering from any one of non-solid and solid tumors.

Malignancy, as contemplated in the present disclosure may be any one of carcinomas, melanomas, lymphomas, leukemia, myeloma and sarcomas. Therefore, in some embodiments any of the methods, products and systems of the present disclosure (specifically, therapeutic, prognostic and diagnostic methods), disclosed herein, may be applicable for any of the malignancies disclosed by the present disclosure.

More specifically, carcinoma as used herein, refers to an invasive malignant tumor consisting of transformed epithelial cells. Alternatively, it refers to a malignant tumor composed of transformed cells of unknown histogenesis, but which possess specific molecular or histological characteristics that are associated with epithelial cells, such as the production of cytokeratins or intercellular bridges.

Melanoma as used herein, is a malignant tumor of melanocytes. Melanocytes are cells that produce the dark pigment, melanin, which is responsible for the color of skin. They predominantly occur in skin but are also found in other parts of the body, including the bowel and the eye. Melanoma can occur in any part of the body that contains melanocytes.

Leukemia refers to progressive, malignant diseases of the blood-forming organs and is generally characterized by a distorted proliferation and development of leukocytes and their precursors in the blood and bone marrow. Leukemia is generally clinically classified on the basis of (1) the duration and character of the disease-acute or chronic; (2) the type of cell involved; myeloid (myelogenous), lymphoid (lymphogenous), or monocytic; and (3) the increase or non-increase in the number of abnormal cells in the blood-leukemic or aleukemic (subleukemic).

Sarcoma is a cancer that arises from transformed connective tissue cells. These cells originate from embryonic mesoderm, or middle layer, which forms the bone, cartilage, and fat tissues. This is in contrast to carcinomas, which originate in the epithelium. The epithelium lines the surface of structures throughout the body, and is the origin of cancers in the breast, colon, and pancreas.

Myeloma as mentioned herein is a cancer of plasma cells, a type of white blood cell normally responsible for the production of antibodies. Collections of abnormal cells accumulate in bones, where they cause bone lesions, and in the bone marrow where they interfere with the production of normal blood cells. Most cases of myeloma also feature the production of a paraprotein, an abnormal antibody that can cause kidney problems and interferes with the production of normal antibodies leading to immunodeficiency. Hypercalcemia (high calcium levels) is often encountered.

Lymphoma is a cancer in the lymphatic cells of the immune system. Typically, lymphomas present as a solid tumor of lymphoid cells. These malignant cells often originate in lymph nodes, presenting as an enlargement of the node (a tumor). It can also affect other organs in which case it is referred to as extranodal lymphoma. Non limiting examples for lymphoma include Hodgkin's disease, non-Hodgkin's lymphomas and Burkitt's lymphoma.

In some embodiments, the methods of the present disclosure may be applicable for any solid tumor. In more specific embodiments, the methods disclosed herein may be applicable for any malignancy that may affect any organ or tissue in any body cavity, for example, the peritoneal cavity (e.g., liposarcoma), the pleural cavity (e.g., mesothelioma, invading lung), any tumor in distinct organs, for example, the urinary bladder, ovary carcinomas, and tumors of the brain meninges.

In some further embodiments, the prognostic methods, as well as the therapeutic methods disclosed herein after by the present disclosure, may be suitable for various solid and non-solid tumors. More specifically, further malignancies that may find utility in the present disclosure can comprise but are not limited to hematological malignancies (including lymphoma, leukemia, myeloproliferative disorders, Acute lymphoblastic leukemia; Acute myeloid leukemia), hypoplastic and aplastic anemia (both virally induced and idiopathic), myelodysplastic syndromes, all types of paraneoplastic syndromes (both immune mediated and idiopathic) and solid tumors (including GI tract, colon, lung, liver, breast, prostate, pancreas and Kaposi's sarcoma. The present disclosure may be applicable as well for the treatment or inhibition of solid tumors such as tumors in lip and oral cavity, pharynx, larynx, paranasal sinuses, major salivary glands, thyroid gland, esophagus, stomach, small intestine, colon, colorectum, anal canal, liver, gallbladder, extraliepatic bile ducts, ampulla of vater, exocrine pancreas, lung, pleural mesothelioma, bone, soft tissue sarcoma, carcinoma and malignant melanoma of the skin, breast, vulva, vagina, cervix uteri, corpus uteri, ovary, fallopian tube, gestational trophoblastic tumors, penis, prostate, testis, kidney, renal pelvis, ureter, urinary bladder, urethra, carcinoma of the eyelid, carcinoma of the conjunctiva, malignant melanoma of the conjunctiva, malignant melanoma of the uvea, retinoblastoma, carcinoma of the lacrimal gland, sarcoma of the orbit, brain, spinal cord, vascular system, hemangiosarcoma, Adrenocortical carcinoma; AIDS-related cancers; AIDS-related lymphoma; Anal cancer; Appendix cancer; Astrocytoma, childhood cerebellar or cerebral; Basal cell carcinoma; Bile duct cancer, extrahepatic; Bladder cancer; Bone cancer, Osteosarcoma/Malignant fibrous histiocytoma; Brainstem glioma; Brain tumor; Brain tumor, cerebellar astrocytoma; Brain tumor, cerebral astrocytoma/malignant glioma; Brain tumor, ependymoma; Brain tumor, medulloblastoma; Brain tumor, supratentorial primitive neuroectodermal tumors; Brain tumor, visual pathway and hypothalamic glioma; Breast cancer; Bronchial adenomas/carcinoids; Burkitt lymphoma; Carcinoid tumor, childhood; Carcinoid tumor, gastrointestinal; Carcinoma of unknown primary; Central nervous system lymphoma, primary; Cerebellar astrocytoma, childhood; Cerebral astrocytoma/Malignant glioma, childhood; Cervical cancer; Childhood cancers; Chronic lymphocytic leukemia; Chronic myelogenous leukemia; Chronic myeloproliferative disorders; Colon Cancer; Cutaneous T-cell lymphoma; Desmoplastic small round cell tumor; Endometrial cancer; Ependymoma; Esophageal cancer; Ewing's sarcoma in the Ewing family of tumors; Extracranial germ cell tumor, Childhood; Extragonadal Germ cell tumor; Extrahepatic bile duct cancer; Eye Cancer, Intraocular melanoma; Eye Cancer, Retinoblastoma; Gallbladder cancer; Gastric (Stomach) cancer; Gastrointestinal Carcinoid Tumor; Gastrointestinal stromal tumor (GIST); Germ cell tumor: extracranial, extragonadal, or ovarian; Gestational trophoblastic tumor; Glioma of the brain stem; Glioma, Childhood Cerebral Astrocytoma; Glioma, Childhood Visual Pathway and Hypothalamic; Gastric carcinoid; Hairy cell leukemia; Head and neck cancer; Heart cancer; Hepatocellular (liver) cancer; Hodgkin lymphoma; Hypopharyngeal cancer; Hypothalamic and visual pathway glioma, childhood; Intraocular Melanoma; Islet Cell Carcinoma (Endocrine Pancreas); Kaposi sarcoma; Kidney cancer (renal cell cancer); Laryngeal Cancer; Leukemias; Leukemia, acute lymphoblastic (also called acute lymphocytic leukemia); Leukemia, acute myeloid (also called acute myelogenous leukemia); Leukemia, chronic lymphocytic (also called chronic lymphocytic leukemia); Leukemia, chronic myelogenous (also called chronic myeloid leukemia); Leukemia, hairy cell; Lip and Oral Cavity Cancer; Liver Cancer (Primary); Lung Cancer, Non-Small Cell; Lung Cancer, Small Cell; Lymphomas; Lymphoma, AIDS-related; Lymphoma, Burkitt; Lymphoma, cutaneous T-Cell; Lymphoma, Hodgkin; Lymphomas, Non-Hodgkin (an old classification of all lymphomas except Hodgkin's); Lymphoma, Primary Central Nervous System; Marcus Whittle, Deadly Disease; Macroglobulinemia, Waldenstrom; Malignant Fibrous Histiocytoma of Bone/Osteosarcoma; Medulloblastoma, Childhood; Melanoma; Melanoma, Intraocular (Eye); Merkel Cell Carcinoma; Mesothelioma, Adult Malignant; Mesothelioma, Childhood; Metastatic Squamous Neck Cancer with Occult Primary; Mouth Cancer; Multiple Endocrine Neoplasia Syndrome, Childhood; Multiple Myeloma/Plasma Cell Neoplasm; Mycosis Fungoides; Myelodysplastic Syndromes; Myelodysplastic/Myeloproliferative Diseases; Myelogenous Leukemia, Chronic; Myeloid Leukemia, Adult Acute; Myeloid Leukemia, Childhood Acute; Myeloma, Multiple (Cancer of the Bone-Marrow); Myeloproliferative Disorders, Chronic; Nasal cavity and paranasal sinus cancer; Nasopharyngeal carcinoma; Neuroblastoma; Non-Hodgkin lymphoma; Non-small cell lung cancer; Oral Cancer; Oropharyngeal cancer; Osteosarcoma/malignant fibrous histiocytoma of bone; Ovarian cancer; Ovarian epithelial cancer (Surface epithelial-stromal tumor); Ovarian germ cell tumor; Ovarian low malignant potential tumor; Pancreatic cancer; Pancreatic cancer, islet cell; Paranasal sinus and nasal cavity cancer; Parathyroid cancer; Penile cancer; Pharyngeal cancer; Pheochromocytoma; Pineal astrocytoma; Pineal germinoma; Pineoblastoma and supratentorial primitive neuroectodermal tumors, childhood; Pituitary adenoma; Plasma cell neoplasia/Multiple myeloma; Pleuropulmonary blastoma; Primary central nervous system lymphoma; Prostate cancer; Rectal cancer; Renal cell carcinoma (kidney cancer); Renal pelvis and ureter, transitional cell cancer; Retinoblastoma; Rhabdomyosarcoma, childhood; Salivary gland cancer; Sarcoma, Ewing family of tumors; Sarcoma, Kaposi; Sarcoma, soft tissue; Sarcoma, uterine; Sezary syndrome; Skin cancer (nonmelanoma); Skin cancer (melanoma); Skin carcinoma, Merkel cell; Small cell lung cancer; Small intestine cancer; Soft tissue sarcoma; Squamous cell carcinoma—see Skin cancer (nonmelanoma); Squamous neck cancer with occult primary, metastatic; Stomach cancer; Supratentorial primitive neuroectodermal tumor, childhood; T-Cell lymphoma, cutaneous (Mycosis Fungoides and Sezary syndrome); Testicular cancer; Throat cancer; Thymoma, childhood; Thymoma and Thymic carcinoma; Thyroid cancer; Thyroid cancer, childhood; Transitional cell cancer of the renal pelvis and ureter; Trophoblastic tumor, gestational; Unknown primary site, carcinoma of, adult; Unknown primary site, cancer of, childhood; Ureter and renal pelvis, transitional cell cancer; Urethral cancer; Uterine cancer, endometrial; Uterine sarcoma; Vaginal cancer; Visual pathway and hypothalamic glioma, childhood; Vulvar cancer; Waldenstrom macroglobulinemia and Wilms tumor (kidney cancer). It should be understood that the methods, systems and products of the present disclosure are applicable for any type and/or stage and/or grade of any of the malignant disorders discussed herein or any metastasis thereof. Still further, it must be appreciated that the methods, systems and products of the present disclosure may be applicable for invasive as well as non-invasive cancers. When referring to “non-invasive” cancer it should be noted as a cancer that do not grow into or invade normal tissues within or beyond the primary location. When referring to “invasive cancers” it should be noted as cancer that invades and grows in normal, healthy adjacent tissues.

Still further, in some embodiments, the methods, systems, products and kits of the present disclosure are applicable for any type and/or stage and/or grade of any metastasis, metastatic cancer or status of any of the cancerous conditions disclosed herein.

As used herein the term “metastatic cancer” or “metastatic status” refers to a cancer that has spread from the place where it first started (primary cancer) to another place in the body. A tumor formed by metastatic cancer cells originated from primary tumors or other metastatic tumors, that spread using the blood and/or lymph systems, is referred to herein as a metastatic tumor or a metastasis.

In yet some further embodiments, the neoplastic disorder is at least one hematological malignancy. In some other embodiments, the protein misfolding disorder or deposition disorder is amyloidosis and/or any related conditions.

In some embodiments, a disorder applicable for the methods, systems and products disclosed herein, may be at least one hematological malignancy. In yet some alternative embodiments, the method for determining a treatment regimen in accordance with the present disclosure may be applicable for a protein misfolding disorder or deposition disorder, for example, amyloidosis and/or any related conditions.

Still further, in some embodiments the method for determining a personalized treatment regimen in accordance with the present disclosure may be applicable in at least one malignancy, specifically, hematological cancer such as MM and/or related conditions. According to such embodiments, the methods of the present disclosure may be used for prognosis, monitoring and/or for determining a personalized treatment regimen for a subject suffering from MM and/or any related conditions and metastasis thereof.

Multiple myeloma (MM), also known as plasma cell myeloma and simple myeloma, is a cancer of plasma cells, a type of white blood cell that normally produces antibodies. Often, no symptoms are noticed initially. As it progresses, bone pain, bleeding, frequent infections, and anemia may occur. Complications may include amyloidosis. The cause of multiple myeloma is unknown. Risk factors include obesity, radiation exposure, family history, and certain chemicals. Multiple myeloma may develop from monoclonal gammopathy of undetermined significance that progresses to smoldering myeloma. The abnormal plasma cells produce abnormal antibodies, which can cause kidney problems and overly thick blood. The plasma cells can also form a mass in the bone marrow or soft tissue. When only one tumor is present, it is called a plasmacytoma; more than one is called multiple myeloma. Multiple myeloma is diagnosed based on blood or urine tests finding abnormal antibodies, bone marrow biopsy finding cancerous plasma cells, and medical imaging finding bone lesions. Another common finding is high blood calcium levels. Because many organs can be affected by myeloma, the symptoms and signs vary greatly. A mnemonic sometimes used to remember some of the common symptoms of multiple myeloma is CRAB: C=calcium (elevated), R=renal failure, A=anemia, B=bone lesions. Myeloma has many other possible symptoms, including opportunistic infections (e.g., pneumonia) and weight loss. Multiple myeloma is considered treatable, but generally incurable. Monoclonal gammopathy of undetermined significance (MGUS) increases the risk of developing multiple myeloma. MGUS transforms to multiple myeloma at the rate of 1% to 2% per year, and almost all cases of multiple myeloma are preceded by MGUS.

Smoldering multiple myeloma increases the risk of developing multiple myeloma. Individuals diagnosed with this premalignant disorder develop multiple myeloma at a rate of 10% per year for the first 5 years, 3% per year for the next 5 years, and then 1% per year. Still further, obesity is related to multiple myeloma with each increase of body mass index by five increasing the risk by 11%. Studies have reported a familial predisposition to myeloma. Hyperphosphorylation of a number of proteins, the paratarg proteins, a tendency that is inherited in an autosomal dominant manner, appears a common mechanism in these families. This tendency is more common in African-American with myeloma and may contribute to the higher rates of myeloma in this group. Rarely, Epstein-Barr virus (EBV) is associated with multiple myeloma, particularly in individuals who have an immunodeficiency due to e.g. HIV/AIDS, organ transplantation, or a chronic inflammatory condition such as rheumatoid arthritis. EBV-positive multiple myeloma is classified by the World Health Organization as one form of the Epstein-Barr virus-associated lymphoproliferative diseases and termed Epstein-Barr virus-associated plasma cell myeloma. EBV-positive disease is more common in the plasmacytoma rather than multiple myeloma form of plasma cell cancer. Tissues involved in EBV+ disease typically show foci of EBV+ cells with the appearance of rapidly proliferating immature or poorly differentiated plasma cells. The cells express products of EBV genes such as EBER1 and EBER2. While the EBV contributes to the development and/or progression of most Epstein-Barr virus-associated lymphoproliferative diseases, its role in multiple myeloma is not known. However, people who are EBV-positive with localized plasmacytoma(s) are more likely to progress to multiple myeloma compared to people with EBV-negative plasmacytoma(s). This suggest that EBV may have a role in the progression of plasmacytomas to systemic multiple myeloma. It should be understood that the methods of the present disclosure may be applicable for any type or stage of MM as disclosed herein.

In some embodiments, the hematological malignancy is MM and/or related conditions. Accordingly, the disclosed method is applicable for determining a personalized treatment regimen for a subject suffering from MM and/or any related conditions.

In yet some further particular embodiments, the methods of the present disclosure are applicable to protein misfolding disorder, also named proteopathy. Thus, the present disclosure provides prognostic methods and personalized therapeutic methods applicable for subjects suffering from any proteopathy, specifically, amyloidosis.

Proteopathy (also known as proteinopathies, protein conformational disorders, or protein misfolding diseases), refers to a class of diseases in which certain proteins become structurally abnormal, and thereby disrupt the function of cells, tissues and organs of the body. Often the proteins fail to fold into their normal configuration; in this misfolded state, the proteins can become toxic in some way (a gain of toxic function), or they can lose their normal function. In some specific embodiments, the proteopathy or protein-misfolding disorder may be Amyloidosis. Specifically, Amyloidosis is a group of diseases in which abnormal proteins, known as amyloid fibrils, build up in tissue. Symptoms depend on the type and are often variable. They may include diarrhea, weight loss, feeling tired, enlargement of the tongue, bleeding, numbness, feeling faint with standing, swelling of the legs, or enlargement of the spleen. There are about 30 different types of amyloidosis, each due to a specific protein misfolding. Some are genetic while others are acquired. They are grouped into localized and systemic forms. The four most common types of systemic disease are light chain (AL), inflammation (AA), dialysis (Aβ₂M), and hereditary and old age (ATTR). It should be understood that the prognostic and personalized therapeutic methods of the present disclosure, as well as any of the therapeutic methods, systems and products disclosed herein, may be applicable for any type of amyloidosis, specifically, any type discussed in the present disclosure.

In some particular and non-limiting embodiments, a therapeutic agent as discussed herein may be any agent or compound that modulates, either directly or indirectly, the proteasome dynamics and/or function. In some embodiments, such agents may modulate the proteasome localization, assembly and/or function. In yet some further embodiments, any of the therapeutic agents disclosed in the present disclosure are applicable for this aspect.

A further aspect of the present disclosure relates to a method for treating, preventing, inhibiting, reducing, eliminating, protecting or delaying the onset of at least one of: at least one neoplastic disorder and/or at least one protein misfolding disorder in a subject in need thereof. More specifically, the method comprising the steps of:

In step (a), detecting and classifying the sub-cellular localization of the proteasome in at least one biological sample of the subject to generate a pathological cell-profile reflecting the relative amount and/or ratio of pathological cell/s in at least two pathological cell-related classes. Step (b), involves determining the responsiveness of the subject to at least one treatment regime, based on the pathological cell-profile generated in step (a). In step (c), subjecting a subject determined as a responder in step (b), to the treatment regimen. Specifically, in case the subject is classified as responder, the method comprises administering a therapeutic effective amount of a therapeutic agent to the subject, and/or subjecting the responder subject to such therapeutic regimen.

It should be understood that detecting and classifying the sub-cellular localization of the proteasome according to step (a), is performed by a method comprising the step of applying a single machine learning (ML) model on at least one input image of the sample. The machine learning model is a model, which has been trained using a partially and weakly labelled training dataset of images. For each input image, the machine learning model is configured to provide as output, C probability maps, where C is defined according to the number of classes in a group of classes which includes at least two cell-related classes and a background class. It should be noted that each map of the C probability maps corresponds to a respective class, wherein each cell-related class in the group of classes reflects a respective distribution of the proteasome within the cell. The c probability maps provide collectively, for each pixel in the input image, a respective probability vector comprising C probability values, each value indicating the probability that the pixel belongs to a respective class in the group of classes.

The method further comprises applying post-processing on the output, comprising: detecting and classifying the sub-cellular localization of the proteasome further involves detecting one or more pathological cell in the at least one input image, based on the probability vectors, and classifying each detected pathological cell to a respective class in the group of classes, based on the probability values in the probability maps of pixels located in the detected object of interest, thereby identifying one or more classified pathological cells in the at least one input image.

In some embodiments, determining and classifying the sub-cellular localization of the proteasome in at least one biological sample is performed by a method as defined by the present disclosure.

As indicated above, the disclosed therapeutic methods involve detecting and classifying the sub-cellular localization of the proteasome in at least one biological sample of the subject to generate a pathological cell-profile reflecting the relative amount and/or ratio of pathological cell/s in the at least two pathological cell-related classes. More specifically, at least one class of the at least two pathological-cell-related classes reflects a ratio of nuclear to cytosolic proteasomal localization that is greater than 1, and at least one class reflects a ratio of nuclear to cytosolic proteasomal localization that is smaller than or equals to 1.

Still further, determining the responsiveness of the subject to at least one treatment regime as indicated in step (b) of the disclosed therapeutic methods, may involve classifying the subject as: (i), a responder subject to the treatment regimen comprising at least one therapeutic agent, if the generated pathological cell-profile is predominantly composed of classes that reflect a ratio of nuclear to cytosolic proteasomal localization that is greater than 1; or as(ii), a non-responder or poor-responder subject, if the generated pathological cell-profile is predominantly composed of classes that reflect a ratio of nuclear to cytosolic proteasomal localization that is smaller than or equals to 1.

Step (c) involves selecting a treatment regimen based on the responsiveness, thereby treating the subject with the selected treatment regimen.

In some particular and non-limiting embodiments, a therapeutic agent as discussed herein may be any agent or compound that modulates, either directly or indirectly, the proteasome dynamics, e.g., localization, assembly and/or function. It should be appreciated that any of the various therapeutic agents described by the present disclosure in connection with other aspects, may be applicable also in the present aspect.

The present disclosure provides therapeutic methods that encompass the diagnostic and prognostic methods, products and systems disclosed herein. Thus, in some aspects thereof, the present disclosure provides methods for treating, preventing, inhibiting, reducing, eliminating, protecting or delaying the onset of at least one pathologic disorder in a subject.

It is to be understood that the terms “treat”, “treating”, “treatment” or forms thereof, as used herein, mean preventing, ameliorating or delaying the onset of one or more clinical indications of disease activity in a subject having a pathologic disorder. Treatment refers to therapeutic treatment. Those in need of treatment are subjects suffering from a pathologic disorder. Specifically, providing a “preventive treatment” (to prevent) or a “prophylactic treatment” is acting in a protective manner, to defend against or prevent something, especially a condition or disease. The term “treatment or prevention” as used herein, refers to the complete range of therapeutically positive effects of administrating to a subject including inhibition, reduction of, alleviation of, and relief from, pathologic disorder involved with at least one short term cellular stress condition/process and any associated condition, illness, symptoms, undesired side effects or related disorders. More specifically, treatment or prevention of relapse or recurrence of the disease, includes the prevention or postponement of development of the disease, prevention or postponement of development of symptoms and/or a reduction in the severity of such symptoms that will or are expected to develop. These further include ameliorating existing symptoms, preventing—additional symptoms and ameliorating or preventing the underlying metabolic causes of symptoms. It should be appreciated that the terms “inhibition”, “moderation”, “reduction”, “decrease” or “attenuation” as referred to herein, relate to the retardation, restraining or reduction of a process by any one of about 1% to 99.9%, specifically, about 1% to about 5%, about 5% to 10%, about 10% to 15%, about 15% to 20%, about 20% to 25%, about 25% to 30%, about 30% to 35%, about 35% to 40%, about 40% to 45%, about 45% to 50%, about 50% to 55%, about 55% to 60%, about 60% to 65%, about 65% to 70%, about 75% to 80%, about 80% to 85% about 85% to 90%, about 90% to 95%, about 95% to 99%, or about 99% to 99.9%, 100% or more.

With regards to the above, it is to be understood that, where provided, percentage values such as, for example, 10%, 50%, 120%, 500%, etc., are interchangeable with “fold change” values, i.e., 0.1, 0.5, 1.2, 5, etc., respectively.

The term “amelioration” as referred to herein, relates to a decrease in the symptoms, and improvement in a subject's condition brought about by the compositions and methods according to the present disclosure, wherein said improvement may be manifested in the forms of inhibition of pathologic processes associated with the disorders described herein, a significant reduction in their magnitude, or an improvement in a diseased subject physiological state.

The term “inhibit” and all variations of this term is intended to encompass the restriction or prohibition of the progress and exacerbation of pathologic symptoms or a pathologic process progress, said pathologic process symptoms or process are associated with.

The term “eliminate” relates to the substantial eradication or removal of the pathologic symptoms and possibly pathologic etiology, optionally, according to the methods of the present disclosure described herein.

The terms “delay”, “delaying the onset”, “retard” and all variations thereof are intended to encompass the slowing of the progress and/or exacerbation of a disorder associated with the at least one short term cellular stress condition/process and their symptoms, slowing their progress, further exacerbation or development, so as to appear later than in the absence of the treatment according to the present disclosure.

As indicated above, the methods and compositions provided by the present disclosure may be used for the treatment of a “pathological disorder”, i.e., pathologic disorder or condition involved with at least one short term cellular stress condition/process, which refers to a condition, in which there is a disturbance of normal functioning, any abnormal condition of the body or mind that causes discomfort, dysfunction, or distress to the person affected or those in contact with that person. It should be noted that the terms “disease”, “disorder”, “condition” and “illness”, are equally used herein.

It should be appreciated that any of the methods, kits and compositions described by the present disclosure may be applicable for treating and/or ameliorating any of the disorders disclosed herein or any condition associated therewith. It is understood that the interchangeably used terms “associated”, “linked” and “related”, when referring to pathologies herein, mean diseases, disorders, conditions, or any pathologies which at least one of: share causalities, co-exist at a higher than coincidental frequency, or where at least one disease, disorder condition or pathology causes the second disease, disorder, condition or pathology. More specifically, as used herein, “disease”, “disorder”, “condition”, “pathology” and the like, as they relate to a subject's health, are used interchangeably and have meanings ascribed to each and all of such terms.

It should be appreciated that the methods, products and systems of the present disclosure may be suitable for any subject that may be any multicellular organism, specifically, any vertebrate subject, and more specifically, a mammalian subject, avian subject, fish or insect. In some specific embodiments, the prognostic as well as the therapeutic, methods presented by the enclosed disclosure may be applicable to mammalian subjects, specifically, human subjects. By “patient” or “subject” it is meant any mammal that may be affected by the above-mentioned conditions, and to whom the treatment and prognostic methods herein described is desired, including human, bovine, equine, canine, murine and feline subjects. Specifically, the subject is a human.

It should be understood that the diagnostic, prognostic, monitoring and classification methods and computer implemented programs provided by the present disclosure may by applied on the diagnosis, grading, classification, monitoring, and tailoring of a personal therapeutic strategy for each patient, either alone, or in any combination with any other appropriate diagnostic approach/es.

For example, in MM, or any other malignancy, the specific methods and computer implemented programs of the present disclosure may be combined with any scoring, grading, staging systems (including but limited to radiological, pathological, clinical and/or laboratory-based scoring systems), means, biomarkers, and ethological, clinical (e.g., pain), physiological or environmental parameters. To name but a few, the disclosed methods and computer implemented programs may be combined with the Revised Multiple Myeloma International Staging System (R-ISS), and/or International staging system(ISS), Durie-Salmon staging system, and any other appropriate system, or any combinations thereof. Still further, the disclosed methods and computer implemented programs of the present disclosure may be combined in addition or alternatively with any cytogenetic classification of MM or of any other malignancy. More specifically, cytogenetic classification applicable in the present disclosure may include detection of genetic abnormalities such as rearrangements, deletions, insertions, translocations, (e.g., using fluorescence in situ hybridization (FISH) or any other appropriate means), trisomies and monosomies. Specific cytogenetic abnormalities used for detection, staging and grading MM include, but are not limited to trisomy(ies) without IgH abnormalities, IgH abnormalities without trisomy(ies), and both, trisomy(ies) with IgH abnormalities, monosomy 14, monosomy 13 and p53 abnormalities, 117p13 deletion, gain or amplification 1q and the like. Other serum biomarkers applicable in the present disclosure include, but are not limited to beta-2 microglobulin (B2M), lactate dehydrogenase (LDH), serum IgA, serum IgG, serum calcium, urine monoclonal protein extraction, serum creatinine, Hb levels and the like.

The disclosed methods and computer implemented programs may be further combined with additional co-morbidities, including but not limited to diabetes, renal failure, heart failure, ischemic heart disease, hyperlipidemia, COPD, hypertension, peripheral cardiovascular disease; as well as additional demographics, laboratory test results, medical imaging, and medical records and information such as age, gender, history of malignancy/neurological disease/cardiovascular disease, family medical history including hereditary genetic conditions, etc.; and any other information that may carry a prognostic value that may complement and/or enhance the disclosed methods and computer implemented programs.

A further aspect of the present disclosure relates to a diagnostic system comprising at least one processing circuitry configured to execute a method of training machine learning model for detection and multi-class classification of pathological cells in an image using a single machine learning model for both detection and classification, in accordance with the present disclosure.

Unless specifically stated otherwise, as apparent from the following discussions, it is appreciated that, throughout the specification, discussions utilizing terms such as “detecting”, “classifying”, “summing”, “identifying”, “connecting, “generating” or the like, include an action and/or processes of a computer that manipulate and/or transform data into other data, said data represented as physical quantities, e.g. such as electronic quantities, and/or said data representing the physical objects.

The terms “computer,” “computer system,” “computer device,” “computer server”, or the like, should be expansively construed to include any kind of hardware-based electronic device with one or more data processing circuitries (e.g., one or more of, digital signal processor (DSP), a graphics processing unit (GPU), a TPU, a field programmable gate array (FPGA), an application specific integrated circuit (ASIC), Reduced Instruction Set Computing (RISC) processor, Complex Instruction Set Computing (CISC) processor microcontroller, microprocessor, etc.). Each processing circuitry may comprise, for example, one or more processors operatively connected to computer memory, loaded with executable instructions for executing operations, as further described below.

Operations in accordance with the teachings herein may be performed by a computer specially constructed for the desired purposes, or by a general-purpose computer specially configured for the desired purpose by a computer program stored in a computer readable storage medium.

Still further, the present disclosure further encompasses any diagnostic or prognostic kit that comprise any of the processing circuitry configured to execute the methods disclosed herein, any/or of the computer program products, together with any reagent required for the preparation of the sample and/or the detection of the cells of interest, and any reagent required for detecting and classifying the cellular localization of the cytosol. As used herein, the phrase “for example”, “such as”, “for instance” and variants thereof, describe non-limiting embodiments of the presently disclosed subject matter. Reference in the specification to “one example”, “some examples”, “other examples”, or variants thereof, means that a particular feature, structure or characteristic described in connection with the embodiment(s) is included in at least one embodiment of the presently disclosed subject matter. Thus, the appearance of the phrase “one example”, “some examples”, “other examples” or variants thereof does not necessarily refer to the same embodiment(s).

It is noted that while examples disclosed herein predominantly refer to detection and classification of Multiple Myeloma cells this information is provided merely as a non-limiting example of one type of application and the same principles of Machine learning detection and multi-class classification disclosed herein can be likewise applied on images in a variety of other technological fields and application, including but not limited to: detection and classification of flowers or leaves, detection and classification of grains, detection and classification of minerals, detections and classification of vehicles in satellite images, contaminating agents or pathogens in environmental samples, and the like.

The terms “increase”, “augmentation” and “enhancement” as used herein relate to the act of becoming progressively greater in size, amount, number, or intensity. Particularly, an increase of 10%, 15%, 20%, 25%, 30%, 35%, 40%, 45%, 50%, 55%, 60%, 65%, 70%, 75%, 80%, 85%, 90%, 95%, 100%, 200%, 300%, 400%, 500%, 600%, 70%, 800%, 900%, 1000% or more of the activity as compared to a suitable control.

All definitions, as defined and used herein, should be understood to control over dictionary definitions, definitions in documents incorporated by reference, and/or ordinary meanings of the defined terms.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to +10%.

The indefinite articles “a” and “an,” as used herein in the specification and in the claims, unless clearly indicated to the contrary, should be understood to mean “at least one.” It must be noted that, as used in this specification and the appended claims, the singular forms “a”, “an” and “the” include plural referents unless the content clearly dictates otherwise.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

Throughout this specification and the Examples and claims which follow, all transitional phrases such as “comprising,” “including,” “carrying,” “having,” “containing,” “involving,” “holding,” “composed of,” and the like are to be understood to be open-ended, i.e., to mean including but not limited to. Specifically, it should be understood as implying the inclusion of a stated integer or step or group of integers or steps but not the exclusion of any other integer or step or group of integers or steps. Only the transitional phrases “consisting of” and “consisting essentially of” shall be closed or semi-closed transitional phrases, respectively, as set forth in the United States Patent Office Manual of Patent Examining Procedures. More specifically, the terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

It should be noted that various embodiments of this disclosure may be presented in a range format. It should be understood that the description in range format is merely for convenience and brevity and should not be construed as an inflexible limitation on the scope of the present disclosure. Accordingly, the description of a range should be considered to have specifically disclosed all the possible sub ranges as well as individual numerical values within that range. For example, description of a range such as from 1 to 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable sub combination or as suitable in any other described embodiment of the present disclosure. Certain features described in the context of various embodiments are not to be considered essential features of those embodiments, unless the embodiment is inoperative without those elements.

Various embodiments and aspects of the present disclosure as delineated herein above and as claimed in the claims section below find experimental support in the following examples.

Disclosed and described, it is to be understood that this disclosure is not limited to the particular examples, methods steps, and compositions disclosed herein as such methods steps and compositions may vary somewhat. It is also to be understood that the terminology used herein is used for the purpose of describing particular embodiments only and not intended to be limiting since the scope of the present disclosure will be limited only by the appended claims and equivalents thereof.

The following examples are representative of techniques employed by the inventors in carrying out aspects of the present disclosure. It should be appreciated that while these techniques are exemplary of preferred embodiments for the practice of the present disclosure, those of skill in the art, in light of the present disclosure, will recognize that numerous modifications can be made without departing from the spirit and intended scope of the present disclosure.

It is to be understood that when specific values are given herein, they are meant to include a range of values acceptable within practical tolerances known in the pertinent field. Furthermore, for the sake of clarity, the term “substantially” or “approximately” is used herein to imply the possibility of variations in the specified values. For example, the term “pixels or pixel located substantially at the center of object”, implies that the pixels may be located at the center but may also deviate from the exact center to some extent.

### EXAMPLES

### Experimental Procedures

### Exemplary Process Description

The inventors hereby detail the scheme for simultaneous detection and classification of Multiple Myeloma (MM) cells, is hereby detailed. The present approach is an improvement of the work of Qu et al., [17], in which partial point annotations of approximately 5% of the total cells in the image, are the driving force for both detection and accurate segmentation for the whole image. As opposed to [17], the final desired outcome is not segmentation, but rather a localization and classification of the cells to nine categories, leading to an accurate and personalized “cell portfolio” for each patient.

### Weakly Supervised Segmentation Using Partial Points (‘Baseline Method’)

For the sake of completeness, the main stages in [39] which aims at cell instance segmentation, were briefly outlined. The proposed algorithm consists of two stages: (1) cell detection, given partial point annotations, and (2) cell segmentation using pseudo labels. In the detection stage, extended Gaussian masks are created from the partial point annotations in each image, using the following mask.

$${M}_{i} = \{ \begin{matrix}exp ( - \frac{{D}_{i}^{2}}{2 {σ}^{2}} ) & if {D}_{i} < {r}_{1} \\ 0 & if {r}_{1} \leq {D}_{i} < {r}_{2} \\ - 1 & otherwise\end{matrix} \qquad ( 1 )$$

where Dis the euclidean distance of pixel i to the closest cell point. The above encoding models each annotated point as a Gaussian, surrounded by a ‘background ring’ with radii r₁,r₂. Pixels located further away from point annotations are ignored during training. A UNet with a ResNet34 pre-trained encoder is trained to regress over the extended Gaussian masks via an MSE loss. To improve the false positive rate, the authors of [17] suggest self-training with background propagation. Once the first network has finished training, a new set of training labels is formed by adding pixels with predicted output probability pᵢ<0.1 and pᵢ>0.7 to the background. Another round of training then begins with a newly initialized network and the updated labels. After 2-3 rounds, the predicted cell locations from the trained detection network are used for creating two sets of pseudo labels. In the first, the detected points serve as seeds for Voronoi partitioning, where the resulting partition lines are tagged as background and the detected points as cells. The second pseudo label is formed by clustering the image pixels to ‘cell’, ‘background’ and ‘ignore’ classes using KMeans. A new network is then trained to output ‘cell’ and ‘background’ probability maps, via minimization of a cross-entropy loss over the two sets of pseudo-labels.

### Multiclass Label Encoding

According to the present disclosure partial point labels of an input image were encoded as a multiclass mask. Denote XϵR^{|Ω|×3} as the RGB input image, belonging to the discrete image domain Ω, where |Ω| is the number of pixels. The corresponding multiclass mask MϵR^{|Ω|×C}. where C is the number of classes, is given by:

$${M}_{i}^{c} = \{ \begin{matrix}1 , & if {D}_{i}^{c = {c}_{gt}} < {r}_{1} \\ 0 , & if {D}_{i}^{c \neq {c}_{gt}} < {r}_{1} \\ 1 , & if {r}_{1} \leq {D}_{i}^{c = {c}_{B}} < {r}_{2} \\ 0 , & if {r}_{1} \leq {D}_{i}^{c \neq {c}_{B}} < {r}_{2} \\ - 1 , & otherwise\end{matrix} \qquad ( 2 )$$

where c denotes the class, c_{B} the background class, c_{gt} the ground truth class, and Dᵢ^{c} the distance of pixel i in class c to the closest point annotation. Each cell is represented as a uniform circle of radius r₁ in the corresponding ground truth class, surrounded by a background ring of radii r₁,r₂. All other pixels are ignored during training. This representation, shown in FIG. 1, amplifies the weak point annotations and enforces the existence of background around each cell, decreasing cell merging in tight clusters. Note, this representation may not be accurate around the edges of the cell, since cells vary in size and shape, whereas the solution will gravitate towards similar sized circles. This shall be addressed in the energy-based smoothness function, explained in the next Section [Network Architecture]. The above-representation is referred to herein as ‘ours-ring’.

The present inventors propose another cell representation, adding an additional level of supervision to the background, by using a version of the Voronoi labels, introduced above in the Section disclosing Weakly Supervised Segmentation using Partial Points. The cell points predicted in the detection stage, are used to compute Voronoi cell boundaries which are now considered as background pixels. As opposed to [17], instead of using all cells as supervision, only those that have class annotations (only 5% of cells in the image) were used herein. The inventors encode these cells as Gaussians as in the Section above [Weakly Supervised Segmentation using Partial Points], appearing only in the channel corresponding to the annotated class. This representation is referred to herein as ‘ours-vor’.

### Network Architecture

To perform simultaneous detection and classification, the problem was formalized as a multi-class segmentation task. Training the network to solve both tasks simultaneously, as opposed to using an additional cell classifier, is naturally more efficient in both training and inference, since the two-share common low- and high-level features. In addition, end-to-end training may reduce accumulated errors in one task that often propagate to the other, improving the accuracy and robustness of the solution. Instead of using pixelwise segmentation masks, the partial cell encodings, introduced in the above Section Multiclass Label Encoding, was utilized. Given the above masks, a UNet [Ronneberger, O., et al., (2015)] model, shown in FIG. 1, with its encoder—a ResNet34 model [He, K., Zhang, X., Ren, S., Sun, J.: Deep residual learning for image recognition. In: Proceedings of the IEEE conference on computer vision and pattern recognition. pp. 770-778 (2016)], pre-trained on ImageNet [Russakovsky, O., et al. (2015)], is trained via a combination of partial cross-entropy [Tang, M., et al. (2018)] and energy-based smoothness [Golts, A., et al., (2021)] losses. The network receives the input RGB image XϵR^{|Ω|×3}, and outputs f_{θ}(X)≅Yϵ^{|Ω|×C}, the pixelwise C-way softmax probabilities.

### Loss Functions

The proposed loss function disclosed herein is composed of two terms. The data term is based on the partial cross entropy [Tang, M., et al. (2018)], defined as:

$${ℒ}_{wpce} = {\sum }_{c = 1}^{C} {\sum }_{i ∈ {Ω}_{L}} - {γ}^{c} {M}_{i}^{c} log {Y}_{i}^{c} \qquad ( 3 )$$

where Ω_{L} is the set of annotated pixel coordinates, Mᵢ^{c}ϵ{0, 1}^{C} is the C dimensional one-hot annotation vector at pixel i, and Y₁ϵ[0,1]^{C} is the C-dimensional softmax probability output vector from the network f_{θ}. The inventors introduce an additional weighting coefficient γ^{c} such that the cell annotations receive stronger weights, as opposed to the background class. The added weight vector is set as γ=[1,α,α, . . . ,α]ϵR^{C},α>1 and promotes stronger confidence for the human-provided cell annotations. The smoothness term is based on the random-walker energy-minimization technique suggested in [Grady, L., IEEE transactions on pattern analysis and machine intelligence 28(11), 1768-1783 (2006)] and implemented via DNNs in [Golts, A., et al., (2021)]. The image is represented as a weighted graph in which each pixel is a vertex and adjacent pixels are connected with edges: wᵢⱼ=exp{−β∥Xᵢ−Xⱼ∥²}, where i,j are the pixel coordinates, Xᵢ,Xⱼ are their corresponding RGB values and β is a hyper-parameter. The random walker regularization term is given by:

$${ℒ}_{smooth} = {\sum }_{c = 1}^{C} {\sum }_{i , j ∈ ε} {{w}_{ij} ( {Y}_{i}^{c} - {Y}_{j}^{c} )}^{2} \qquad ( 4 )$$

where ε is the group of adjoining pixels in a 4-neighborhood connectivity. The above term penalizes variation between adjacent pixel values of the output probability maps. A higher penalty is inflicted on similar colored pixels, as compared to transitional areas with edges and boundaries. This imposes the output probability maps to abide to the given edges and boundaries in the input image. The final loss function, minimized during training is:

$$L = Lwpce + λ Lsmooth , \qquad ( 5 )$$

where λ is a hyper-parameter, striking a balance between the uniform partial cross entropy loss, and the shape and boundary preserving smoothness loss.

Inference of a new image is performed via a forward-pass over the trained network, resulting in C softmax probability maps. An additional post-processing, detailed in Algorithm 1 (see Table 1), is performed which involves extracting the cell pixels by thresholding, removing irregularly sized cells and classifying each obtained blob by assigning the class with the highest average probability. In such a way, one can collect cell class predictions for each tile in the input slide and aggregate them to a patient-specific cell histogram.

TABLE 1
Algorithm 1: Simultaneous Detection and Classification Inference

```
Input: output probability maps ƒ_{θ}(X) = Y ∈ R^{|Ω|×C}
Init: per-class scores = 0 ∈ R^{C}, final prediction Y_{pred} = 0 ∈ R^{|Ω|}
Y_{cell} = sum(Y[:,1:], dim = 1)
Yₜₕᵣₑₛₕ = threshold (Y_{cell}, t)
Y_{comps} = connected − components(Yₜₕᵣₑₛₕ)
Y_{comps} = remove − small − components(Y_{comps}, πₗ)
Y_{comps} = remove − large − components(Y_{comps}, πᵤ)
K = len(Y_{comps})
For k = 0 to K − 1 do:
  coords = component − coords(Y_{comps}[k])
  For c = 0 to C − 1 do:
  scores[c] = mean(Y[coords, c])
  Y_{pred}[coords] = argmax (scores)
Return: Y_{pred}
```

The semi- and weakly-supervised dataset constructed by the present disclosure is hereby detailed, along with the metrics used for detection and classification, the experimental setup and the final results of the disclosed method.

### Example 1

### Dataset

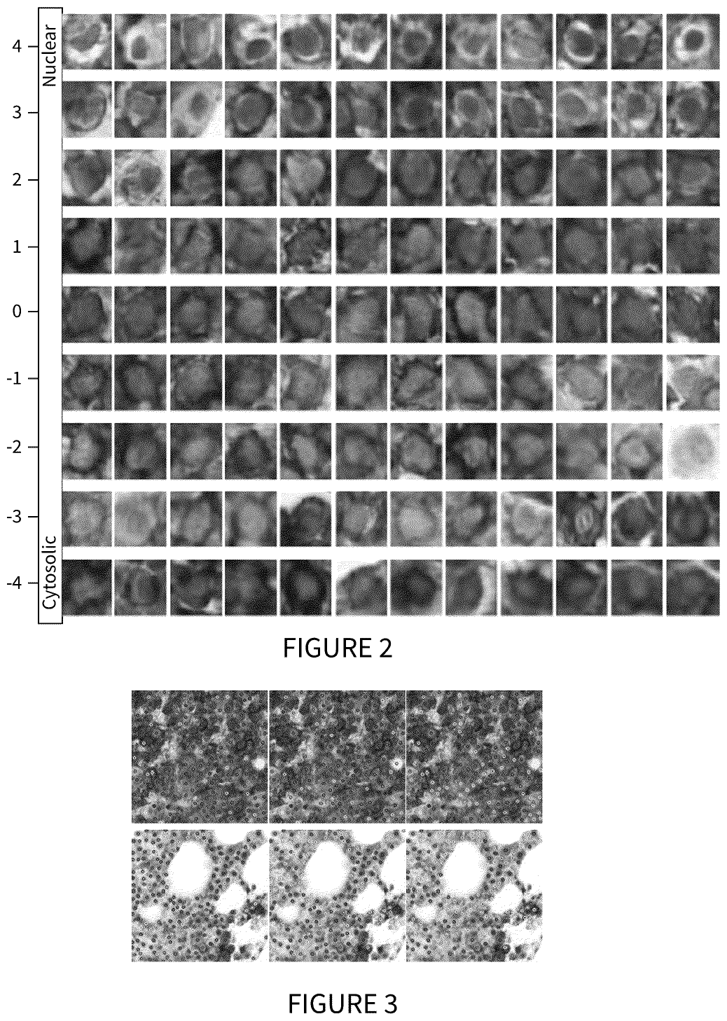

A dataset of Immunohistochemistry (IHC) images of 12 Multiple Myeloma (MM) patients' bone-marrow samples, collected in Rambam Medical Center in Israel, was first constructed. Each slide is stained to reveal both MM cells and the sub-cellular Proteasomal pattern and is then scanned with a 3DHistech scanner. The digitized slides are globally thresholded using Otsu filter and divided up into hundreds of 512×512 image patches, termed ‘tiles’, where tiles containing less than 50% tissue are discarded. Each annotated cell in the dataset is ranked for the spread of proteasomal staining, with a score of −4 (most cytosolic) to 4 (most nuclear), where the visual characteristics of each consecutive score are slightly different. An additional ‘non-relevant’ category is assigned to non-malignant cells, appearing in the biopsy. Note that the background class is not annotated but inferred as part of our solution. FIG. 2 presents different representatives in each class.

In general, the inventors avoided laborious pixelwise annotations of each tile, and instead opt for partial and weakly supervised labels, obtained in several hours of a practiced Pathologist's labor. The dataset presented herein, consisting of 277 512×512 tiles, collected from different slides, is annotated with partial annotations of either points, denoting cell centers, or bounding boxes, depicting the location and size of the cell. The images are divided to three groups: 214 partially point/box annotated images for training, 21 fully annotated points for evaluation of detection performance (7 for validation; 14 for test), and partially annotated points/boxes for classification evaluation (18 for validation and 24 for test). All images are partially annotated, with an average of 5% of the cells in each image. To evaluate the detection performance, all the cells were annotated as points in the detection evaluation set, without specifying the exact class, in order to save expensive annotation time. The full description of the dataset is given in Table 2.

TABLE 2

| Dataset | #images | type | #annotations | −4 | −3 | −2 | −1 | 0 | 1 | 2 | 3 | 4 | 5 |
|---|---|---|---|---|---|---|---|---|---|---|---|---|---|
| ‘train’ | 214 | point | 1636 | 63 | 183 | 154 | 167 | 171 | 167 | 138 | 171 | 72 | 283 |
| ‘class-val’ | 18 | bbox | 220 | 10 | 27 | 25 | 19 | 24 | 19 | 16 | 25 | 9 | 36 |
| ‘class-test’ | 24 | bbox | 319 | 15 | 37 | 33 | 32 | 34 | 32 | 27 | 34 | 14 | 48 |
| ‘det-val’ | 7 | point | 845 | | | | | | | | | | |
| ‘det-test’ | 14 | point | 2012 | | | | | | | | | | |

Dataset. Number of examples and annotations in each set and each class, where −4 is most cytosolic cell and 4 is most nuclear cell; 5 denotes non-relevant cell.

### Example 2

### Evaluation Metrics

Recall the dataset consists of two types of evaluation sets, one with fully annotated points for each cell location, but without their labels, and the other with partially annotated cells and their corresponding bounding boxes and labels. The first set of images, denoted as ‘det-test’, was used to measure detection performance.

The inventors compute the precision, recall and F₁ as in [17]

$$P = \frac{tp}{tp + fp} , R = \frac{tp}{tp + fn} , {F}_{1} = \frac{2 PR}{P + R} , \qquad ( 6 )$$

where tp, fp, fn are the number of true positives, false positives and false negatives, correspondingly. A predicted point is added to tp if it is located within an r₁ radius distance from a ground truth (GT) point. A GT point, without any corresponding prediction is added to fn, and a prediction without a corresponding GT is added to fp. To evaluate localization accuracy, the inventors additionally report the mean (μ) and standard deviation (σ) of the distance between GT and their corresponding tp points, defined as:

$$μ = \frac{1}{{N}_{tp}} {\sum }_{i = 1}^{{N}_{tp}} {d}_{i} , σ = \sqrt{\frac{1}{{N}_{tp}} {\sum }_{i = 1}^{{N}_{tp}} {( {d}_{i} - μ )}^{2}} \qquad ( 7 )$$

where dᵢ is the euclidean distance between GT and corresponding prediction. To evaluate classification performance, the image set ‘class-test’ was used. The relative recall was first computed on the partial set of annotations, similarly to the above detection stage. Note that the inventors cannot compute fp since the images are only partially annotated, thus real predictions cannot be distinguished from false positives. The partial recall for ‘class-test’ is thus R=tp/(tp+fn). To compute the classification performance of the cells tagged as tp in the previous stage, the inventors used the accuracy, precision, recall and F1 classification metrics:

$$P = \frac{tp}{tp + fp} , R = \frac{tp}{tp + fn} , {F}_{1} = \frac{2 PR}{P + R} , Acc = \frac{tp + tn}{tp + tn + fp + fn} , \qquad ( 8 )$$

where tp, tn are positive and negative examples correctly classified, fn are positive examples, incorrectly classified as negative and fp are negative examples, incorrectly classified as positive. The multi-class scores of each metric were calculated by taking the weighted average of the one-vs-all scores of each class. The inventors also compute the mAP (mean Average Precision) score, measuring the area under the precision-recall curve, weighted across all classes.

### Example 3

### Implementation Details

The radii and Gaussian width encoding parameters are determined from the validation set and taken as r₁=12, r₂=14.5, σ=r₁/3. The post-processing threshold, minimum and maximum areas are:

$$t = 0.85 , {π}_{l} = {π ( {r}_{1} / 3.5 )}^{2} , {π}_{u} = π {r}_{1}^{2}$$

The hyper-parameters in the loss function are taken as α=10, β=30, λ=1e⁻⁵. During training, data augmentation of the input 512×512 tiles, including random resize, horizontal and vertical flip, rotation, affine transformation and crop to the input size of the network 224×224, was performed. As suggested in [17], the inventors use ResUNet—a fully-convolutional UNet model, with the ResNet34 encoder pretrained on ImageNet. The network is trained using the Adam optimizer with a learning rate of 10⁻¹, weight decay of 10⁻³ and batch size of 16. The inventors choose the model that gave the best combined F₁ metric of both the detection, denoted as

$${F}_{1}^{D}$$

and classification, denoted as

$${F}_{1}^{C} ,$$

represented as a geometric average of both:

$${F}_{1}^{Best} = ( 2 \cdot {F}_{1}^{D} \cdot {F}_{1}^{C} ) / ( {F}_{1}^{D} + {F}_{1 )}^{C} .$$

The inventors implement the code in Pytorch and Numpy on a GTX Titan-X Nvidia GPU. The ‘baseline’ method is based on the implementation of [17]. The detection network is trained for 4 rounds, after which it produces point, Voronoi and cluster labels for the training of the next segmentation network. To produce classifications, CNN was trained with three 3×3 convolutional layers of width 16,32,64, each followed by BatchNorm, ReLU and 2×2 MaxPool. The final two linear layers are of size 100, C, where C is the number of classes. For every segmented component, the surrounding bounding box is extracted and warped to constant size of 64×64, then fed to the trained classifier. The classifier is trained and validated using bounding boxes in the train and validation sets.

### Example 4

### Comparing Approaches of Cell Detection and Classification

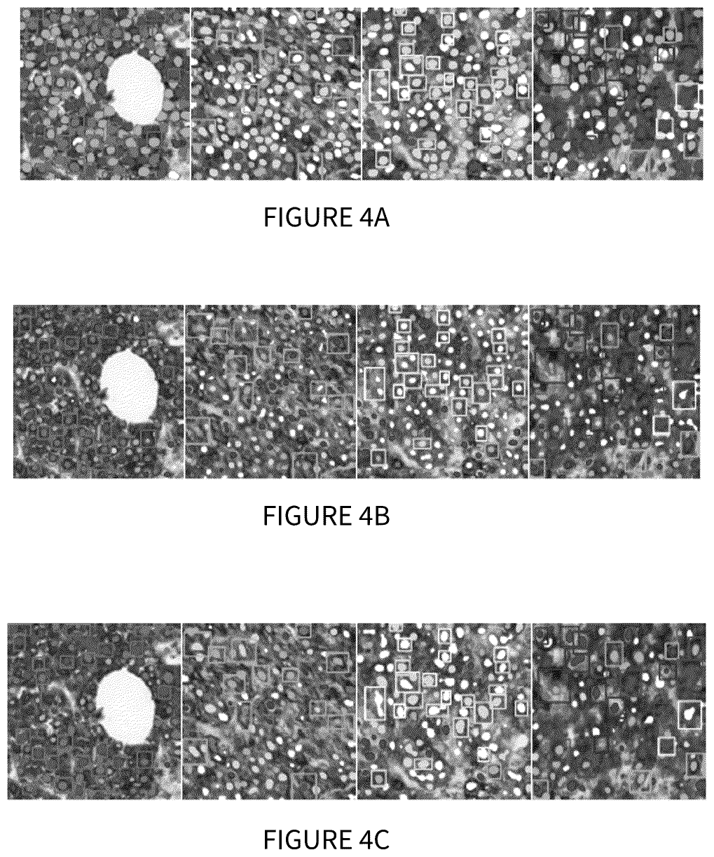

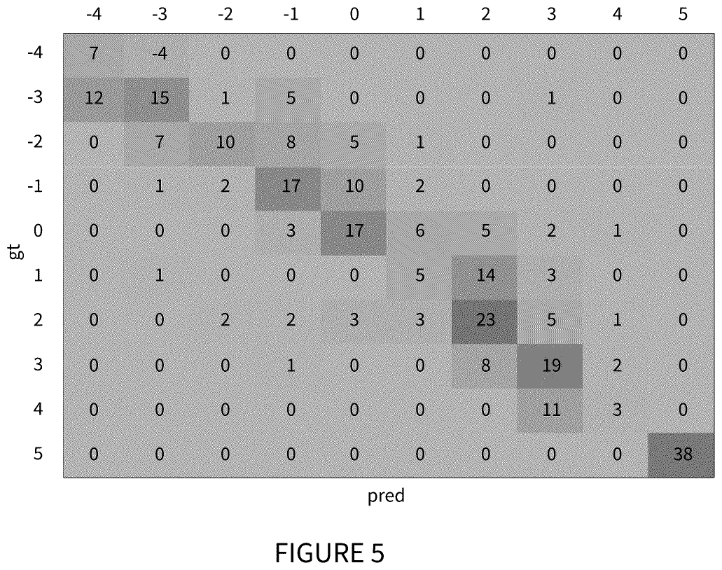

The three approaches of cell detection and classification as detailed in the experimental procedures, the ‘baseline’ method, which features disjoint detection and classification and ‘ours-ring’ and ‘ours-vor’, were next compared by performing both tasks within the same architecture. The cell versus background detection results on ‘det-test’ are shown on the left in Table 3. Although one cannot compute precision for ‘class-test’, the inventors can report the partial recall, denoted as Rₚₐᵣₜ in the table. As for classification performance, all detected blobs that received higher scores than the threshold were treated as ‘cells’, and their respective class assignments were computed using either Algorithm 1 for the method of the present disclosure or applying a classifier on the bounding box which surrounds the detected blob, for the baseline. The classification results are listed on the right of Table 3. Notably, the method of the present disclosure receives better classification results and a higher combined Fscore, suggesting that training simultaneously for both tasks improves the combined performance. Note that the additional Voronoi-based background supervision in ‘ours-vor’ improves the results. The qualitative detection and classification results are presented in FIG. 3 and FIG. 4.

TABLE 3
Numeric results.

| | ‘det-test’ | | | | | ‘class-test’ | | | | | | |
|---|---|---|---|---|---|---|---|---|---|---|---|---|
| Method | P | R | F_1 | μ | σ | Rₚₐᵣₜ | Acc | P | R | F₁ | mAP | F1_{comb} |
| ‘baseline’ | 0.766 | 0.812 | 0.788 | 3.81 | 2.50 | 0.872 | 0.414 | 0.452 | 0.414 | 0.406 | 0.457 | 0.535 |
| ‘ours-ring’ | 0.712 | 0.759 | 0.735 | 3.70 | 2.34 | 0.912 | 0.491 | 0.503 | 0.491 | 0.489 | 0.544 | 0.587 |
| ‘ours-vor’ | 0.923 | 0.629 | 0.748 | 3.51 | 2.33 | 0.897 | 0.539 | 0.550 | 0.539 | 0.530 | 0.577 | 0.621 |

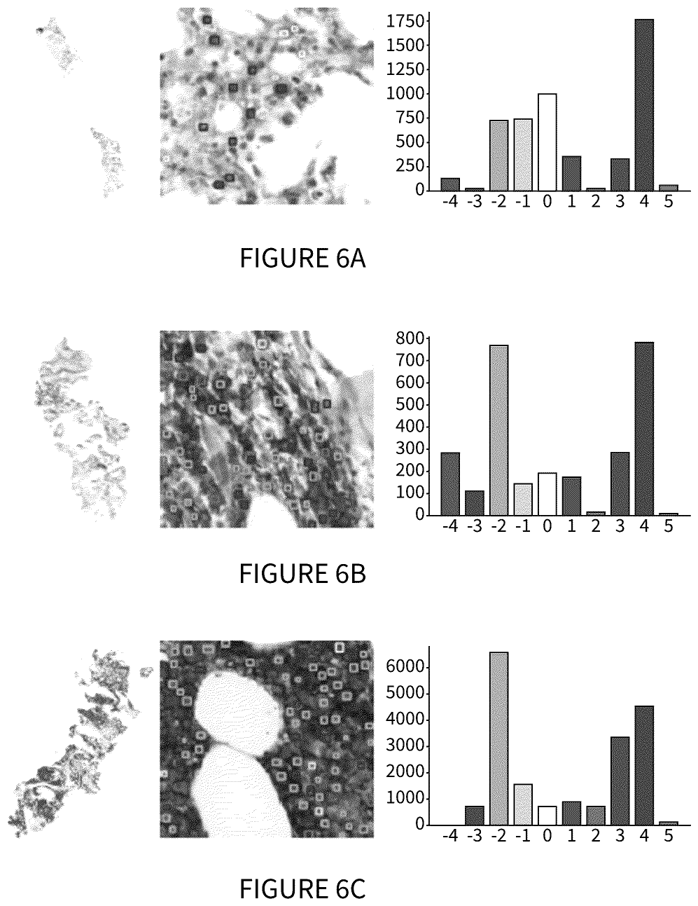

The left (‘det-test’) and right (‘class-test’) columns present detection and classification results. Rₚₐᵣₜ denotes partial detection recall, and F1_{comb} denotes combined Fscore. The classification confusion matrix of ‘ours-vor’ is given in FIG. 5. As can be seen, the confusion matrix is nearly diagonal, up to an offset of ±1 from the main diagonal. This can be expected since neighboring scores, differing by ±1 can be easily confused by the annotating pathologist (see. adjacent rows of FIG. 2) and consequently by the algorithm of the present disclosure. The inventors acknowledge this difficulty and show the numeric results given a grace of ±1 between ground truth and predicted scores. The inventors calculate accuracy, precision, recall and F₁, based on this extended metric and report the results in Table 4. As can be seen, this considerably increases the classification Fscore to ≈85%. As to runtime performance, as shown in Table 4, the joint network of the present disclosure is ×4 faster in inference, as it does not require an external classifier over each and every cell, as the ‘baseline’ method.

Returning to the original application, personalized cell histograms, the inventors aggregate the results of the method of the present disclosure over three patient' slides (not used for training or validation) and show the results in FIG. 6. The tile images of each patient's WSI were fed into the trained network of the present disclosure and the predicted boxes and matching softmax probabilities were obtained. In the resulting tile example and histogram, the inventors show cells that achieved a confidence score of 0.35 and higher. The rows (from top to bottom) in FIG. 6 correspond to patients, tagged globally by a pathologist, as ‘nuclear’, ‘evenly distributed’ and ‘cytosolic.’

TABLE 4
Classification with ±1 and runtime.

| | ‘baseline’ | ‘ours-ring’ | ‘ours-vor’ |
|---|---|---|---|
| Acc ± 1 | 0.755 | 0.866 | 0.874 |
| P ± 1 | 0.738 | 0.841 | 0.844 |
| R ± 1 | 0.748 | 0.828 | 0.860 |
| F₁ ± 1 | 0.726 | 0.830 | 0.848 |
| Inference[s] | 0.0872 | 0.0239 | 0.0213 |

The inventors have presented the disclosed approach for simultaneous detection and classification of cells in IHC images, derived from biopsies of MM patients. The inventors proposed a new weakly and partially supervised dataset for cell classification, consisting of 9 categories, corresponding to different levels of proteasomal staining. The DNN of the present disclosure, trained to perform both detection and classification, is guided by a loss function, combining fidelity to the given partial labels and smoothness of the resulting multiclass probability maps. The inventors have shown that the disclosed method is able to predict the correct class up to a margin of ±1, with an accuracy of ≈87%.

1.-68. (canceled)

69. A computer implemented method of detection and multi-class classification of objects of interest in an image, using a single machine learning model, the method comprising:
applying a machine learning model on at least one input image, wherein the machine learning model is a model, which has been trained using a partially and weakly labelled training dataset of images;
for each input image, the machine learning (ML) model is configured to provide as output, C probability maps, where C is defined according to the number of classes in a group of classes, which includes at least two object-related classes and a background class; and each map of the C probability maps corresponds to a respective class and wherein the C probability maps provide collectively, for each pixel in the input image, a respective probability vector comprising C probability values, each value indicating the probability that the pixel belongs to a certain class in the group of classes;
applying post-processing on the output, comprising:
detecting one or more objects of interest in the at least one input image, based on the probability vectors; and
classifying each detected object of interest to a respective class in the group of classes, based on the probability values, in the probability maps, of pixels located in the detected object of interest.

70. The computer implemented method of claim 69, wherein at least one of:
(A) the detecting one or more objects of interest in the at least one input image further comprising:
for each pixel in the at least one input image:
summing all probability values in the respective probability vector that correspond to the one or more objects of interest and not background to thereby obtain a respective summed object-related probability value of the pixel;
identifying each pixel that is an object-related pixel which is part of an object, based on the respective object-related probability value;
connecting nearby object-related pixels to thereby identify groups of object-related pixels, where each group of object-related pixels represents a respective object in the at least one input image;
wherein the classifying comprising:
for each map in a subset of the c probability maps:
for each group of object-related pixels in the map calculating a respective group-specific probability value, thereby obtaining a plurality of group-specific probability values for each group of object-related pixels;
classifying each group of object-related pixels to a selected class based on the plurality of group-specific probability values;
(B) wherein each group-specific probability value is an average of probability values of object-related pixels in the respective group of object-related pixels;
(C) wherein the selected class is a class corresponding to a probability map associated with the highest group-specific probability value of the plurality of group-specific probability values;
(D) wherein the computer implemented method further comprising a screening step, comprising:
removing groups of object-related pixels having a size greater than a certain maximal threshold or a side smaller than a certain minimal threshold;
(E) wherein the group of classes includes at least three object-related classes and a background class;
(F) wherein each probability value is a uint8 value and wherein a sum of probability values in each respective probability vector equals to 1; and
(G) the computer implemented method further comprising:
assigning each classified object of the one or more classified objects to a respective subgroup according to the respective class of the classified object, wherein a distribution of the one or more classified objects to different subgroups provides an object related profile.

71. The computer implemented method of claim 69, wherein at least one of:
(A) the input images are images of a biological sample, and the objects are cells in the biological sample, or any organelles and/or cell compartments thereof;
(B) wherein the biological sample is a sample of a subject, wherein said objects are cells, wherein said object of interest are pathological cells, and wherein each class in the group of classes reflects a respective distribution of at least one biomarker within the cell;
(C) wherein the respective distribution of said at least one biomarker indicates a sub-cellular localization of the at least one biomarker and/or a relative amount and/or a relative ratio of the biomarker in the cell compartments and/or organelle;
(D) wherein the sub-cellular localization comprises at least one of: a nuclear localization and a cytosolic localization of said at least one biomarker;
(E) wherein said biomarker is the proteasome, or any subunit thereof;
(F) wherein said pathological cells are neoplastic cells or cells of a subject suffering from a protein misfolding disorder or a deposition disorder;
(G) wherein said neoplastic cells are cancer cells; and
(H) wherein said cancer cells are Multiple Myeloma (MM) cells.

72. The computer implemented method of claim 69, wherein at least one of:
(A) in at least part of images in the partially and weakly labelled training dataset of images, only a single pixel is labeled in a labeled object;
(B) the computer implemented method further comprising applying an encoding expansion process on the weakly and partially labeled dataset before training, comprising:
for each labeled object in the training dataset:
automatically defining a first masked region surrounding at least one manually labeled pixel in the labeled object, wherein all pixels in the first region are classified to the same class as the at least one manually labeled pixel, and a second masked region surrounding the first mased region, wherein an area between the first masked region and the second masked region corresponds to background; and
(C) the computer implemented method further comprising training the machine learning model, the method comprising:
obtaining a training dataset comprising a collection of partially and weakly labelled images, where in each image only part of the objects are labeled, and only part of the pixels of each labeled object are labeled;
using the training dataset for training the machine learning model comprising: generating for each partially and weakly labeled image c probability maps, wherein each map corresponds to a respective class and comprises, with respect to each labelled pixel a respective probability value indicative of a probability that the pixel belongs to the respective class; wherein the c probability maps provide collectively, for each labelled pixel, a respective probability vector comprising c probability values each value indicating the probability that the pixel belongs to a respective class; and
iteratively applying a loss function on the training dataset; and optionally,
wherein the loss function includes a partial entropy loss component and a smoothness component, wherein the smoothness component is configured to increase loss function penalty on neighboring pixels with similar values, which are assigned by the machine learning model with different probabilities as compared to neighboring pixels with different values which are assigned with different probabilities and reside across transitional areas in an image.

73. A computer program product stored on a non-transitory computer-readable medium comprising instructions which, when the program is executed by a computer, cause the computer to carry out a method according to claim 69.

74. A computer program product operable in a computer and comprising instructions stored on a non-transitory computer-readable medium for causing the computer to execute a method of detection and multi-class classification of one or more objects in an image, using a single machine learning model for both detection and classification, wherein the product is produced by the processes of:
obtaining a training dataset comprising a collection of partially and weakly labelled images, where in each image only part of the one or more objects are labeled, and only part of the pixels of each labeled object are labeled;
using the training dataset for training the machine learning model comprising: generating for each partially and weakly labeled image C probability maps, wherein each map corresponds to a respective class and comprises, with respect to each labelled pixel a respective probability value indicative of a probability that the pixel belongs to the respective class; wherein the C probability maps provide collectively, for each labelled pixel, a respective probability vector comprising C probability values each value indicating the probability that the pixel belongs to a respective class; and
iteratively applying a loss function on the training dataset.

75. The computer program product of claim 74, wherein at least one of:
(A) wherein in at least part of images in the training dataset only a single pixel is manually labeled in each labeled object;
(B) wherein the method further comprising applying an encoding expansion process on the weakly and partially labeled dataset before training, comprising:
for each labeled object in the training dataset:
automatically defining a first masked region surrounding at least one manually labeled pixel in the labeled object, wherein all pixels in the first region are classified to the same class as the at least one manually labeled pixel, and a second masked region surrounding the first mased region, wherein an area between the first masked region and the second masked region corresponds to background; and
(C) wherein the loss function includes a partial entropy loss component and a smoothness component, wherein the smoothness component is configured to increase loss function penalty on neighboring pixels with similar values, which are assigned by the machine learning model with different probabilities as compared to neighboring pixels with different values which are assigned with different probabilities and reside across transitional areas in an image.

76. A computer implemented method of training machine learning model for detection and multi-class classification of one or more objects in one or more images using a single machine learning model for both detection and classification, the method comprising:
applying an encoding expansion process on the weakly and partially labeled dataset before training, comprising:
for each labeled object in the training dataset:
automatically defining a first masked region surrounding at least one manually labeled pixel in the labeled object, wherein all pixels in the first region are classified to the same class as the at least one manually labeled pixel, and a second masked region surrounding the first mased region, wherein the area between the first masked region and the second masked region corresponds to background,
using the training dataset for training the machine-learning model comprising: generating for each partially and weakly labeled image C probability maps, wherein each map corresponds to a respective class and comprises, with respect to each labelled pixel a respective probability value indicative of a probability that the pixel belongs to the respective class; wherein the C probability maps provide collectively, for each labelled pixel, a respective probability vector comprising C probability values each value indicating the probability that the pixel belongs to a respective class; and
iteratively applying a loss function on the training dataset.

77. The computer implemented method of claim 76, wherein at least one of:
(A) in at least part of images in the training dataset only a single pixel is manually labeled in each labeled object; and
(B) wherein the loss function includes a partial entropy loss component and a smoothness component, wherein the smoothness component is configured to increase loss function penalty on neighboring pixels with similar values, which are assigned by the machine learning model with different probabilities as compared to neighboring pixels with different values which are assigned with different probabilities and reside across transitional areas in an image.

78. A computer system comprising at least one processing circuitry configured to execute a method of detection and multi-class classification of objects in an image, using a single machine learning model for both detection and classification according to claim 69.

79. A computer system comprising at least one processing circuitry configured to execute a method of training machine learning model for detection and multi-class classification of objects in an image using a single machine learning model for both detection and classification, according to claim 69.

80. A diagnostic method for detecting and multi-class classifying of sub-cellular localization of at least one biomarker, in at least one object of at least one biological sample, the method comprising:
applying a machine learning model on at least one input image of said sample, wherein the machine learning model is a model, which has been trained using a partially and weakly labelled training dataset of images;
for each input image, the machine learning (ML) model is configured to provide as output, C probability maps, where C is defined according to the number of classes in a group of classes, which includes at least two object-related classes and a background class; and each map of the C probability maps corresponds to a respective class, wherein each object-related class in the group of classes reflects a respective distribution of at least one biomarker within the object; wherein the C probability maps provide collectively, for each pixel in the input image, a respective probability vector comprising C probability values, each value indicating the probability that the pixel belongs to a certain class in the group of classes;
applying post-processing on the output, comprising:
detecting one or more objects of interest in the at least one input image, based on the probability vectors; and
classifying each detected object of interest to a respective class in the group of classes, based on the probability values, in the probability maps, of pixels located in the detected object of interest, thereby identifying one or more classified objects in the at least one input image.

81. The diagnostic method of claim 80, wherein at least one of:
(A) the object/s are cell/s in the biological sample or any organelles and/or compartments thereof;
(B) wherein said cell/s comprise pathological cell/s and wherein the detecting one or more objects of interest in the at least one input image further comprises:
for each pixel in the input image:
summing all probability values in the respective probability vector that correspond to the one or more objects of interest and not background to thereby obtain a respective summed object-related probability value of the pixel;
identifying each pixel that is an object-related pixel which is part of an object, based on the respective object-related probability value;
connecting nearby object-related pixels to thereby identify groups of object-related pixels, where each group of object-related pixels represents a respective object in the at least one input image;
wherein the classifying comprising:
for each map in a subset of the c probability maps:
for each group of object-related pixels in the map calculating a respective group-specific probability value, thereby obtaining a plurality of group-specific probability values for each group of object-related pixels;
classifying each group of object-related pixels to a selected class based on the plurality of group-specific probability values, thereby determining a respective classified object in the at least one input image;
(C) wherein the diagnostic method further comprising:
assigning each classified object of the one or more classified objects to a respective subgroup according to the respective class of the classified object, wherein a distribution of the one or more classified objects to different subgroups provides a pathological cell-profile of the biological sample;
(D) wherein the biological sample is of a subject, wherein the cells comprise pathological cells of said subject, wherein said pathological cell-profile is a subject-specific pathological cell-profile, and wherein each class in the group of classes is indicative of a respective distribution of at least one biomarker within the cell, thereby reflecting the sub-cellular localization and/or the relative amount and/or relative ratio of said at least one biomarker in a specific cell compartment/s and/or organelles;
(E) wherein the subcellular localization comprises at least one of: a nuclear localization and a cytosolic localization of said at least one biomarker;
(F) wherein said biomarker is the proteasome, or any subunit thereof,
(G) wherein the cell-related class/s comprise at least two pathological cell-related classes, and wherein at least one class of the at least two pathological-cell-related classes reflects a ratio of nuclear to cytosolic proteasomal localization that is greater than 1; and at least one class reflects a ratio of nuclear to cytosolic proteasomal localization that is smaller than or equals to 1;
(H) wherein the sample is a tissue sample or a cell sample, wherein the sample is subjected to at least one immunological and/or affinity and/or enzymatic and/or activity assay to detect said biomarker, and wherein said input image is an image of said at least one immunological, and/or affinity, and/or enzymatic and/or activity assays of the sample;
(I) wherein said immunological affinity assay is an immunohistochemical staining and the input image is an image of immunohistochemical staining of the tissue and/or cell sample;
(J) wherein the at least one input image is generated by scanning whole slide images (WSI);
(K) wherein said pathological cell is a neoplastic cell or a cell of a subject suffering from a protein misfolding disorder or a deposition disorder;
(L) wherein at least one of: (i), said neoplastic cell is a cancer cell, of a subject suffering from a hematological malignancy, optionally, Multiple Myeloma (MM); and/or (ii) wherein said cell of a subject suffering from a protein misfolding disorder or deposition disorder is a cell of a subject suffering from amyloidosis or any related conditions;
(M) the diagnostic method further comprising: applying an encoding expansion process on the weakly and partially labeled dataset before training, comprising:
for each labeled object in the training dataset:
automatically defining a first masked region surrounding at least one manually labeled pixel in the labeled object, wherein all pixels in the first region are classified to the same class as the at least one manually labeled pixel, and a second masked region surrounding the first mased region, wherein the area between the first masked region and the second masked region corresponds to background; and
(O) wherein a loss function applied the partially and weakly labelled training dataset of images during training of the ML model includes a partial entropy loss component and a smoothness component, wherein the smoothness component is configured to increase loss function penalty on neighboring pixels with similar values, which are assigned by the machine learning model with different probabilities as compared to neighboring pixels with different values which are assigned with different probabilities and reside across transitional areas in an image.

82. A computer system comprising at least one processing circuitry configured to execute a diagnostic method for determining and classifying the sub-cellular localization of at least one biomarker in at least one biological sample according to claim 80.

83. The diagnostic method according to claim 80, for determining the prognosis of a subject suffering from a pathologic disorder and/or for predicting and/or assessing responsiveness of the subject to a treatment regimen, the method comprising the steps of:
(a) detecting and classifying the sub-cellular localization of the proteasome in at least one pathological cell of at least one biological sample of said subject to generate a pathological cell-profile that reflects the relative amount and/or ratio of pathological cell/s in at least two pathological cell-related classes; and
(b) determining for said subject a negative or positive prognosis; and/or the responsiveness to said treatment regime, based on the pathological cell-profile generated in step (a);
Wherein detecting and classifying the sub-cellular localization of the proteasome according to step (a), is performed by a method comprising:
applying a machine learning (ML) model on at least one input image of said sample, wherein the machine learning model is a model, which has been trained using a partially and weakly labelled training dataset of images;
for each input image, the machine learning model is configured to provide as output, C probability maps, where C is defined according to the number of classes in a group of classes which includes at least two cell-related classes and a background class; and each map of the C probability maps corresponds to a respective class, wherein each cell-related class in the group of classes reflects a respective distribution of the proteasome within the cell; wherein the c probability maps provide collectively, for each pixel in the input image, a respective probability vector comprising C probability values, each value indicating the probability that the pixel belongs to a respective class; and
applying post-processing on the output, comprising:
detecting one or more pathological cell in the at least one input image, based on the probability vectors; and classifying each detected pathological cell to a respective class in the group of classes, based on the probability values in the probability maps, of pixels located in the detected object of interest, thereby identifying one or more classified pathological cells in the at least one input image.

84. The prognostic method of claim 83, wherein at least one of:
(A) wherein at least one class of the at least two pathological-cell-related classes reflects a ratio of nuclear to cytosolic proteasomal localization that is greater than 1; and at least one class reflects a ratio of nuclear to cytosolic proteasomal localization that is smaller than or equals to 1;
(B) wherein at least one of:
(I) a pathological cell-profile predominantly composed of classes that reflect a ratio of nuclear to cytosolic proteasomal localization that is greater than 1, is a profile where:
(i) more than 50% of the cells in the sample are classified in at least one class reflecting a ratio of nuclear to cytosolic proteasomal localization that is greater than 1; and/or
(ii) where less than 1% of the examined cells are classified in at least one class reflecting a ratio of nuclear to cytosolic proteasomal localization that is smaller than or equals to 0.5; and/or
(II) a pathological cell profile predominantly composed of classes that reflect a ratio of nuclear to cytosolic proteasomal localization that is smaller than or equals to 1, is a profile where:
(i) 50% or more of the cells in the sample are classified in at least one class reflecting a ratio of nuclear to cytosolic proteasomal localization that is smaller than or equals to 1; and/or
(ii) where 1% or more of the examined cells, are classified in at least one class reflecting a ratio of nuclear to cytosolic proteasomal localization that is smaller than or equals to 0.5;
(C) wherein determining for said subject the responsiveness to said treatment regime according to step (b), comprises classifying said subject as:
(i) a responder subject to said treatment regimen, if the generated pathological cell-profile is predominantly composed of classes that reflect a ratio of nuclear to cytosolic proteasomal localization that is greater than 1; or
(ii) a non-responder or poor-responder subject to said treatment regimen if the generated pathological cell-profile is predominantly composed of classes that reflect a ratio of nuclear to cytosolic proteasomal localization that is smaller than or equals to 1;
thereby predicting and assessing the responsiveness of a mammalian subject to said treatment regimen;
(D) wherein determining the prognosis of said subject according to step (b), comprises:
(i) determining a positive prognosis of the subject, if the generated pathological cell-profile is predominantly composed of classes that reflect a ratio of nuclear to cytosolic proteasomal localization that is greater than 1; and/or
(ii) determining a negative prognosis of the subject, if the generated pathological cell-profile is predominantly composed of classes that reflect a ratio of nuclear to cytosolic proteasomal localization that is smaller than or equals to 1;
(E) wherein a pathological cell-profile comprising at least one class with the smallest ratio of nuclear to cytosolic proteasomal localization that is below 1, is positively correlated with a negative prognosis of the subject;
(F) wherein the method is for monitoring disease progression, said monitoring disease progression comprises at least one of predicting and/or determining disease relapse and/or assessing a remission interval, wherein said method further comprises the steps of:
(c) repeating the step of claim 83 (a), to determine and classify proteasome subcellular localization, for generating a pathological cell-profile for at least one more temporally-separated sample of said subject; and
(d) predicting and/or determining disease relapse in said subject, if the generated pathological cell-profile of said at least one temporally separated sample, comprises increased number or fraction and/or extremity of pathological cell-classes that reflect reduced ratio of nuclear to cytosolic proteasome localization;
(G) wherein said subject is suffering from at least one of: at least one neoplastic disorder, and/or at least one protein misfolding disorder or deposition disorder,
(H) wherein said neoplastic disorder is at least one hematological malignancy, and wherein said protein misfolding disorder or deposition disorder is amyloidosis and any related conditions; and
(I) wherein said hematological cancer is a multiple myeloma (MM) and/or any related condition.

85. The diagnostic method according to claim 80, for determining a personalized treatment regimen for a subject suffering from a pathologic disorder, the method comprising the steps of:
(a) detecting and classifying the sub-cellular localization of the proteasome in at least one biological sample of said subject to generate a pathological cell-profile reflecting the relative amount and/or ratio of pathological cell/s in at least two pathological cell-related classes;
(b) determining the responsiveness of the subject to at least one treatment regime, based on the pathological cell-profile generated in step (a); and
(c) selecting a treatment regimen based on the responsiveness determined in (b);
Wherein detecting and classifying the sub-cellular localization of the proteasome according to step (a), is performed by a method comprising:
applying a machine learning (ML) model on at least one input image of said sample, wherein the machine learning model is a model, which has been trained using a partially and weakly labelled training dataset of images;
for each input image, the machine learning model is configured to provide as output, C probability maps, where C is defined according to the number of classes in a group of classes which includes at least two cell-related classes and a background class; and each map of the C probability maps corresponds to a respective class, wherein each cell-related class in the group of classes reflects a respective distribution of the proteasome within the cell; wherein the c probability maps provide collectively, for each pixel in the input image, a respective probability vector comprising C probability values, each value indicating the probability that the pixel belongs to a respective class; and
applying post-processing on the output, comprising:
detecting one or more pathological cell in the at least one input image, based on the probability vectors; and classifying each detected pathological cell to a respective class in the group of classes, based on the probability values in the probability maps, of pixels located in the detected object of interest, thereby identifying one or more classified pathological cells in the at least one input image.

86. The method of claim 85, wherein at least one of:
(A) at least one class of said at least two pathological-cell-related classes reflects a ratio of nuclear to cytosolic proteasomal localization that is greater than 1; and at least one class reflects a ratio of nuclear to cytosolic proteasomal localization that is smaller than or equal to 1, and wherein determining the responsiveness of the subject to at least one treatment regime comprises classifying said subject as:
(i) a responder subject to a treatment regimen comprising at least one therapeutic agent, if the generated pathological cell-profile is predominantly composed of classes that reflect a ratio of nuclear to cytosolic proteasomal localization that is greater than 1; or
(ii) a non-responder or poor-responder subject if the generated pathological cell-profile is predominantly composed of classes that reflect a ratio of nuclear to cytosolic proteasomal localization that is smaller than or equals to 1;
(B) wherein said subject is and/or was subjected to a treatment regimen, and is monitored for disease progression, the method comprising the steps of:
(a) determining and classifying the sub-cellular localization of the proteasome in at least one biological sample of said subject to generate a pathological cell-profile reflecting the relative amount and/or ratio of pathological cell/s in said at least two pathological cell-related classes, wherein at least one class of the at least two pathological-cell-related classes reflects a ratio of nuclear to cytosolic proteasomal localization that is greater than 1; and at least one class reflects a ratio of nuclear to cytosolic proteasomal localization that is smaller than or equals to 1, and wherein at least one of said sample is obtained after the initiation of said treatment regimen;
(b) determining at least one of:
(i) a disease relapse and/or loss of responsiveness, and/or non-responsiveness, and/or poor-responsiveness and/or drug-resistance of said subject, if the pathological cell-profile generated in (a), is predominantly composed of classes that reflect a ratio of nuclear to cytosolic proteasomal localization that is smaller than or equals to 1; or
(ii) responsiveness or maintained responsiveness of said subject, if the pathological cell-profile generated in (a), is predominantly composed of classes that reflect a ratio of nuclear to cytosolic proteasomal localization that is greater than 1; and
(c) ceasing a treatment regimen for a subject displaying disease relapse and/or loss of responsiveness, and/or non-responsiveness, and/or poor-responsiveness and/or drug-resistance; or maintaining said treatment regimen for a subject displaying responsiveness and/or maintained responsiveness;
(C) wherein said subject is suffering from at least one of: at least one neoplastic disorder, and/or at least one protein misfolding disorder or deposition disorder;
(D) wherein said neoplastic disorder is at least one hematological malignancy, and wherein said protein misfolding disorder or deposition disorder is amyloidosis and/or any related conditions;
(E) wherein said hematological malignancy is MM and/or related conditions, and wherein said method is for determining a personalized treatment regimen for a subject suffering from MM and/or any related conditions.

87. A method for treating, preventing, inhibiting, reducing, eliminating, protecting or delaying the onset of at least one of: at least one neoplastic disorder and/or at least one protein misfolding disorder in a subject in need thereof, the method comprising the steps of:
(a) detecting and classifying the sub-cellular localization of the proteasome in at least one biological sample of said subject to generate a pathological cell-profile reflecting the relative amount and/or ratio of pathological cell/s in at least two pathological cell-related classes, as defined by the method of claim 80;
(b) determining the responsiveness of the subject to at least one treatment regime, based on the pathological cell-profile generated in step (a); and
(c) subjecting a subject determined as a responder to said treatment regimen;
Wherein detecting and classifying the sub-cellular localization of the proteasome according to step (a), is performed by a method comprising:
applying a machine learning (ML) model on at least one input image of said sample, wherein the machine learning model is a model, which has been trained using a partially and weakly labelled training dataset of images;
for each input image, the machine learning model is configured to provide as output, C probability maps, where C is defined according to the number of classes in a group of classes which includes at least two cell-related classes and a background class; and each map of the C probability maps corresponds to a respective class, wherein each cell-related class in the group of classes reflects a respective distribution of the proteasome within the cell; wherein the c probability maps provide collectively, for each pixel in the input image, a respective probability vector comprising C probability values, each value indicating the probability that the pixel belongs to a respective class; and
applying post-processing on the output, comprising:
detecting one or more pathological cell in the at least one input image, based on the probability vectors; and classifying each detected pathological cell to a respective class in the group of classes, based on the probability values in the probability maps, of pixels located in the detected object of interest, thereby identifying one or more classified pathological cells in the at least one input image; optionally, wherein at least one class of said at least two pathological-cell-related classes reflects a ratio of nuclear to cytosolic proteasomal localization that is greater than 1; and at least one class reflects a ratio of nuclear to cytosolic proteasomal localization that is smaller than or equal to 1, and wherein determining the responsiveness of the subject to at least one treatment regime comprises classifying said subject as:
(i) a responder subject to said treatment regimen comprising at least one therapeutic agent, if the pathological cell-profile generated in (a), is predominantly composed of classes that reflect a ratio of nuclear to cytosolic proteasomal localization that is greater than 1; or
(ii) a non-responder or poor-responder subject if the pathological cell-profile generated in (a), is predominantly composed of classes that reflect a ratio of nuclear to cytosolic proteasomal localization that is smaller than or equals to 1.

88. A diagnostic system comprising at least one processing circuitry configured to execute a method of training machine learning model for detection and multi-class classification of pathological cells in an image using a single machine learning model for both detection and classification, according to claim 80.
